(19) United States
(12) Patent Application Publication
(10) Pub. No.: US 2026/0113184 A1
(43) Pub. Date: Apr. 23, 2026

(54) SYSTEMS AND METHODS FOR ESTABLISHING A SECURE DIGITAL NETWORK ENVIRONMENT

(71) Applicant: QDS Holdings Inc., Rapid City, SD (US)

(72) Inventors: Tilo Alexander Kunz, Dollard-des-Ormeaux (CA); William Arthur Yakamovich, Fall River (CA); Gary Paul Swatton, Phoenix, AZ (US); Kim Brian Holmes, Renton, WA (US); Jonathan Neil Catlin, Scottsdale, AZ (US)

(73) Assignee: QDS Holdings Inc., Rapid City, SD (US)

(21) Appl. No.: 19/117,922

(22) PCT Filed: Oct. 3, 2023
(86) PCT No.: PCT/CA2023/051307

§ 371 Date: Apr. 2, 2025

Related U.S. Application Data
(60) Provisional application No. 63/412,868, filed on Oct. 3, 2022.
(60) Provisional application No. 63/413,240, filed on Oct. 4, 2022.
(60) Provisional application No. 63/428,416, filed on Nov. 28, 2022.

(51) Int. Cl. H04L 9/08; H04L 9/40; H04L 12/66

(52) U.S. Cl. CPC H04L 9/0858; H04L 9/0869; H04L 9/0891; H04L 12/66; H04L 63/02; H04L 63/0876; H04L 63/10; H04L 63/20

(57) ABSTRACT

According to the instant application, there are provided systems and methods to create a quantum secure/resistant secure communication channel (QSR-SCC) for communication between two or more end-points at or within devices, applications, services, APIs, secure communication protocols, etc. In one example of a QSR-SCC, a quantum secure/resistant private network (QSR-PN) extends existing VPN solutions using one time pad (OTP) based keys, augmented handshake mechanisms, and interchangeable ciphers, for example, stream ciphers or block ciphers, for enhancing security associated with the QSR-PN.

### CROSS-REFERENCE TO RELATED APPLICATIONS

This application claims priority to U.S. Provisional Patent Application No. 63/412,868 filed Oct. 3, 2022, U.S. Provisional Patent Application No. 63/413,240 filed Oct. 4, 2022 and U.S. Provisional Patent Application No. 63/428,416 filed Nov. 28, 2022, which are incorporated herein by reference in their entirety.

### FIELD OF THE INVENTION

The present invention relates to the field of cybersecurity, for example cybersecurity for communications and data management. More particularly, the present invention can relate to systems and methods for securing a digital network environment, for example against present day security threats and potential future quantum computing derived threats.

### BACKGROUND

Global ransomware damages totaled US$325M in 2015. By 2021 they reached US$20B, a 60-fold increase. Ten years from now ransomware will cost its victims US$265B annually (Cybercrime Magazine, Jun. 3, 2021). These statistics represent damages from conventional threats that will unfortunately be dwarfed by the disruption projected from pending quantum threats. Furthermore, since mid-2020 organizations throughout the world have had to adapt to remote working, dramatically increasing the attack vectors available to cybercriminals and rogue nation states. It is self-evident that these risks are rapidly becoming uninsurable.

In addition to persistent cyber threats quantum disruption is at our doorstep. The theoretical is quickly becoming reality with the looming quantum revolution threatening the cryptographic underpinnings of our global digital infrastructure.

Quantum computers are computers that are built using a unique property of quantum mechanics, the superposition principle. Quantum computers use quantum bits, or “qubits,” which can exist in a superposition state. In this state qubits have a value of both 0 and 1 simultaneously. (Schrödinger's paradox of a cat in a box). This quantum physics-based behavior potentially allows a quantum computer with sufficient power to exponentially perform certain math-based calculations that no classical computer would ever be able to perform. Conventional thought is that in a number of math-based cryptographic operations (for example, prime factorization), a quantum computer could break Elliptic Curve and RSA encryption algorithms 1000's of times faster than any conventional system. For the RSA encryption algorithm (the mainstay of conventional cryptography), a conventional computer would need about 300 trillion years to crack communications protected with a 2,048-bit digital key, however an adequately powered quantum computer with ˜4,100 (Quintessence Labs June 2019 Breaking RSA encryption) qubits would need just 10 seconds.

Many security organizations are working on Post-Quantum-Cryptography (PQC) to counter the quantum threat, but this is only a stop gap measure as none are provably quantum secure (QS).

Currently (2021) existing public-key (RSA for example) algorithms (asymmetric) could be broken by a suitably powered quantum computer.

“Post quantum cryptography” (PQC) are cryptographic algorithms (typically public-key) that are thought to be resistant to a cryptanalytic attack by a quantum computer. These algorithms have a common trait; namely that they are complex math-based solutions that in some cases have been studied for years assessing their security strength and effectiveness. Yet none of these algorithms are information-theoretically secure (ITS) (e.g. provably unbreakable). Regardless of the success or acceptance of any of these algorithms from a standards perspective, an operational problem is that these algorithms require larger key sizes and greater complexity than commonly used “pre-quantum” public key algorithms such as RSA. The larger key size and more complex algorithms require computationally more power, reduced efficiencies, and larger footprints for ciphertext and signatures. In addition, the carbon footprints required for these PQC solutions are unsustainable.

In contrast to this, symmetric cryptographic algorithms, such as AES or DES and hash functions are considered relatively secure from attack provided that a sufficiently large key size is used. Cryptographic symmetric-key algorithms are algorithms that use the same cryptographic keys for both the encryption of plaintext and the decryption of ciphertext. Keys may be identical, or there may be simple transformation functions to go between the two keys. To the best of the inventors' knowledge, however, there are no symmetric cryptographic algorithms that are provably quantum secure (QS).

The current thinking is to make incremental improvements as opposed to an approach that is future proof against further advances. Industry cannot remove and replace infrastructure every time there is an advance in quantum capability or further future technological breakthroughs. Furthermore, current systems are protected with a patchwork of security solutions that continuously require additional patches as new leaks and holes are discovered.

There remains a need for “secure-by-design” solutions that may address current cyber security shortcomings, and that may be provably capable of protecting from new cyber security threats, quantum or otherwise yet to be conceived threats. Such solutions may provide needed assurance that digital systems, privacy, and data may remain QS for both completely centralized or geographically distributed work and operational environments.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide systems and methods for establishing a secure digital network environment.

According to embodiments, there is provided a system configured to create a quantum secure/resistant secure communication channel (QSR-SCC) for communication between two or more end-points. The system includes an originating end-point and a destination end-point, both the originating end-point and the destination end-point configured for communication therebetween. The system further includes an encryption engine to provide an encrypted communication between the originating end-point and the destination end-point and a plurality of KPADs, wherein each KPAD includes multiple sets of true random number generator (TRNG) bytes of key data configured with a QSR-E key structure. Each of the plurality of KPADs is configured to be used by the encryption engine, wherein each of the plurality of KPADs is created and centrally managed by a quantum key management system (QKMS); and a true random number generator (TRNG), the TRNG configured to generate quantum secure random numbers for use in the plurality of KPADs. The encryption engine and plurality of KPADs are used to establish a secure communication tunnel for the secure transmission of data.

In some embodiments, the two or more end-points are located at or within one or more of devices, applications, services, application programming interfaces (APIs) and secure communication protocols.

In other embodiments, the QSR-SCC is operatively associated with means to provide authentication and authorization functionalities with respect to the originating and destination end-points and associated users to establish the secure communication tunnel and securely transmit data via the QSR-SCC.

In still other embodiments, the system further includes an identity and access management service (IAM) configured to manage user and end-point identity, access, and authorization services, wherein the originating end-point and the destination end-point are operatively connected to the IAM. The system further includes one or more universal endpoint managers (UEM), wherein each UEM is operatively associated with the means to provide authorization and authentication functionalities and is configured to manage at least the originating and destination end-points. The system further includes user and end-point authorization services (Auth), wherein the Auth is configured to interface with the IAM to remotely manage the originating end-point and the destination end-point of the QSR-SCC. The system further includes one or more firewalls, wherein each firewall is configured to provide one or more zero trust access, ingress and/or egress, and communication traffic inspection capabilities. The system further includes one or more quantum secure/resistant end-point management services (QSR-Agent), wherein each of the originating and destination end-points is operatively connected with a QSR-Agent and wherein each QSR-Agent is operative to interact with the system to allow, deny, manage, monitor and/or control the establishment of the secure communication tunnel and the transmission of data via the QSR-SCC. The system further includes a quantum secure/resistant enterprise asset manager (QSR-EAM) configured for centralized management of hardware and digital assets and operatively associated with the QSR-SCC; one or more policy orchestrators (PO), wherein each PO is configured to manage and deliver zero trust policy services within the QSR-SCC and wherein each PO is configured to orchestrate one or more of user, group, or other security policies for providing access and control to the originating and destination end-points of the QSR-SCC. The system further includes one or more risk managers (RM), wherein the RM is configured to assess and report on risk regarding the operability of the QSR-SCC and compliance with pre-determined risk management standards set for or to be evaluated for the system; and/or a quantum secure/resistant enterprise manager (QSR-EM) configured to provide a unified view of the two or more end-points and entirety of the system.

In some embodiments, the QSR-SCC is used to create a quantum secure/resistant private network (QSR-PN) between the two or more end-points. In other embodiments, the QSR-PN includes a quantum secure/resistant gateway (QSR-Gateway) and/or a quantum secure/resistant router (QSR-Router).

In some embodiments, the QSR-SCC is timed-out and rekeyed on a random periodic basis.

In other embodiments the multiple sets of true random number generator (TRNG) bytes of key data are sequenced in a sequentially ordered fashion.

According to embodiments there is provided a quantum secure/resistant ecosystem (QSR-E) for secure communication between a plurality of quantum secure/resistant end-points. The QSR-E including one or more systems, each system configured to create a quantum secure/resistant secure communication channel (QSR-SCC) for communication between two or more end-points. TQSR-E includes an originating end-point and a destination end-point, both the originating end-point and the destination end-point configured for communication therebetween. The QSR-E further includes an encryption engine to provide an encrypted communication between the originating end-point and the destination end-point and a plurality of KPADs. Each KPAD includes multiple sets of true random number generator (TRNG) bytes of key data configured with a QSR-E key structure and each of the plurality of KPADs configured to be used by the encryption engine. Each of the plurality of KPADs is created and centrally managed by a quantum key management system (QKMS). The QSR-E further includes a true random number generator (TRNG), the TRNG configured to generate quantum secure random numbers for use in the plurality of KPADs. The encryption engine and plurality of KPADs are used to establish a secure communication tunnel for the secure transmission of data. The QSR-E further includes a QSR-Router deployed at a location remote from one of the one or more systems, wherein the QSR-Router is configured to secure a remote communication tunnel with one or more end-points of said system. The QSR-E further includes one or more quantum secure/resistant user and end-point devices (QSR-UEDs), each QSR-UED including a plurality of KPADS, each KPAD configured with a QSR-E key structure created and managed by a quantum key management system (QKMS) within the QSR-E.

According to embodiments, there is provided a quantum secure/resistant device (QSR-Device) for use within a QSR-E created by one or more systems, each system configured to create a quantum secure/resistant secure communication channel (QSR-SCC) for communication between two or more end-points associated with one or more QSR-Devices. The QSR-E includes an originating end-point and a destination end-point, both the originating end-point and the destination end-point configured for communication therebetween. The QSR-E further includes an encryption engine to provide an encrypted communication between the originating end-point and the destination end-point and a plurality of KPADs. Each KPAD includes multiple sets of true random number generator (TRNG) bytes of key data configured with a QSR-E key structure, each of the plurality of KPADs configured to be used by the encryption engine, wherein each of the plurality of KPADs is created and centrally managed by a quantum key management system (QKMS). The QSR-E further includes a true random number generator (TRNG), the TRNG configured to generate quantum secure random numbers for use in the plurality of KPADs; wherein the encryption engine and plurality of KPADs are used to establish a secure communication tunnel for the secure transmission of data. The QSR-device includes a processor and a memory having stored thereon one or more KPADs. The memory further having stored thereon machine executable instructions. The instructions when executed by the processor cause the QSR-device to be configured to communicate with an Auth, wherein the Auth is configured to conduct multi-factor authentication (MFA) with an access management service (IAM) within the system. The instructions when executed by the processor further configure the QSR-Device to communicate with one or more other devices associated with the QSR-E using a KPAD for encrypting communications.

According to embodiments, there is provided a method for creating a quantum secure/resistant private network (QSR-PN) for communication between two or more devices. The method includes generating, by the originating device, an encrypted handshake using a cipher key retrieved from an originating KPAD, the originating KPAD including multiple sets of true random number generator (TRNG) bytes of cipher key data configured with a QSR-Ecosystem key structure, the encrypted handshake including information indicative of the originating device. The method further includes transmitting, by the originating device, the encrypted handshake to a destination device together with an indication of the cipher key and receiving, by the destination device, the encrypted handshake and the indication of the cipher key. The method further includes retrieving, by the destination device, the cipher key from a destination KPAD, the destination KPAD associated with the originating KPAD, the retrieving based at least in part on the indication of the cipher key and decrypting the encrypted handshake using the cipher key to obtain the handshake and the information indicative of the originating device for the destination device to thereby authenticate the originating device. Upon authentication of the originating device by the destination device, the method further includes generating, by the destination device, a second encrypted handshake using an ephemeral key created, derived or generated from the destination KPAD, the second encrypted handshake including information indicative of the destination device. The method additionally includes transmitting, by the destination device, the second encrypted handshake to the originating device together with an indication of the ephemeral key and receiving, by the originating device, the second encrypted handshake and the indication of the ephemeral key. The method further includes retrieving, by the originating device, the ephemeral key from the originating KPAD, the retrieving based at least in part on the indication of the ephemeral key and decrypting the second encrypted handshake using the ephemeral key to obtain the handshake and the information indicative of the destination device for the originating device to thereby authenticate the destination device. Upon authentication of the destination device by the originating device, the method further includes establishing an encrypted communication session between the originating device and the destination device based at least in part on the ephemeral key.

According to embodiments, there is provided a system configured to create a quantum secure/resistant private network (QSR-PN) for communication of data between two or more devices. The system includes an originating device. The originating device includes an originating KPAD loaded in memory on the originating device, the KPAD including multiple sets of true random number generator (TRNG) bytes of cipher key data configured with a QSR-Ecosystem key structure. The originating device further includes an originating cipher module configured to use a cipher key received from an encryption engine, the cipher key used by the cipher module to transform the data into encrypted data and an originating encryption engine configured to perform logic of providing the cipher module with the cipher key obtained from the KPAD and an originating communication module for transmitting the encrypted data and an indication of the cipher key to a destination device. The destination device includes a destination communication module for receiving the encrypted data and the indication of the cipher key from the originating device and a destination KPAD loaded in memory on the destination device, the destination KPAD associated with the originating KPAD. The destination device further includes a destination encryption engine configured to perform logic of providing a destination cipher module with a decryption cipher key obtained from the destination KPAD based at least in part on the indication of the cipher key received from the originating device. The destination device further includes a destination cipher module configured to use the decryption cipher key received from the destination encryption engine, the decryption cipher key used by the destination cipher module to transform the encrypted data into the data.

According to embodiments, there is provided a method for creating a quantum secure/resistant private network (QSR-PN) for communication of data between two or more devices. The method includes storing an originating KPAD on an originating device, the KPAD including multiple sets of true random number generator (TRNG) bytes of cipher key data configured with a QSR-Ecosystem key structure. The method further includes obtaining a cipher key from the originating KPAD and transferring the cipher key to an encryption engine and transforming the data to encrypted data using the cipher key. The method further includes transmitting the encrypted data and an indication of the cipher key to a destination device.

According to embodiments, there is provided a method for creating a quantum secure/resistant private network (QSR-PN) for communication of data between two devices. The method includes storing a destination KPAD on a destination device and receiving encrypted data and an indication of a cipher key from an originating device. The method further includes retrieving the cipher key from the destination KPAD, the retrieving based at least in part on the indication of the cipher key and transforming the encrypted data into the data based on the cipher key.

According to embodiments, there is provided an apparatus for creating a quantum secure/resistant private network (QSR-PN) for communication of data between two or more devices. The apparatus includes a processor and a memory having stored thereon computer executable instructions. The instructions when executed by the processor configure the apparatus to perform one or more of the methods disclosed herein.

### BRIEF DESCRIPTION OF THE DRAWINGS

These and other features of the invention will become more apparent in the following detailed description in which reference is made to the appended drawings.

FIG. 1 is a block diagram of a QSR-E established by a QSR-PN and QSOC, according to embodiments.

FIG. 1A is a generalized block diagram of a quantum secure/resistant ecosystem (QSR-E) created by a quantum security operations center (QSOC), according to embodiments.

FIG. 1B is a block diagram of a ecosystem QSR-E which is created by a QSOC, according to embodiments.

FIG. 1C is a block diagram of a QSR-E which is created by a QSOC, according to embodiments, wherein the system includes the ability for the QSR-PN to establish a direct secure communication between a remote office worker and the headquarters of the enterprise.

FIG. 2 is a block diagram of QSR-Apps, according to embodiments.

FIG. 3 is a block diagram of a QSOC, according to embodiments.

FIG. 4 is another block diagram of a QSOC, according to embodiments.

FIG. 5 is a block diagram of a QSR-E which is created by a QSOC, according to embodiments.

FIG. 6 is a block diagram of a QSR-Adaptor that can be operatively connected with a QSR-E, according to embodiments.

FIG. 7 is a block diagram of a headquarters that can be operative within a QSR-E, according to embodiments.

FIG. 8 is another block diagram of a headquarters that can be operative within a QSR-E, according to embodiments.

FIG. 9 is a block diagram of a remote worker and a remote office that can be operative within a QSR-E, according to embodiments.

FIG. 10 is block diagram of a remote office that can be operative within a QSR-E, according to embodiments.

FIG. 11 is block diagram of a remote worker that can be operative within a QSR-E, according to embodiments.

FIG. 12 is another block diagram of a remote worker that can be operative within a QSR-E, according to embodiments.

FIG. 13 is block diagram of an industrial control system that can be operative within a QSR-E, according to embodiments.

FIG. 14 is another block diagram of another industrial control system that can be operative within a QSR-E, according to embodiments.

FIG. 15 is a block diagram of QSR-Apps that can be operative within a QSR-E, according to embodiments.

FIG. 16 is a workflow diagram for the provision of cyber security risk assessments and information, according to embodiments.

FIG. 17 is a block diagram of a risk manager (RM) associated with a QSOC, according to embodiments.

FIG. 17A is a close up of a first portion of the block diagram of a RM illustrated in FIG. 17, according to an embodiment.

FIG. 17A-1 is a close up of a first portion of the block diagram of a RM illustrated in FIG. 17 illustrating one mode of communication between an insurance company and a QSOC, according to embodiments.

FIG. 17A-2 is a close up of a first portion of the block diagram of a RM, illustrated in FIG. 17 illustrating one mode of communication between an insurance company and a QSOC using a QSR diode, according to embodiments.

FIG. 17B is a close up of a second portion of the block diagram of a RM, illustrated in FIG. 17.

FIG. 17C a block diagram of a RM, according to embodiments.

FIG. 17D is a close up of a half portion of the block diagram of a RM illustrated in FIG. 17C.

FIG. 18 is a schematic diagram of an electronic device 2000 that may perform any or all of operations of the above methods and features explicitly or implicitly described herein, according to different embodiments of the present disclosure.

FIG. 19A is a schematic representation of a QSR-E illustrating networked QSR-PN enabled architecture features, according to embodiments.

FIG. 19B is a schematic representation of a QSR-E illustrating networked QSR-PN enabled architecture features, according to embodiments.

FIG. 19C is a schematic representation of a QSR-E illustrating networked QSR-PN enabled architecture features which can support blockchain, according to embodiments.

FIG. 19D is a QSOC according to embodiments.

FIG. 19E is a remote exchange according to embodiments.

FIG. 19F is a remote exchange according to embodiments.

FIG. 19G is a remote exchange according to embodiments.

FIG. 20 is a schematic representation of an exemplary QSR-PN multi-factor authentication system for a QSR-E including core and perimeter components, according to embodiments.

FIG. 21A, 21B, 21C is a table of QSR-E architecture features, according to embodiments.

FIG. 22 is a schematic representation of an exemplary QSR-E risk profile monitoring system and processes for an organization managing a QSR-E and insurance providers, according to embodiments.

FIG. 23 is an exemplary QSR-PN insurance risk process for generating QSR-E insurable risk assessment reports (risk profiles), according to embodiments.

FIG. 24 is a schematic representation of potential cyber risk sources that can be addressed by QSR-PN solutions.

FIG. 25 is a table listing attack vectors that can be countered or mitigated by the use of a QSR-PN solution leveraging a QSR-E, according to embodiments.

FIG. 26 is a table listing types of active cyber security threats, according to embodiments.

FIG. 27 is a table listing sources of cyber security threats, according to embodiments.

FIG. 28 is a table listing one embodiment of QSR-E components, according to embodiments.

FIG. 29A is a block diagram that describes the synchronization of data configurations, settings and applications between multiple QSOCs, wherein synchronization is performed over the internet, leveraging quantum-resistance QSR-PN tunnels, according to embodiments.

FIG. 29B is a block diagram that describes the synchronization of data configurations, settings and applications between multiple QSOCs, wherein synchronization is performed over private lines, according to embodiments.

FIG. 30 is a block diagram illustrating support fail-over communications provided by an alternate or redundant QSOC associated with a single QSR-device, according to embodiments.

FIG. 31 is a block diagram illustrating how an enterprise administrator can manage an enterprise QSR-E, including the ability to get enterprise risk management information, according to embodiments.

FIG. 32 is a block diagram illustrating how an enterprise administrator can manage an enterprise QSR-E, including the ability to obtain enterprise risk management information and enable the ability for an insurance company to receive risk reports about the QSOC and QSR-E, according to embodiments.

FIG. 33 is a block diagram illustrating how an enterprise administrator can manage an enterprise QSR-E including surveillance and providing the ability to obtain enterprise risk management information, according to embodiments.

FIG. 34 is a block diagram illustrating how an enterprise administrator can manage an enterprise QSR-E including surveillance and providing the ability to obtain enterprise risk management information and additionally providing the ability for an insurance company to receive risk reports about the QSOC and QSR-E, according to embodiments.

FIG. 35 is a block diagram illustrating how an enterprise administrator can manage an enterprise QSR-E including surveillance and including the ability to obtain enterprise risk management information and additionally providing the ability for a regulator to receive risk reports about the QSOC and QSR-E, according to embodiments.

FIG. 36 is a block diagram illustrating how an enterprise administrator can manage an enterprise QSR-E and including the ability to obtain enterprise risk management information and additionally providing the ability for a regulator to receive risk reports about the QSOC and QSR-E, according to embodiments.

FIG. 37 is a block diagram illustrating how an enterprise administrator can manage an enterprise QSR-E including managed industrial internet of things (IIoT) devices configured as embedded devices that include customized QSR-Agents with customized parameter settings and metrics, and including providing the ability to obtain enterprise risk management information and additionally providing the ability for a regulator to receive risk reports about the QSOC and QSR-E, according to embodiments.

FIG. 38 is a block diagram of a QSR-E mesh network, according to embodiments.

FIG. 39 is a block diagram illustrating a QSR-router-QSR gateway-QSR router configuration, according to embodiments.

FIG. 40 is a block diagram illustrating a QSR-PN configuration including QSR-books, according to embodiments.

FIG. 41 is a block diagram illustrating a QSR-PN enterprise wide area network (WAN_configuration, according to embodiments.

FIG. 42 is a block diagram illustrating a QSR-PN overlay configuration, according to embodiments.

FIG. 43 is a block diagram illustrating a representation of the QSR-PN overlay configuration of FIG. 42, according to embodiments.

FIG. 44 is a block diagram illustrating a QSR-PN-QSR-router configuration, according to embodiments.

FIG. 45 is a block diagram illustrating a flexible QSR-router configuration, according to embodiments.

FIG. 46 is a block diagram illustrating a QSR-PN site to site configuration, according to embodiments.

FIG. 47 is a block diagram illustrating a QSR-PN corporate office to branch office WAN configuration, according to embodiments.

FIG. 48 is a block diagram illustrating an enterprise integrated QSOC configuration, according to embodiments.

FIG. 49 is a block diagram illustrating an enterprise integrated QSOC including a restricted server configuration, according to embodiments.

FIG. 50 is a block diagram illustrating a QSR-PN domain segmentation with a centralized management configuration, according to embodiments.

FIG. 51 is a block diagram illustrating QSR-PN domain segmentation including a QSR-book configuration, according to embodiments.

FIG. 52 is a block diagram illustrating a QSR-PN QSOC hierarchical configuration, according to embodiments.

FIG. 53 is a block diagram illustrating a QSR-PN QSOC direct connect configuration, according to embodiments.

FIG. 54 is a block diagram illustrating a QSR-PN QSOC mesh connect configuration, according to embodiments.

FIG. 55 is a block diagram illustrating a QSR-PN QSOC having a hybrid hierarchical mesh configuration, according to embodiments.

FIG. 56 is a block diagram illustrating a QSR-PN QSOC including a QSR-gateway mesh configuration, according to embodiments.

FIG. 57 is a block diagram illustrating a QSR-PN QSOC including a hierarchical QSR-gateway configuration, according to embodiments.

FIG. 58 is a block diagram illustrating a QSR-PN QSOC including a QSR-gateway having a hierarchical mesh configuration, according to embodiments.

FIG. 59 is a block diagram illustrating a QSR-PN QSR-router direct connect configuration, according to embodiments.

FIG. 60 is a block diagram illustrating a QSR-PN backbone configuration, according to embodiments.

FIG. 61 is a block diagram illustrating a QSR-PN configurations including an edge QSR-router and QSR-book, according to embodiments.

FIG. 62 is a block diagram illustrating a QSR-PN configurations for a small office or home office, according to embodiments.

FIG. 63 is a block diagram illustrating a configuration of QSR-PN migration from edge to endpoint, according to embodiments.

FIG. 64 is a block diagram illustrating configurations of a QSR-PN securing an edge device, according to embodiments.

FIG. 65 is a block diagram illustrating QSR-embedded device configurations, according to embodiments.

FIG. 66 is a block diagram illustrating enterprise applications migration to QSOC QSR-spps, according to embodiments.

FIG. 67 is a block diagram illustrating features, functions and capabilities of a QSR system, according to embodiments.

FIG. 68 is a block diagram illustrating features, functions and capabilities of a cloud native security platform (CNSP), according to embodiments.

FIG. 69 is a block diagram illustrating features, functions and capabilities of a QSR-PN, according to embodiments.

FIG. 70 is a block diagram illustrating features, functions and capabilities of a QSN-PN and security operating center (SOC) systems, according to embodiments.

FIG. 71 is a block diagram illustrating features, functions and capabilities of a QSR-private cloud, according to embodiments.

FIG. 72 is a block diagram illustrating features, functions and capabilities of a QSR-PC and QSR-PN, according to embodiments.

FIG. 73 is a block diagram illustrating features, functions and capabilities of a QSR-PC and SOC systems, according to embodiments.

FIG. 74 is a block diagram illustrating features, functions and capabilities of a QSR-PN and QSR-private cloud and SOC systems, according to embodiments.

FIG. 75A is a block diagram illustrating a QSR-PN with a full CNSP configuration, according to embodiments.

FIG. 75B is a block diagram illustrating a QSR-PN with a basic server configuration, according to embodiments.

FIG. 76 is a block diagram illustrating QSR-PN/QSR-encryption (EN)/QSR-Agent functions implemented at endpoint processors, according to embodiments.

FIG. 77A is a sequence diagram illustrating a sequence of QSR-EN for the establishment of a secure tunnel between an originating device and a destination device, according to embodiments.

FIG. 77B is a sequence diagram illustrating a sequence of QSR-EN for the establishment of a secure tunnel between an originating device and a destination device, according to embodiments.

FIG. 77C is a sequence diagram illustrating a sequence of QSR-EN for the establishment of a secure tunnel between an originating device and a destination device, according to embodiments.

FIG. 78 is a block diagram illustrating QSOC incremental growth in a mesh configuration, according to embodiments.

FIG. 79 is a block diagram illustrating QSOC incremental growth in a hub and spoke configuration, according to embodiments.

It will be noted that throughout the appended drawings, like features are identified by like reference numerals.

### DETAILED DESCRIPTION

Various features of the invention will become apparent from the following detailed description taken together with the illustrations in the Figures. The design factors, construction and use of the systems and methods disclosed herein are described with reference to various examples representing embodiments which are not intended to limit the scope of the invention as described and claimed herein. The skilled technician in the field to which the invention pertains will appreciate that there may be other variations, examples and embodiments of the invention not disclosed herein that may be practiced according to the teachings of the present disclosure without departing from the scope and spirit of the invention.

### Definitions

Unless defined otherwise, all technical and scientific terms used herein have the same meaning as commonly understood by one of ordinary skill in the art to which this invention pertains.

The use of the word “a” or “an” when used herein in conjunction with the term “comprising” may mean “one,” but it is also consistent with the meaning of “one or more,” “at least one” and “one or more than one.”

With reference to a system or process of the present disclosure, the terms “comprising,” “having,” “including” and “containing,” and grammatical variations thereof, as used herein, are inclusive or open-ended and do not exclude additional, unrecited elements and/or method/process steps. The term “consisting essentially of” or “essentially consisting of” denote that additional elements and/or method/process steps may be present, but that these additions do not materially affect the manner in which the recited elements and/or method/process steps function. The term “consisting of” when used herein in excludes the presence of additional elements and/or method steps. A system or process and any aspect thereof described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to.

The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the invention and not intended to limit the scope of the invention.

The term, “quantum secure” (abbreviated as “QS”), refers to an encryption technique that is proven to be mathematically unbreakable. At this time, a known mathematically unbreakable encryption technique is a pure one time pad (OTP) implementation. It will be readily understood that other quantum secure implementations may be available or developed in the future and these encryption techniques are to be considered within the intended scope of quantum secure.

The term, “quantum resistant” (abbreviated as “QR”), refers to an encryption technique that while it cannot be proven to be mathematically unbreakable, there may be current technology or potential future computing technologies and algorithms may be capable of breaking a strong quantum resistant encryption technique. It will be readily understood that other quantum resistant implementations may be available or developed in the future and these encryption techniques are to be considered within the intended scope of quantum resistant.

The term “quantum secure/resistant” (abbreviated as “QSR”) is used to refer to one or more products and solutions which integrate implementations that are considered to be either quantum secure or quantum resistant.

The term, “ecosystem” refers to the features, functions, services, products and infrastructure enabling a solution and or service. For example a QSR ecosystem (abbreviated as “QSR-E”), can be considered to encompass the features, functions, products and services that provide an ecosystem that is quantum secure/resistant.

The term “quantum security operations center” (abbreviated as “QSOC”) refers to and includes one or more of hardware, software and firmware that upon activation or operation at least in part provisions the creation of a QSR-E. It is to be understood that in some instances, for example to provide particular enhancements to a QSR-E, there may be one or more security operations personnel that may modify one or more of hardware, software and firmware associated with a QSOC in order to provide the particular enhancement to an end user of the QSR-E.

The term software/firmware is used to define one or more of software and firmware. For example, according to embodiments, a QSR private network (abbreviated as “QSR-PN”) can be created by the association of QSR-PN software/firmware upon installation and activation on two or more devices.

It is contemplated that any embodiment of the systems, components thereof, and methods disclosed herein can be implemented by one skilled in the art, as is, or by making such variations or equivalents without departing from the scope and spirit of the invention.

The present invention relates to the field of cyber security and more particularly to solutions leveraging quantum secure/resistant private network (QSR-PN) enabled components, systems and methods for securing digital network environments to render them with a level of quantum secure/resistant (QSR) security against current and future cyber threats, which may arise from the advent and more widespread usage of quantum computing technologies.

### Quantum Secure/Resistant Secure Communication Channel

According to the disclosure, there is provided systems and methods to create a quantum secure/resistant secure communication channel (QSR-SCC) for communication between two or more endpoints, by establishing a secure (encrypted) communication tunnel between end-points, End-points can be located at or within devices, applications, services, application programming interfaces (APIs) and/or communication protocols. As used herein, end-point refers to a communication linkage point at or within a device, application, a service, an API, and/or a communication protocol, which can be secured when operatively associated with an encryption engine, KPADs, and means to provide authentication, authorization functionalities. Said means for providing authentication and authorization functionalities may in one embodiment be mediated using a QSR-Agent to deploy (at least in part) said functionalities. The QSR-Agent more generally supports the ability to manage, monitor or control aspects of an end-point, e.g., to additionally retrieve or modify the end-point, for example, by getting lists of versions of applications running on a device, retrieving log files and/or applying patches.

Alternative means for providing authentication functionalities may include, for example, the implementation of user names with passwords, MFA (including third party MFA systems), certificate based solutions, biometric data based authentication, OAuth/OAuth2 methods, and single sign-in solutions or strategies. Alterative means for providing authorization functionalities may include role-based access control (RBAC), attribute-based access control (ABAC), API keys, OAuth Scopes, JWT Claims, as well as IAM and policy management orchestration systems.

In the present disclosure the encryption engine may provide or perform an array of cryptographic functions for both data communications, and data at rest. Cryptographic functions refer to the cryptographic tasks including but not limited to encryption, decryption, hashing, signing, and key exchange.

End-points can be located at or within devices, wherein the security aspects of the devices have been enhanced to ensure quantum secure/resistant communication by operatively associating the device with a encryption engine, KPADS, and means to provide authentication and authorization functionalities to become QSR-Devices. When end-points are located at or within devices, the system will be described with reference to an originating device and/or a destination device. It is to be understood however, that devices are just one example of where end-points can be located and the system is not to be limited to configurations where end-points are only located at or within devices.

Devices to optionally be considered as part of the system include desktop computers, tablets, thin clients, printers, scanners, network-attached storage (NAS) external storage devices, input devices, smartphones, feature phones, smart watches, Internet of Things (IoT), smart home appliances, environmental sensors, wearable health devices, medical devices, vehicle computers, embedded systems such as functioning within larger mechanical or electrical systems, connected vehicles, surveillance and security devices such as cameras and access control systems, Industrial Internet of Things (IIoT), industrial sensors, manufacturing robots, telemetry devices, routers, switches, firewalls, proxies, programmable logic controllers (PLCs), remote terminal units (RTUs), supervisory control and data acquisition (SCADA) systems, distributed control systems (DCS), safety instrumented system (SIS), etc. One skilled in the art would appreciate that other devices to be developed in the future may be equally amenable to be part of the system or otherwise rendered quantum secure/resistant according to the disclosure.

End-points can be located at or within applications wherein the security aspects of the applications have been enhanced to ensure quantum secure/resistant communication by operatively associating the device with an encryption engine, KPADS, and means to provide authentication and authorization functionalities to become QSR-Applications. Applications to be considered optionally part of the system include traditional software installed on company servers, end user computers, computer peripherals, IoT devices, on premise applications, cloud applications such as SaaS, PaaS, and IaaS, mobile applications, such as applications located on smartphones and tablets. Applications include desktop applications, web applications, mobile applications, enterprise applications, embedded systems, database applications, gaming applications, multimedia applications, educational applications, utility applications, communication applications, simulation and modeling applications, end-to-end encrypted messaging applications, secure email services, virtual private networks (VPNs), secure voice and video call applications, secure file transfer and sharing applications, secure browsing applications, secure collaboration platforms, two-factor/multi-factor authentication applications, password managers, secure networking applications, incident response and forensics tools, secure IoT communication platforms, etc. One skilled in the art would appreciate that other applications to be developed in the future may be equally amenable to be part of the system or otherwise rendered quantum secure/resistant according to the disclosure.

End-points can be located at or within services wherein the security aspects of the services have been enhanced to ensure quantum secure/resistant communication by operatively associating the service with a encryption engine, KPADS, and means to provide authentication and authorization functionalities to become QSR-Services. Services to be considered optionally part of the system include both internal and external services within the QSR-E, including but not limited to web services, collaboration/messaging services such as WhatsApp, Signal, Facebook, Zoom. Services include financial services, healthcare services, government services, intelligence services, defense (military) services, E-commerce services, local system and cloud storage and data center services, legal and compliance services, telecommunications services, transportation and logistics services, research and development services, clinical trial services, insurance services, energy and utility services, educational services, media and entertainment services. One skilled in the art would appreciate that other services to be developed in the future may be equally amenable to be part of the system or otherwise rendered quantum secure/resistant according to the disclosure.

End-points can be located at or within application programming interfaces (APIs) wherein the security aspects of the APIs have been enhanced to ensure quantum secure/resistant communication by operatively associating the API with an encryption engine, KPADS, and means to provide authentication and authorization functionalities to become QSR-API. APIs include authentication and authorization APIs, data storage and retrieval API's, analytics and reporting APIs, payment and transaction APIs, communication APIs, workflow and process automation APIs, IoT device management APIs, collaboration and productivity APIs, inventory and supply chain APIs, monitoring and logging APIs, security and compliance APIs, web APIs, local on-premises and cloud application APIs, secure messaging and communication APIs, hardware security module (HSM) APIs, and other secure communication libraries and services. APIs to be further considered optionally part of the system include QSR-SSL based APIs for web services, database APIs, hardware APIs, which communicate directly with hardware such as a printer, system APIs such as internal operating system (IOS) services, and data repositories, etc. One skilled in the art would appreciate that other APIs to be developed in the future may be equally amenable to be part of the system or otherwise rendered quantum secure/resistant according to the disclosure.

End-points can be located at or within secure communication protocols (SCP), not to be confused with secure copy protocol, wherein the security aspects of the secure communications protocol have been enhanced to ensure quantum secure/resistant communication by operatively associating the SCP with an encryption engine, KPADs, and means to provide authentication and authorization functionalities to become QSR-SCPs. Secure communication protocols include but are not limited to: transport layer security (TLS) and Secure Sockets Layer (SSL), internet protocol security (IPsec), secure/multipurpose internet mail extensions (S/MIME), secure shell (SSH), WebSocket secure (WSS), real-time transport protocol (RTP) with secure RTP (SRTP) transparent data encryption (TDE) for data at rest, advanced encryption standard (AES) for data at rest, pretty good privacy (PGP) and GNU privacy guard (GPG), Linux unified key setup (LUKS) trusted platform module (TPM), public key infrastructure (PKI), HTTPs, SSL/TLS, OAuth/OAuth2, SAML, OpenID, JWT, API Keys, WS Security, Secure Copy Protocol. Additional protocols that may be enhanced with KPAD solutions include email services such as simple mail transport protocol (SMTP), internet message access protocol (IMAP), post office protocol version 3 (POP3), message application programming interface (MAPI), Webmail, local mail transfer protocol (LMTP), or custom protocol services such as Proton mail services. One skilled in the art would appreciate that other communication protocols to be developed in the future may be equally amenable to be part of the system or otherwise rendered quantum secure/resistant according to the disclosure.

One skilled in the art would appreciate that APIs and communication protocols reside within or interact with applications, which reside on devices and some of which provide services. It is to be understood that each of these end-point categories are illustrated throughout the disclosure in conjunction with the various configurations of the systems, methods and the construction of QSR-Ecosystems.

### Quantum Secure/Resistant Private Network (QSR-PN)

When the secure communication tunnel within a QSR-SCC is established by modifying a VPN solution to operatively associate it with an encryption engine, KPADS, and means to provide authentication and authorization functionalities, the QSR-SCC will be referred to as a quantum secure/resistant private network (QSR-PN).

The aspects of a QSR-E will be described by referring to embodiments of a QSR-PN, but it is to be understood that a QSR-E may include embodiments of a QSR-SCC in the alternative to or in addition to a QSR-PN. Furthermore, a QSR-PN could include endpoints that can be located at or within devices, applications, services, application programming interfaces (APIs) and/or communication protocols, and may thereby include one or more QSR-SCCs.

In embodiments, the QSR-PN extends existing VPN solutions like WireGuard, OpenVPN, StrongSwan among others, with cross VPN interoperability features, including the incorporation of specialized pre-shared KPAD keys, augmented handshake mechanisms, and interchangeable ciphers, for example stream ciphers or block ciphers, for enhancing security and quantum resistance associated with the QSR-PN. The QSR-PN cross VPN framework is a unified software development kit (SDK) that can include multiple application programming interfaces (APIs) and libraries that facilitate integration and operation across multiple VPN protocols and technologies.

According to some embodiments, the system configured to create a QSR-PN can include QSR-PN software/firmware that is present and operative on two or more end-points. As such, a QSR-PN can be created between these two or more end-points upon activation or operation of the software/firmware associated with the QSR-PN. A QSR-PN solution can provide the ability to custom integrate, extend or integrate and extend existing open source or proprietary virtual private network (VPN) solutions. Example of such VPN solutions can include Wireguard, OpenVPN, StrongSwan, or other VPN solutions as would be readily understood. According to embodiments, a QSR-PN includes a set of libraries, source code, and techniques that leverage one time pad (OTP) based keys (herein referred to as KPADs) to augment existing cryptography solutions such as VPNs. While leveraging these libraries, existing VPN solutions can be extended, augmented, or extended and augmented in order to create QSR solutions which include a QSR-PN.

According to embodiments, there is provided a method for creating a quantum secure/resistant private network (QSR-PN) for communication between two or more end-points. End-points can be located at or within devices, applications, services, application programming interfaces (APIs) and/or communication protocols. The method includes generating, by the originating end-point, an encrypted handshake using a cipher key retrieved from an originating KPAD, the originating KPAD including multiple sets of true random number generator (TRNG) bytes of cipher key data configured with a QSR-E key structure, the encrypted handshake including information indicative of the originating end-point. The method further includes transmitting, by the originating end-point, the encrypted handshake to a destination end-point together with an indication of the cipher key and receiving, by the destination end-point, the encrypted handshake and the indication of the cipher key. The method includes retrieving, by the destination end-point, the cipher key from a destination KPAD, the destination KPAD associated with the originating KPAD, the retrieving based at least in part on the indication of the cipher key and decrypting the encrypted handshake using the cipher key to obtain the handshake and the information indicative of the originating end-point for the destination device to thereby authenticate the originating device. Upon authentication of the originating end-point by the destination device, the method further includes generating, by the destination end-point, a second encrypted handshake using an ephemeral key created, derived or generated from the destination KPAD, the second encrypted handshake including information indicative of the destination end-point. The method includes transmitting, by the destination end-point, the second encrypted handshake to the originating end-point together with an indication of the ephemeral key and receiving, by the originating end-point, the second encrypted handshake and the indication of the ephemeral key. The method further includes retrieving, by the originating end-point, the ephemeral key from the originating KPAD, the retrieving based at least in part on the indication of the ephemeral key and decrypting the second encrypted handshake using the ephemeral key to obtain the handshake and the information indicative of the destination end-point for the originating device to thereby authenticate the destination device. Upon authentication of the destination device by the originating device, the method includes establishing an encrypted communication session (a tunnel) between the originating end-point and the destination end-point at least in part based on the ephemeral key.

According to embodiments, there is provided a system configured to create a quantum secure/resistant private network (QSR-PN) for communication of data between two or more end-points. The system includes an originating end-point and a destination end-point. The originating device includes an originating KPAD loaded in memory on the originating end-point, the KPAD including multiple sets of true random number generator (TRNG) bytes of cipher key data configured with a QSR-Ecosystem key structure. The originating end-point further includes an originating cipher module configured to use a cipher key received from an encryption engine, the cipher key used by the cipher module to transform the data into cipher data and an originating encryption engine configured to perform logic of providing the cipher module with the cipher key obtained from the KPAD. The originating end-point further includes an originating communication module for transmitting the cipher data and an indication of the cipher key to a destination end-point. The destination device includes a destination communication module for receiving the cipher data and the indication of the cipher key from the originating end-point and a destination KPAD loaded in memory on the destination end-point, the destination KPAD associated with the originating KPAD. The destination end-point further includes a destination cipher module configured to use a decryption cipher key received from a destination encryption engine, the decryption cipher key used by the cipher module to transform the cipher data into the data. The destination end-point additionally includes a destination encryption engine configured to perform logic of providing the destination cipher module with the decryption cipher key obtained from the destination KPAD based at least in part on the indication of the cipher key received from the originating end-point.

In some embodiments, the system for the creation of a QSR-SCC includes an optional capability to perform end-point and user authentication and authorization after establishing a secure encrypted communication tunnel. Upon establishing a secure communication tunnel between origination and destination end-points, for example when they are located at or within a QSR-Router and QSR-Gateway, the origination encryption engine will make a call to the API provided by the QSR-Agent process running in association with the origination end-point to perform device and/or optional user authentication with the destination device and/or ecosystem.

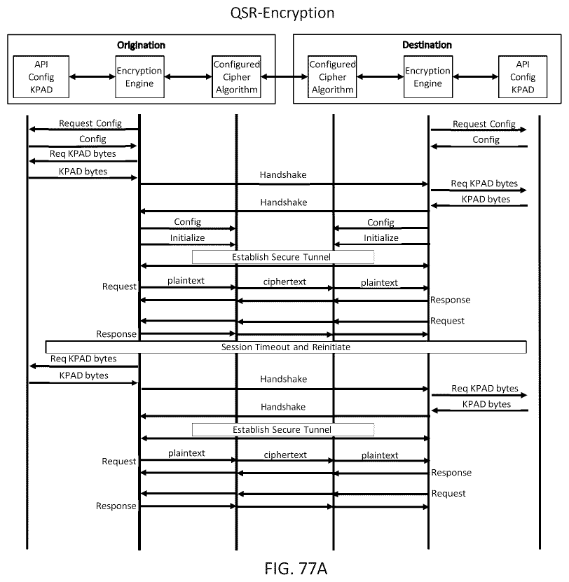

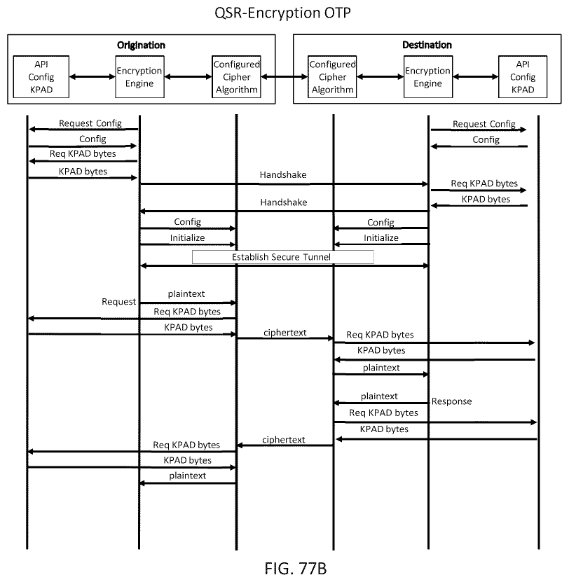

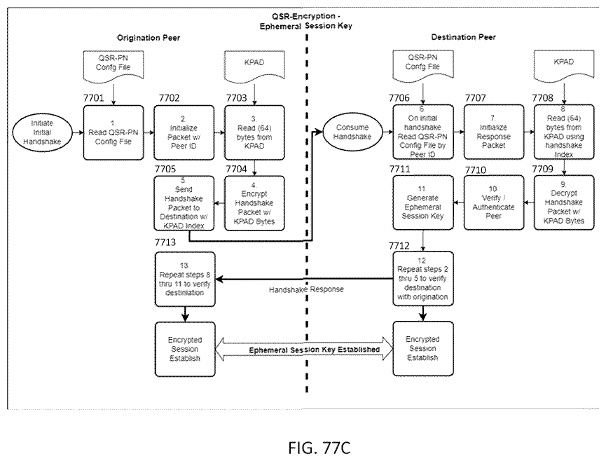

For orientation of the overall configuration according to embodiments, FIG. 77A and FIG. 77B, depict some of the relationships between components within a QSR-SCC, configured as a QSR-PN, wherein the end-points are located at or within QSR-Devices (e.g., a QSR-Router and QSR-Gateway). Upon establishing the secure communication tunnel as described in FIG. 77A and FIG. 77B, the encryption engine will perform the following steps. (1) Encryption engine calls authentication method on the QSR-Agent API, passing the device fingerprint, and user running upon the device, to authenticate both the QSR-Device and user running on the QSR-Device to the QSR-E. (2) The QSR-Agent, upon receiving the authentication request will delegate the authentication request to the IAM service API running within the QSR-E passing the device fingerprint and user credentials. (3) The IAM service API running within the QSR Ecosystem will then validate the device credentials (fingerprint) and user credentials to determine whether both the device and user running upon the device have the required permissions to access to the QSR Ecosystem and network. In one embodiment, the QSR-Agent to IAM service authentication will be performed via a zero trust knowledge proof leveraging the end-point located at or within a QSR-Device and user credentials. In other embodiments, this may be performed utilizing different traditional and/or new authentication methods. If either the end-point located at or within the QSR-Device and/or user running upon the end-point located at or within the said device do not have the necessary permissions to access to the network, the communication tunnel will be silently terminated and the end-point located at or within the QSR-Device communication will be disconnected. (4) If both the end-point located at or within the QSR-Device and user are authenticated and have necessary permissions to access the QSR-PN network and ecosystem, then access to the QSR-PN network will be granted. (5) Upon valid authentication of both the end-point located at or within the QSR-Device and user running on the device, the IAM service will interact with associated UEM and PO services running within the ecosystem to query permissions available for the user running upon the end-point located at or within the QSR-Device. (6) The IAM service will then interact with other services within the ecosystem to open network communication channels to authorized systems, networks, applications and/or services based upon both the device and user permissions and policies that are defined. (7) The necessary permissions and authentication and/or authorization response information will be returned to the QSR-Agent on the origination device along with successful response notification. (8) The QSR-Agent will return the authentication/authorization response and optional permissions back to call the encryption engine, and the encryption engine will finalize the establishment of a quantum secure/resistant communication tunnel.

In some embodiments, the QSR encryption engine may perform the authentication process separately from the authorization process as defined above. In this case, the said encryption engine will perform separate calls to the QSR-Agent API running upon the device to first authenticate the device, then authorize the device (open network communication routes and get network permissions), then authenticate the user, then authorize the user on the device. Note that all of these calls will be from the QSR-Agent to one or more of the following API's as may be defined: IAM service API, UEM service API, PO service API, or other API's as may be available.

In some embodiments, the system for the creation of a QSR-SCC includes a number of end-points located at or within quantum secure/resistant (QSR) communication devices, which have been hardened and adapted to function to route data in a QSR-SCC. The devices include one or more quantum secure/resistant gateways (end-point located at or within QSR-Gateways), one or more quantum secure/resistant routers (end-point located at or within QSR-Router). There are additional embodiments to support the ability to locate end-points at or within many additional types of QSR-Devices, including but not limited to QSR-Book (desktop or laptop computers, iPad, ChromeBook, or other computing devices), QSR-Phone which is a solution to provide quantum secure/quantum-resistant communications on mobile/cellular devices both at the application layer (VPN) or at a low-level cellular communication layer, QSR-Adapter which is a device that can be connected to an existing computing device to support a bump-in-the-wire solution for network connectivity, QSR-Embed where other device types including, but not limited to internet of things (IoT), industrial IoT (IioT), Industrial Control Systems (ICS)/SCADA, that leverage QSR-PN application programming interfaces (API)'s and software development kits (SDK's) to enable QSR-SCC communications on said devices.

According to embodiments, an end-point located at or within a QSR-Device includes a plurality of KPADs, wherein each KPAD includes multiple sets of true random number generator (TRNG) bytes of key data sequenced in a sequentially ordered fashion and configured with a QSR-E key structure. Each of the plurality of KPADs can be configured to be used by an encryption engine to encrypt a communication between the two or more devices, wherein each of the plurality of KPADs are at least in part known by the two or more devices in question.

According to embodiments, an end-point located at or within QSR-Device includes one or more quantum secure/resistant endpoint management services (QSR-Agent), wherein a QSR-Agent is installed or operatively connected with a particular device and wherein the QSR-Agent is operative to interact with the system in order to provide access to the QSR-PN by the particular device.

According to embodiments, the system also includes key management services including one or more true random number generators (TRNG), the TRNG configured to generate quantum secure random numbers for use in the plurality of KPADs, in addition to a quantum key management system (QKMS), wherein each of the plurality of KPADs is minted (created) and centrally managed by the QKMS.

In one embodiment, the system provides the ability for raw TRNG data to be provided by a customer or third party, and the KPAD can be created using externally provided TRNG data. This can be done either through accessing the raw data from a secure storage device containing the TRNG data, or through application program interfaces (APIs) that integrate 3rd party TRNG generation mechanisms.

According to embodiments, the system also includes system management services. The system management services include one or more identity and access management service (IAM) configured to manage user and-end-point identity, access, and authorization services operatively associated with the QSR-SCC, one or more universal endpoint managers (UEM), wherein each UEM is configured to manage end-points (e.g. at or within devices) of the QSR-SCC, and one or more end-point authorization (Auth) services (e.g. user and endpoint devices), wherein each Auth is configured to interface with the IAM to remotely manage one or more end-points associated with the QSR-SCC.

In addition, according to embodiments, the system includes one or more firewalls, wherein each firewall is configured to provide capabilities including one or more zero trust access, ingress and/or egress, and network traffic inspection, the firewall providing the capabilities between devices, platforms, applications and services within and between different systems outside of the QSR-PN.

According to embodiments, wherein an end-point is located at or within a QSR-Gateway, a QSR-Gateway is operatively connected to the IAM, the QSR-Gateway can be configured for access by the two or more devices and to facilitate communication between the two or more devices through the QSR-PN. QSR-Devices, including QSR-Routers, QSR-Books, QSR-Phones, QSR-Embed among others, are deployed at a location remote from the QSR-Gateway, wherein the QSR-Device is configured to secure a remote communication tunnel with the system.

According to embodiments, initially a secure communication tunnel is created between a first user-end-point and a second user end-point of the QSR-SCC upon verification and authorization of the end-points being used for communication. Upon creation of this communication tunnel a second identification and authorization step is performed in order to ensure that the specific end-points requesting the creation of a QSR-SCC for communication are in fact authorized. In addition, a QSR-SCC provides a one-time pad key structure, herein defined as a KPAD, which can include random entropy data (for example, raw key material) and metadata information that provides information about the KPAD, to be used as a security key by each of the two communicating devices.

According to embodiments, a KPAD is a symmetric key structure, including multiple sets of true random number generator (TRNG) bytes (e.g. Entropy key data, cesium decay data, etc.) of key data sequenced in a sequentially ordered fashion. As an example, a KPAD could be generated as 10 sets of 10 MB TRNG bytes of key data sequenced in a sequentially ordered fashion to compose a 100 MB KPAD. The raw key data is generated utilizing one or more well-known techniques available to generate TRNG, including hardware random number generators (HRNG) or other methods. Multiple HRNG systems called TRNG appliances can be utilized to generate sets of random key data that will subsequently be used for the creation or generation of a new KPAD.

According to embodiments, each KPAD is given a unique identifier, associated with metadata to describe the size, physical storage location, attributes, and usage properties of the key data, and is shared between two peer systems or peer devices that are using that KPAD for enabling the QSR-SCC therebetween. In some embodiments, a KPAD can be shared between more than two peer systems or peer end-points, wherein said peer systems or peer end-points are engaging in a group type communication using a QSR-SCC, for example a group chat, broadcast system or the like. According to some embodiments, a peer system or peer device can be end-points located at or within QSR-Devices, QSR-Appliances, QSR-Accessories, applications, or services within a QSR-E.

However, in some embodiments, the peer systems or peer devices can be configured to create and use a QSR-SCC wherein the QSR-SCC software/firmware is present and operating on the associated peer systems or peer devices.

According to embodiments, the KMS system is responsible for composing (minting) KPADs from the generated or 3^{rd} party provided TRNG key data into a single KPAD and protecting the KPAD within a hardware security module (HSM) subsystem within the KMS. According to some embodiments, a KPAD can be protected by other techniques for example an information dispersal algorithm (IDA) or stored on a secure storage device, for example a secured thumb drive or disc. KPAD's are then securely distributed between different systems such as end-points located at or within QSR-Devices, QSR-Appliances, applications, or services and used within different parts of the QSR-PN.

According to embodiments, there are several principal properties of a KPAD that are desired. These properties can include features such that the key data is truly random and the key data is never reused. Further properties can include features such that data encrypted (e.g. ciphertext) generated with the key data is at least as long as the plain text. In addition, a key or key data is maintained completely secret and is physically securely stored on devices that are utilizing said key or key data.

Additionally, according to embodiments, KPADs provide additional attributes that are leveraged in constructing the QSR-PN services and solution. The additional attributes include:

1. KPADs are consumable data objects such that as the random key data is utilized, this key data is physically destroyed and/or overwritten and destroyed from the end-point holding the KPAD and utilizing the KPAD key material. As would be readily understood, an end-point holding the KPAD can be envisioned in a variety of configurations, for example a thumb drive, flash drive, disc or other device as would be readily understood.

2. KPADs are bound to end-points utilizing them and all subsystems utilizing the KPAD key material are responsible for validating that the end-point is authorized to utilize the KPAD. When end-points located at or within QSR-Devices are initially provisioned, KPADs will be physically deployed onto the end-points located at or within QSR-Devices. Once an end-point located at or within a QSR-Device has been deployed into the field, KPADs can be exported to KPAD export packages and physically shipped to the location where the end-point located at or within a QSR-Device exists. The KPAD export package can be imported onto the end-point located at or within a QSR-Device by an administrative user of the end-point located at or within a QSR-Device.

3. When KPADs are distributed, the raw key material is encrypted utilizing envelope encryption (eg. Data encryption key/key encryption key (DEK/KEK) strategy or other format of encryption). For example, when utilizing a KPAD, the subsystem using the KPAD is required to use the associated data encryption key to decrypt the raw key data prior to utilizing the KPAD key data for encrypting/decrypting data. In other words, the KPAD key material is encrypted itself and is to be decrypted prior to utilizing for encrypting/decrypting other data or messages. It is to be understood that only authorized devices will be granted access to the encryption key for the specified KPAD.

5. KPADs are extensible and support the ability to add additional key data to an existing KPAD within the KMS system. The updated KPAD containing the additional key data will be stored within the KMS and is exportable to a KPAD export package, that provides the ability for it to be physically copied to an external media device such as external disk, tape, USB attached device, etc. In some embodiments, only meta data about a KPAD is stored in the KMS, wherein the KPAD itself only exists on the end-points located at or within devices that will use them. This provisioning of the KPAD can aid in the reduction of the attack surface of the QSR-SCC. The external media device can be attached to a QSR-Device subsystem and imported onto the device; effectively extending the size of the KPAD on the device. As discussed elsewhere herein, a KPAD distribution system has been provided for the suitable distribution of the one or more KPADs.

An embodiment of a method for using a KPAD is used within the QSR-SCC for communication within the QSR-E. In this embodiment, a KPAD is securely shared between two peer end-points and securely stored upon each peer end-point. While this peer end-point, when located at or within a device can be a QSR-Book or QSR-Router and a QSR-Gateway, the QSR-SCC can be provisioned between two peers end-points through software/firmware operative on these two peers end-points, as discussed elsewhere herein. In an instance where an end-point located at or within a QSR-Book is connected to an end-point located at or within a QSR-Router which is connected to an end-point located at or within a QSR-Gateway, the end-point located at or within a QSR-Book KPAD encrypts the transferred information and additionally the end-point located at or within a QSR-Router doubly encrypts the transferred information, thereby creating a double-encryption, wherein the end-point located at or within a QSR-Book data is tunneled across the end-point located at or within a QSR-Router to the end-point located at or within a QSR-Gateway.

In some embodiments, there is a KPAD pair, such that one of the KPAD pair is associated an originating end-point and a second of the KPAD pair is associated with a destination end-point. In some embodiments, a KPAD pair is a directional KPAD pair. A directional KPAD pair is associated with a particular direction of communication between an originating end-point and a destination-end-point. For example, when the originating end-point is transmitting to the destination end-point a first KPAD pair is used (i.e. one KPAD of the first KPAD pair associated with the originating end-point and a second KPAD of the first KPAD pair is associated with the destination end-point). When the destination end-point is transmitting to the originating end-point a second KPAD pair is used (i.e. one KPAD of the second KPAD pair associated with the originating end-point and a second KPAD of the second KPAD pair is associated with the destination end-point).

In one embodiment, the QSR-SCC is configured to utilize the KPAD to set up a one-time pad (OTP) cipher, for example a stream cipher or a block cipher, to construct a secure QSR-SCC tunnel. In a first configuration, for example envisioned as a tier 1, (a table of which is presented in TABLE 1), the raw KPAD key material must first be decrypted using the DEK prior to XOR'ing the data. In another configuration, for example envisioned as a tier 2, an amount of key material (wherein this amount may be configurable) is used to prime a cipher to encrypt/decrypt the message. The cipher continues to be used for a duration (which may be another configurable quantity) and then another amount of key material is consumed to re-prime the cipher and this process continues during the transmission.

In some embodiments, outbound communication messages from the end-point located at or within a QSR-Book to the end-point located at or within a QSR-Gateway are constructed which specify the KPAD key data index offset, packet size, and ciphertext generated using a simple XOR cipher of the KPAD key data and plaintext, and sent to the end-point located at or within a QSR-Gateway. The end-point located at or within a QSR-Gateway looks up the shared KPAD ID from its peer configuration, and then utilizes the KPAD key index offset and packet size to read the associated packet size number of KPAD key material in order to generate the plaintext from the specified message by XORing the ciphertext message with the DEK decrypted KPAD key data physically residing on the end-point located at or within a QSR-Gateway.

In some embodiments, the QSR-SCC is configured to use a KPAD as seed material with a cipher, which can be a stream cipher or a block cipher. A stream cipher can be considered to be an encryption technique that works byte by byte to transform plain text into code that is unreadable to anyone without the proper key. A block cipher is an encryption technique which includes encrypting data in blocks to produce ciphertext using a cryptographic key and algorithm. A block cipher processes fixed-size blocks simultaneously.

In an embodiment, the encryption algorithm used by the QSR-SCC is ChaCha20 Poly1305. The encryption algorithm used by QSR-SCC can be replaced as the cyber security community evolves and generates new ones, therefore the architecture for integration of the encryption algorithm for use with creation of a QSR-SCC is such that a new encryption algorithm can be added or removed in a relatively simple manner. Possible ciphers could be those proposed by NIST from the post-quantum cryptography project, such as CRYSTALS-Kyber, CRYSTALS-Dilithium, FALCON and SPHINCS+. Other algorithms that might be used are AES-GCM-SIV, AES-GCM, AES-CBC+HIMAC-SHA2, Elliptic Curve.

According to embodiments, a QSR-SCC is configured to support cross VPN interoperability which refers to the ability of a system or device associated with a QSR-PN to adopt new cryptographic algorithms and techniques without requiring significant modifications. In order to achieve this, the QSR-PN is developed as a set of application programming interfaces (APIs) and software development kits (SDKs) which can be integrated with limited effort into current versions of a QSR-PN. These APIs abstract common operations necessary for providing different types of secure network communication and provide concrete implementations of different encryption algorithms, ciphers, and utilities including hashing, digital signatures and the like.

An embodiment of a method for using KPADs within the QSR-SCC is in support of the Auth multi-factor authentication (MFA) solution. In this embodiment, a specific KPAD is distributed to both a end-point located at or within a QSR-Device such as a QSR-Book and also to a end-point located at or within a QSR-Wearable accessory. During the user authentication process, the end-point located at or within a QSR-Book will create an end-point located at or within a QSR-SCC (for example using a OTP) encrypted tunnel between the end-point located at or within a QSR-Book and the end-point located at or within a QSR-Wearable over Bluetooth low energy (BLE), near field communication (NFC), or other personal area communication protocol. The user will only succeed in authenticating to the end-point located at or within a QSR-Book if they physically have an end-point located at or within a QSR-Wearable device within communication range that contains the necessary KPAD for Auth MFA authentication. Once authenticated, the user credentials will be maintained and shared within the QSR-SCC system to the rest of the QSR-ecosystem (QSR-E) in order to provide and ensure necessary authentication, authorization, and zero trust policy management and orchestration throughout the QSR-E.

### QSR-Platform

Virtualizing computer systems provides benefits such as the ability to execute multiple computer systems on a single hardware computer, replicating computer systems, moving computer systems among multiple hardware computers, and so forth. “Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). More recently, hybrid cloud computing platforms have been developed. Hybrid cloud platforms refers to the ability of an enterprise to operate an enterprise application in a private and a public environment. Hyperconverged infrastructures are yet another step in the evolution of virtual computing system.

According to embodiments, the QSR-Platform provides connections to underlying components through API's, GUI's and direct access to programs. These connections in turn enable and allow the various components of the QSR-E to operate and to be operated as a whole. The QSR-Platform builds upon functionality, services and applications of the QSR-SCC, by adding new capabilities and deepening & widening the existing ones. Examples of the new capabilities added are end-points located at or within QSR-Space, QSR-Locker, QSR-Apps, etc. Examples of the deepening and widening are expanding identity and access management service (IAM) services to cover the new capabilities (for example, QSR-Space) or SIEM/SOAR where additional types of events are being captured and managed.

In some embodiments, the QSR-Platform can be a cloud provider such as (Amazon, Google, etc.), a co-location facility where equipment and software is installed or within a private datacenter located within a company's premises.

In some embodiments, the QSR-Platform acts as a Cloud Native Security Platform (CNSP) or a Cloud Native Application Protection Platform (CNAPP).

According to embodiments, the key elements of Cloud Native Security can include one or plural of inventory and classification, compliance management, network security, identity and access management (IAM) security, data security, vulnerability management, workload security and automated investigation and response.

In some embodiments, the one or both the QSR-Platform, the CNSP and the CNAPP include hyperconverged infrastructure (HCI). A hyperconverged infrastructure is a rack-based system that combines compute, storage and networking components into a single system to reduce data center complexity and increase scalability. Multiple nodes can be clustered together to create clusters and/or workload domains of shared compute and storage resources, designed for convenient consumption. Hyperconverged systems include dynamic software defined compute infrastructure that are virtual not only in the compute realm but also in the storage, networking and security realms. As the types of virtual compute environments evolve, ways to manage the distributed resources are also evolving. Workload domains are one such management resource concept used in the world of hyperconverged compute systems. Workload domains are physically isolated containers that hold a group of enterprise applications having similar performance, availability, and security requirements. When a workload is to be created, requirements of application(s) are translated into a number of servers having sufficient CPU, memory and storage capacity to support the applications. A workload having the required number of servers is then assigned to the workload domain. When more capacity is needed (whether CPU, memory and/or storage capacity), one or more additional servers can be added to the workload domain. Hyperconverged infrastructure can be sourced from a company such as Nutanix. Hyperconverged infrastructure can also be sourced from companies such as Microsoft, Dell, or Scale Computing.

In some embodiments wherein the QSR-Platform includes HCI, the following services/capabilities may be provided and can include one or plural of QSR-Enterprise Manager (QSR-EM), Scalable Compute, Software-Defined Networking (SDN), Disaster Recovery (DR), QSR Enterprise Asset Management (QSR-EAM), Network Management and Asset Repository, each of which are discussed in further detail below.

QSR-Enterprise Manager (QSR-EM)-According to embodiments a QSR-Enterprise Manager (QSR-EM) is the central single pane of glass management and monitoring console, that provides administrators with a unified view of interconnected QSR Ecosystems. This can be configured as a web-based application that can integrate with the HCI management console and other integrated security solution management consoles, enabling a security operations team the ability to operate and monitor devices, applications, and services within the QSR-E.

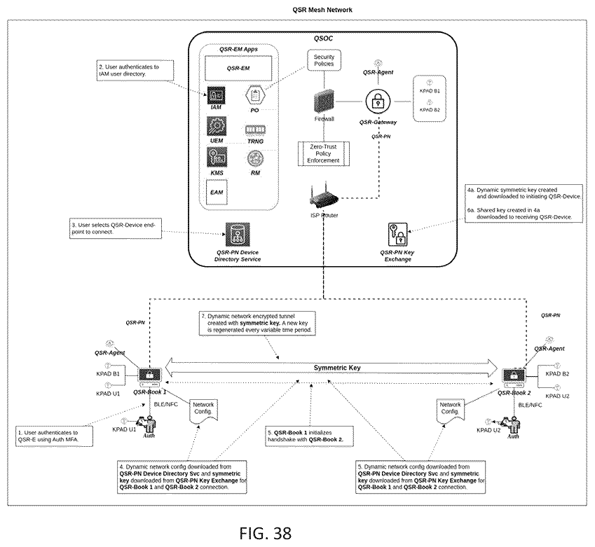

According to embodiments, the QSR-EM is a pluggable set of components providing both GUIs and APIs for each of the services such as IAM, UEM, EAM, etc. The QSR-EM includes various modules such as RM, TRNG, QSR-PN Key Exchange, which is discussed in further detail elsewhere herein including FIG. 38.

According to embodiments, the QSR-EM is configured in order that its component services can be included in other 3^{rd} party applications thereby providing flexibility regarding how users or automation can interact with the QSR-E. As an example, when a HCI is provided, the HCI administrative application can be used to access the QSR-E.

According to embodiments, the QSR-EM consolidates viewing of operation of a plurality of components into a single pane of glass view. For example, the QSR-EM can provide operative view and access to one or more of QSR-SCC and network management, private cloud hosted applications, security services which may include Asset Management, SIEM/SOAR interface, MDR interface, Nutanix infrastructure, border router and firewall, for example next generation firewall.

According to embodiments, the QSR-EM acts a central point to access other features and services such as IAM, PO, KMS, UEM, etc. Access to the QSR-EM is itself controlled through IAM and PO. The QSR-EM provides both a GUI and API allowing both human and machine interaction to the services it provides. In some embodiments, the GUIs can allow authorized users such as QSOC operators or clients access to services to configure, operate, monitor and change the components. IAM and PO rules combine to secure access to the services for all users. In some embodiments, The API's are used as integration points within the QSR-E to enable automation of some service functions and to allow authorized 3^{rd} party integrations to internal and external components. In some embodiments, QSR-EM is configured to support multi-tenancy, so users of the GUI or API will only be able to interact with the specific data for which they are specifically authorized. This provision of access may be provided by both data entered and retrieved being filtered in order to provide appropriate partitioning of the data. The QEM encompasses various modules such as RM, QRNG, QPN Key Exchange each of which are discussed in further detail elsewhere herein. For example, QSR-PN key exchange is further discussed with reference to FIG. 38. According to some embodiments, the QSR-EM can be configured as both a GUI and an API, wherein the QSR-EM can supply information via the API without using the GUI.

Scalable Compute-According to embodiments, the QSR-Platform (for example CNSP/CNAPP) can provide vertical and horizontal scaling of compute processing resources such as CPU and memory, provided by the nodes within the underlying HCI cluster or virtual private cloud (VPC). The nodes of the QSR-Platform can work together to create a scalable, available and high-performance compute environment. As more resources are needed, additional nodes can be added to the QSR-Platform to increase the available compute, memory and storage. The QSR-Platform can then supply these resources to existing or additional services or applications within the cluster.

According to embodiments, applications and services can be configured to be available by ensuring underlying storage is mirrored to other node(s) and the cluster (for example the QSR-Platform) can automatically restart it on another node should the node it is running on fail. As such, this can provide a level of redundancy for the operation of the QSR-Platform.

Software-Defined Networking (SDN)—According to embodiments, SDN capabilities can provide virtual network infrastructure within the CNSP HCI cluster. It enables administrators to create and manage virtual networks, subnets, and network policies.

According to embodiments, SDN is supplied by the QSR-Platform as a service to the applications and administrative tools, running within the QSOC. SDN is used by authorized applications to either statically or dynamically configure, and partition applications and services, which in turn provides further security isolation within the QSR-Platform.

According to embodiments, SDN enables applications to create, configure, monitor and destroy networks through the use of APIs and services, without the need for human intervention.

Disaster Recovery (DR)—According to embodiments, the CNSP can provide disaster recovery features on the underlying CNSP HCI clusters and enables organizations to securely replicate data between different CNSP clusters while utilizing the underlying QSR-PN associated therewith.

According to embodiments, the QSR-Platform can handle data replication of underlying data-stores within the QSR-E allowing specific point in time recovery should a node within the QSR-E fail.

According to embodiments, the QSR-Platform supplies a measure of resilience against single component failures within the hardware and software infrastructure. DR is designed to provide resiliency against catastrophic failures of a complete QSR-E node or in some cases multiple nodes, depending on the configuration and availability of resources.

QSR Enterprise Asset Management (QSR-EAM)—According to embodiments, the enterprise Asset Management (QSR-EAM) is a component of the QSR-E providing a holistic cybersecurity approach that centralizes the management of physical, and digital assets throughout their life cycle (during any stage of an asset's life-cycle as may be required or desirable). This may include a range of management tasks and services including without limitation, maintenance management, inventory management (e.g., procurement, disposal, replacement), asset tracking and location monitoring management, risk management, compliance and regulatory management, reporting and analytics management. Having proper management and control of assets can provide effective management of a Zero Trust environment and provide authentication and authorization of devices, applications, and services. The QSR-EAM can assist organizations identify anomalies, like unauthorized asset access or unusual behavior, further strengthening the Zero Trust model's efficacy. In some embodiments, EAM solutions that can be integrated into the QSR-Platform can be sourced from companies such as Microsoft, CrowdStrike, or PaloAlto.

Computer systems generally include operating systems and application software programs. An operating system provides system-wide management functions and an executing environment for application software programs, each of which performs a particular functionality.

The operating system and the application software programs of a personal computer are often configured according to a user's needs. Such configuration may be stored through a persistent mechanism, such as an on-disk file, so that when the computer is reset or restarted, the configuration settings can be read and the operating system or software applications can run with the stored settings. The user does not have to reconfigure the settings from scratch. However, when a computer is replaced or upgraded by another computer system, or when the operating system is changed from one to another, the application software programs and the configuration may be no longer usable and manual processes are often required to carry out such software program reinstallation and configuration for replacing or upgrading the personal computer. Further, when the number of the computers involved is large, which is often the case within a large organization, it may be time-consuming and even impractical to manage such reinstallation or upgrade due to the number of manual processes and operations.

A Network may include any appropriate network or networks. For example, network may include a wired network, wireless network, public network, private network, packet switched network, circuit-switched network, personal area network, local area network, wide area network, or any combination of networks such as the ubiquitous Internet. Network may be used to enable communications among a QSR-Server, third party computer, and computers.

A first local network and a second local network may represent local networks of an enterprise entity in multiple business locations, and each location may have its own local network. Computers include any appropriate computing device, such as a personal computer, server computer, workstation computer, laptop, palmtop, personal digital assistant (“PDA”), wireless communication device, cell phone, pager, or any other type of computing device. According to embodiments, with reference to QSR-EAM, the term computer refers to QSR-Routers, QSR-Gateways, QSR-Book, QSR-Appliances, CNSP servers and hardware systems, applications and services, QSOC servers and applications, and optionally any network attached devices such as third-party computers or peripherals comprising one or more end-points, if they have either been manually registered into the QSR-EAM system or have a QSR-Agent running upon them.

The enterprise entity may require computers to be installed, moved, added, and/or changed (IMAC). For example, a computer may be installed in a first local network; a computer may be moved from a first local network to a second local network; new hardware or software may be added on a computer; a computer may be changed from one type of operating system to another type of operating system; and/or a computer may be changed or upgraded, for example, from one version of operating system to another newer version of the same operating system (e.g., Windows 2000 to Windows XP, etc.). Such IMAC activities may be carried out by both the involved computers and a QSR-Server.

A third-party computer may include any appropriate computer system residing outside the enterprise entity, such as one or more computers from a service provider to provide certain services to the enterprise entity, or from a vender to provide certain hardware or software products or licenses. A third-party computer may communicate with an end-point located at or within a QSR-Server or any of computers via a network.

According to embodiments, a QSR-Server comprising one or more end-points may include a appropriate computer system that provides various server functionalities to manage the IMAC activities. For example, the sever functionalities may include providing central databases, software asset management, system management server (SMS) services, inventory management, security management and other network and/or system management, etc. A QSR-Server comprising one or more end-points may create various databases to manage computers within the enterprise entity.

For example, an QSR-Server comprising one or more end-points may track deployment and use of software assets and plan software procurement and licensing. An QSR-Server comprising one or more end-points may also maintain inventories of computer hardware and software to manage the population of the computers and to manage computers that roam from one location to another and connect to the network from different geographical locations. Further, a QSR-Server comprising one or more end-points may include various databases to store software releases or software packages, such as active directory, etc. In certain embodiments, a QSR-Server comprising one or more end-points may include multiple computer systems, and each may provide a particular functionality or may perform similar functionalities based on load-balancing techniques.

Network Management—According to embodiments, QSR-Platform and network management module within the QSR-EM provides administrators the ability to configure, manage, and monitor complex networks of interconnected devices and the QSR-PN within the CNSP and QSOC's. Authentication, authorization, KPAD encryption keys, and network configurations and policies can be managed from the QSR-EM centralized command and control center within the QSR-Platform.

Asset Repository—According to embodiments, the asset repository is an underlying data-store used by the QSR-EAM component. The asset repository can hold a list of the digital assets within the QSR-E, along with meta data about each asset. This can allow tracking of the various components for a wide range of uses, including securing access to the assets via IAM and PO. PO policies can use meta data about an asset within its rules, thus ensuring access to them is appropriately granted or denied.

According to embodiments, another use for the Asset Repository is to track information about versions of firmware and software. The version information can then be used to determine potential security vulnerabilities, provide the basis of planning component upgrades and assure version compliance across the QSR-E.

To reiterate, the aspects of a QSR-E are be described by referring to embodiments of a QSR-PN, but it is to be understood that a QSR-E may include embodiments of a QSR-SCC in the alternative to or in addition to a QSR-PN. Furthermore, a QSR-PN could include endpoints that can be located at or within devices, applications, services, application programming interfaces (APIs) and/or communication protocols and may thereby include one or more QSR-SCCs. Accordingly, the description of and figures illustrating components, functionalities, relationships, methods, configurations, etc., herein with reference to a QSR-PN, are in no way necessarily limited to a QSR-PN. It is to be understood that the description and figures do not in any way limit the system and methods of the disclosure being confined to contexts where a QSR-PN is used.

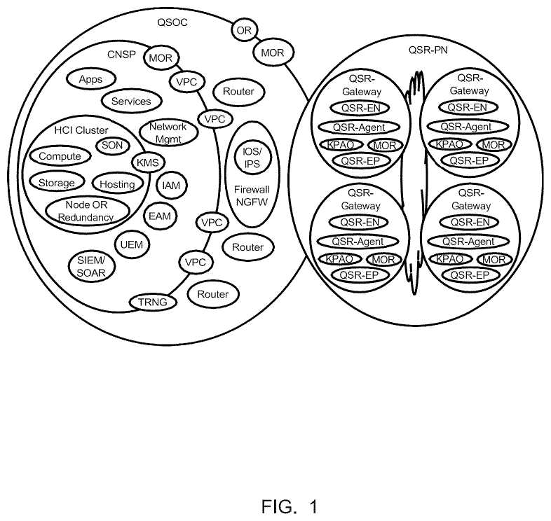

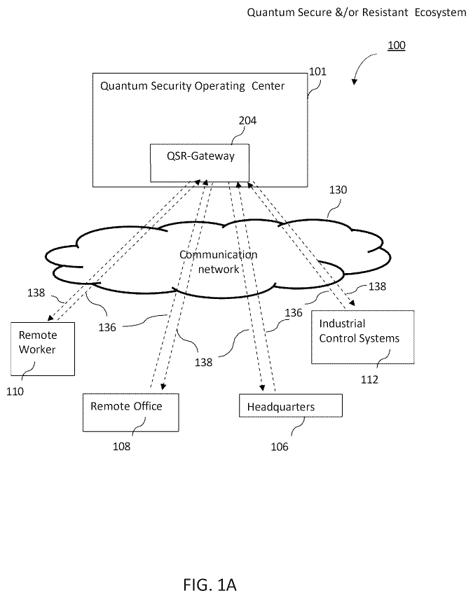

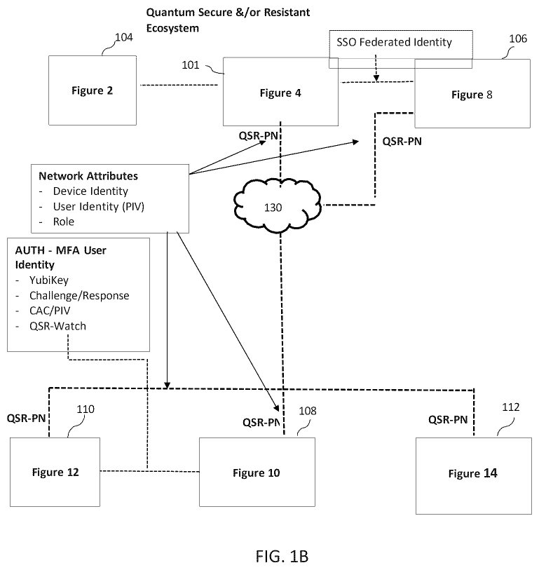

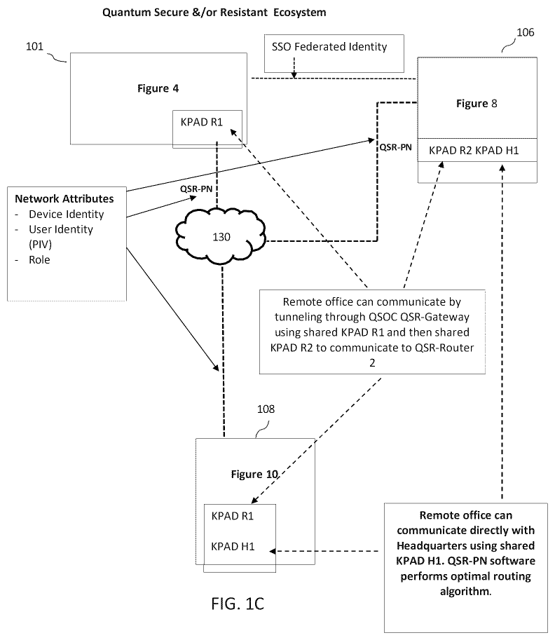

For orientation of the overall configuration according to embodiments, FIG. 1 depicts some of the relationships between components within the overall QSR-E. FIG. 1 is a block diagram of a QSR-E established by a QSR-PN and QSOC, according to embodiments. The main groupings are the QSOC, CNSP and QSR-PN. Starting with the QSR-PN, it resides partially within the QSOC as the QSR-Gateway can be physically located within the QSOC and also needs to provide access to CNSP components, for example the apps and services. The QSR-PN also resides outside of the physical location of the QSOC as most of its components are located at remote sites and provides the private network connections back the QSOC apps/services and to other remote sites connected to the QSR-PN. Further detail and discussion is presented elsewhere herein.

FIG. 1A is a generalized block diagram of a quantum secure/resistant ecosystem (QSR-E) created by a quantum security operations center (QSOC), according to embodiments.

FIG. 1B is a block diagram of a ecosystem QSR-E which is created by a QSOC, according to embodiments.

FIG. 1C is a block diagram of a QSR-E which is created by a QSOC, according to embodiments, wherein the system includes the ability for the QSR-PN to establish a direct secure communication between a remote office worker and the headquarters of the enterprise.

### Quantum Security Operations Center

According to embodiments, a quantum security operations center (QSOC) is configured to use a multi-tier security mechanism or protocol enabling the creation of a QSR-E.

According to embodiments, a QSOC includes one or more identity and access management services (IAM) which is configured to manage user and device identity, access, and authorization services, which can include the authorization of a computing device for subsequent creation of a secure communication tunnel and identity confirmation of a particular user of the device. A QSOC further includes a plurality of KPADs which are configured with a QSR-E key structure, wherein the KPADs are minted and centrally managed by a key management system (KMS) within the QSR-E. A QSOC further includes a quantum secure/resistant gateway (QSR-Gateway) which is configured to provide connectivity to a QSOC, thereby enabling devices to interact with a QSOC for creation of a QSR-E as a quantum private network.

According to embodiments, a QSOC further includes a true random number generator (TRNG) which is configured to generate quantum secure random numbers for use within the KPADs. The operation and configuration of the TRNG is under the control of the KMS.

In some embodiments, a QSOC further includes one or more universal endpoint managers (UEM). A UEM is configured to manage systems deployed throughout QSR-E, including for example appliances, user devices and accessories and the like.

In some embodiments, a QSOC further includes one or more policy orchestrators (PO). A PO can be configured to manage and deliver zero trust policy services within QSR-E. A PO can further be configured to orchestrate one or more of user, group, device, or other policies for providing access and control between systems, devices, services and applications.

In some embodiments, a QSOC further includes one or more user and endpoint device authorization (Auth) services. An Auth can be configured to interface with the IAM and optionally end-user devices to support multi-factor authentication (MFA) to devices, platforms, appliances, applications, and services within the QSR-E.

In some embodiments, a QSOC further includes one or more firewalls. A firewall can be configured to provide zero trust access, ingress/egress, and network traffic inspection capabilities between system devices, platforms, applications and services within and between different QSOCs.

According to embodiments, a QSOC further includes one or more endpoint management services (QSR-Agent) which may be installed or operatively connected with devices and platforms. The devices having an associated QSR-Agent can be configured to interface and be managed by a UEM.

According to embodiments, a QSOC further includes one or more risk managers (RM). A RM can be configured to assess and manage risk within the QSR-E and the associated devices and appliances connected thereto. In some embodiments, a RM can include one or more automated information gathering engines that aggregate system and device risk data and store this data within a centralized risk data repository. In some embodiments, a RM further includes one or more automated risk analysis modules that process system and device risk data to determine cyber and security risk ratings. In some embodiments, a RM further includes an application programming interface (API) configured to provide remote system access to a central risk data repository from 3^{rd} party risk assessment providers. As an example, a central risk data repository may be associated with an insurance company. In some embodiments, a RM further includes a web portal user interface configured to enable 3^{rd} party risk assessment providers, for example insurance companies, the ability to retrieve risk data information necessary to perform risk assessment calculations.

According to embodiments, a QSOC further includes a quantum secure/resistant platform (QSR-Platform), which includes one or more appliances that are configured to host or support the functionality of one or more QSOC components, which can be configured as one or more of software components, hardware components and firmware components associated with a QSOC. In some embodiments, a QSOC component is configured as one or more QSOC software packages. The QSR-Platform can support one or more of a QSOC components which can include KMS, UEM, IAM, PO and RM.

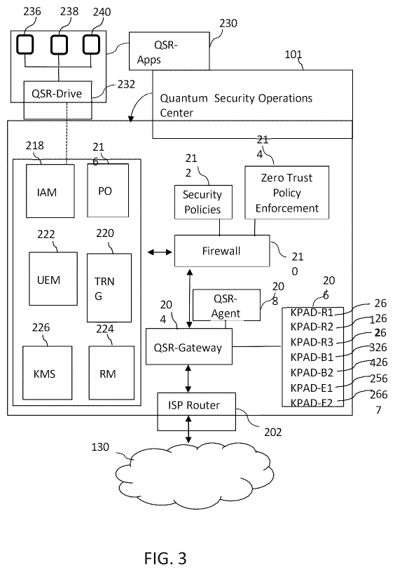

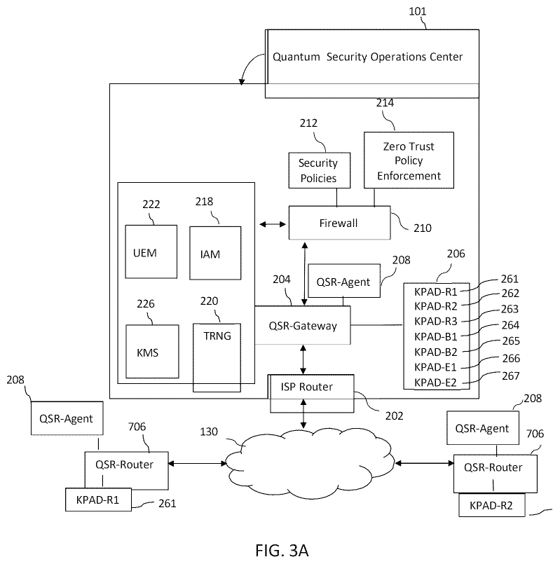

FIG. 3 is a block diagram of a QSOC 101, according to embodiments. A QSOC includes key management systems (KMS) 226 which are configured to mint and manage the plurality of KPADS 206. Also, within a QSOC 101 are one or more true random number generators (TRNG) 220 that are configured for generating quantum secure random numbers, configured to operate under the control of KMS 226. A QSOC 101 includes a plurality of KPADS 206, configured with a proprietary QSR-E key structure 261-267 and are minted and managed by the KMS 226. Additionally, within a QSOC 101 is a universal endpoint manager (UEM) 222 that is configured to manage systems deployed throughout the QSR-E, including appliances, user devices and accessories. In addition, an identity and access management service (IAM) 218 is configured to interface with a KMS 226 and a UEM 222 in order to provide authorization of a device and identity confirmation of a user prior to creation of a quantum secure/resistant private network. A QSOC 101 further includes one or more policy orchestrators (PO) 216 that are configured to manage and deliver zero trust policy services within a QSR-E and orchestrates user, group, and other security policies. Within a QSOC 101 there is a firewall 210 that has direct access to a store of security policies 212 and a store of zero-trust policy enforcement information 214. In addition, a QSOC includes a QSR-Gateway 204 with a QSR-Agent 208 and a plurality of KPADs 206. The KPADs 206 associated with the QSR-Gateway 204 can be paired with the KPADs 206 associated with other QSR-Appliances and user devices, which have the necessary credentials, that may request the creation of a QSR-E or a QSR-PN between a first device and a second device. Furthermore, a risk manager (RM) 224 is provided within a QSOC 101. The RM 224 is an application hosted within a QSOC that is responsible for assessing and managing risk within the QSR-E. A QSOC 101 further includes a router, for example an ISP Router 202, which provides connectivity between the QSR-Gateway 204 and the communication network 130.

In some embodiments, a QSR-Router, which is a QSR-Appliance, can be deployed within a remote environment that acts similar as an ISP router, except that it performs the function of securing the network communication channel (e.g. secure communication tunnel) via KPADs that have been provisioned upon the device to perform KPAD stream cipher encrypted communications with the QSR-Gateway 204 deployed within the corresponding QSOC.

According to some embodiments, the QSR-Router does not replace the ISP router. The QSR-Router augments the connectivity such that end user devices are attached to the QSR-Router which is then attached to the ISP Router. In some embodiments, the QSR-Router is embedded within the ISP Router, in which case there would not be two separate entities based on this type of integration.

According to embodiments, associated with the QSR-E and a QSOC is a user and endpoint device authorization (Auth) service which is configured to interface with a IAM 218 and to remotely manage the operational characteristics of devices, users and the like. According to embodiments, the Auth service is a library running on QSR-Devices through which both the QSR-Device and users are authenticated and authorized to access the QSR-E leveraging several types of MFA (multi-factor authentication) capabilities.

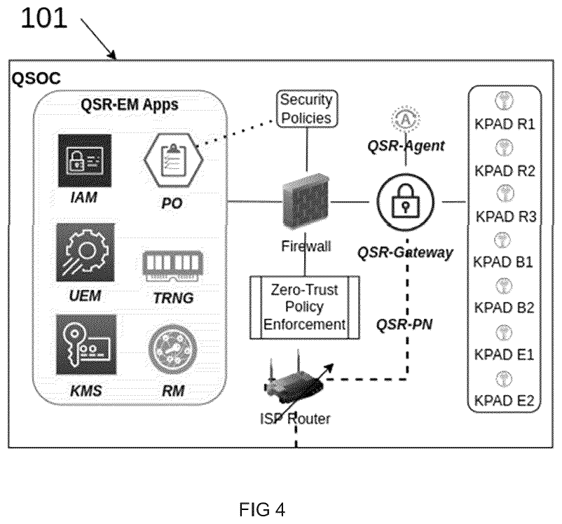

FIG. 4 is another block diagram of a QSOC, according to embodiments. According to embodiments as described in FIG. 29, an embodiment includes the synchronization of data configurations, settings and applications between multiple QSOCS, according to embodiments. The upper figure describes the synchronization over the internet, leveraging quantum-resistance QSR-PN tunnels. The lower figure describes the synchronization over private lines.

FIG. 29A is a block diagram that describes the synchronization of data configurations, settings and applications between multiple QSOCs, wherein synchronization is performed over the internet, leveraging quantum-resistance QSR-PN tunnels, according to embodiments. FIG. 29B is a block diagram that describes the synchronization of data configurations, settings and applications between multiple QSOCs, wherein synchronization is performed over private lines, according to embodiments. These figures illustrate a mechanism to enable synchronization of information between two QSOC's, whether they are located nearby, in the same country or even when located across great distances. FIG. 29A is using the QSR-PN to encrypt traffic traversing the public internet. FIG. 29B is using a private communications channel is obtained for the sole purpose of providing communication between the two QSOCs. These are examples of how the QSR-PN can be configured to enable the QSR-EMSE management applications to send and receive data for the purposes of synchronizing the operations and to provide a measure of resilience, should one of the QSOCs fail. These same methods can be used to connect more than 2 QSOCs to enable greater synchronization of data and thus a greater level of resilience to failure.

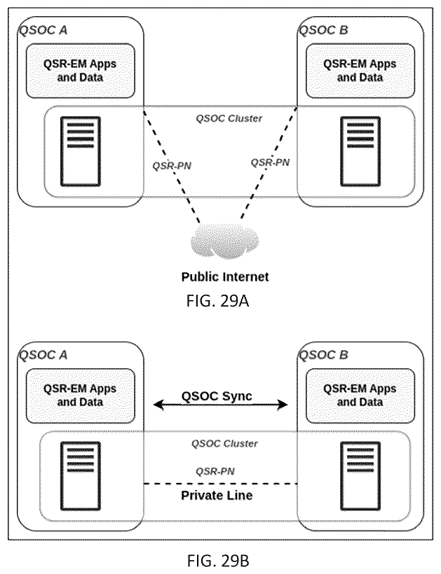

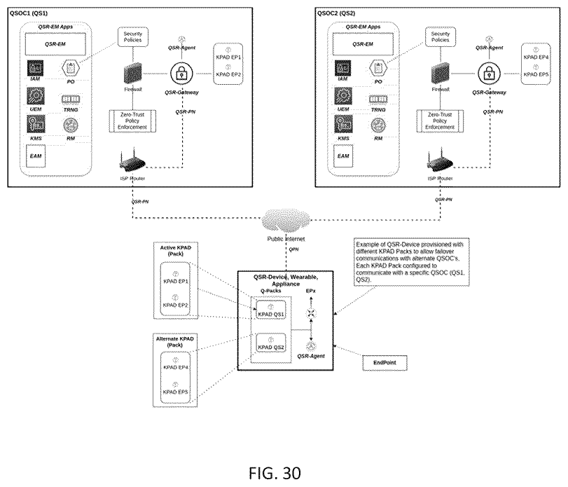

FIG. 30 is a block diagram illustrating support fail-over communications provided by an alternate or redundant QSOC associated with a single QSR-device, according to embodiments.

FIG. 30 shows how a Q-Device could be configured to be able to communicate with multiple QSOC's, in case of failure. A Q-Device could be configured to contain multiple sets of KPADs, one set being used to communicate over an active channel to a QSOC, where the others are available should that channel fail. On failure, another QSR-PN is established to a different QSOC, using the KPAD set that has been specifically built for that channel. While FIG. 30 only illustrates two communications paths available, this methodology can be applied to multiple channels providing many layers of redundancy should it be needed. The method of selecting the next channel to use, once a failure is detected, could be either pre-allocated at the time of provisioning the QSR-Device or based on a dynamic algorithm which could take environmental factors into consideration.

FIG. 30 shows KPAD EP1 and KPAD EP2 be used for the active channel to QSOC1 and EP4 & EP5 configured for the alternative channel to QSOC2, should the primary channel fail.

QSR-Devices, QSR-Wearables and QSR-Appliances can be provisioned or field upgraded with multiple KPAD packs, each establishing unique QSR-PN connections to individual QSOCs. The purpose of this capability is to ensure redundancies in the event that a single QSOC should become inaccessible. Only a single KPAD pack is used at a time. If a QSOC becomes inaccessible then the QSR-Agent will default to the next KPAD pack to resume communications between the QSR-Device, QSR-Wearable or QSR-Appliance and the QSR-E.

### QSR-PN, QSR-Platform and QSOC

FIG. 1 illustrates an embodiment of the system, depicting some of the relationships between components within the overall QSR-E. The main groupings are the QSOC, CNSP and QSR-PN. Starting with the QSR-PN, it resides partially within the QSOC as the QSR-Gateway can be physically located within the QSOC and also needs to provide access to CNSP components, for example the apps and services. The QSR-PN also resides outside of the physical location of the QSOC as most of its components are located at remote sites and provides the private network connections back the QSOC apps/services and to other remote sites connected to the QSR-PN.

The QSOC also contains the CNSP and various other components needed for the QSR-E, such as Routers, Firewalls, Disaster Recovery (DR) services and links to external service providers such as MDR.

The CNSP is a grouping of hardware and software, residing in the physical confines of a QSOC and taking advantage of the other QSOC components to deliver its services to users connected via the QSR-PN and to the operators of the QSOC. The CNSP comprises hardware that can be in the form of Hyper Converged Infrastructure (HCI) or separate components, delivering the compute, network, storage, high availability, hosting and software defined networking (SDN).

The CNSP also comprises network management functionality for the QSR-PN and internals, the QSR-EM, IAM, PO, EAM, UEM, etc., along with the ability to host applications and services. The CNSP components provide further security layers around the QSR-PN, for the hosted applications and services in addition to the security provided by the QSR-PN. The CNSP also provides information to the QSOC operator, QSOC services such as MDR to further enhance security of the eco system. The CNSP uses TRNG services located within the QSOC to construct the basic information required for the KAPD's used by the QSR-PN.

### QSR-Ecosystem

According to embodiments, there is provided a system that provides and enables the creation of a quantum secure/resistant ecosystem (QSR-E) where two or more users, for example a remote worker, remote office, operational headquarters, industrial control system, or other user configuration, are able to communicate and transfer information therebetween in a secure manner. The system includes one or more quantum secure/resistant operations centers (QSOCs), which are configured to use a multi-tier security mechanism or protocol enabling the creation of a QSR-E. Initially a secure communication tunnel (QSR-PN) is created between a first user and second user. In some embodiments, the communication tunnel (QSR-PN) is created by a QSOC upon verification and authorization of the devices being used for communication. Upon creation of this communication tunnel a second identification and authorization step is performed in order to ensure that the specific individuals requesting the creation of a QSR-E for communication are in fact authorized. In addition, according to some embodiments, a QSOC provides a one-time pad key structure, herein defined as a KPAD, which can include random entropy data (for example, raw key material) and metadata information that provides information about the KPAD, to be used as a security key by each of the two communicating users. As is evident from the configuration of the KPAD, upon use of a first security key from the KPAD, it becomes obsolete, and a second security key from the KPAD is to be used for a subsequent communication transmission.

According to some embodiments, a quantum secure/resistant operations centers (QSOC) includes an agnostic or conversion layer through which communications with a QSOC is performed. The agnostic layer or transformation layer is configured to transform operational signals associated with a first operating system into operational signals that are compatible with the operational characteristics of a QSOC. In this manner, a QSOC is provided with the ability to create a quantum secure/resistant ecosystem (QSR-E) for a variety of operating systems associated with user devices. As such, a user having a first device having a first operating system is provided with the means for creation of a QSR-E with a second device having a second operating system associated therewith, while neither the first operating system nor the second operating system are required to be directly compatible with the operating system associated with a QSOC, in embodiments where a QSOC is present for the creation of the QSR-PN.

According to some embodiments, the agnostic layer can be termed a QS interface (IPL) which can include one or more quantum secure/resistant interoperability protocol (QIP) modules which together can unify the services within a QSR-E, independent from their proprietary source.

FIG. 1A illustrates a generalized configuration of a quantum secure/resistant ecosystem (QSR-E) which is created by a quantum security operations center (QSOC) according to embodiments. A QSR-E 100 can be created by a QSOC 101 which thereby enables two or more users, for example a remote worker 110, a remote office 108, headquarters 106, industrial control systems 112 or other users to communicate in a quantum secure/resistant manner. For the creation or generation of a QSR-E 100, the respective user communicates with a QSOC 101 over a communication network 130, for example a public network, a private network, internet or other network configuration which can be wireless, wired or a combination thereof, that enables communication between a QSOC and the respective user. Communication between the user and a QSOC can be provided through a gateway 204 associated with a QSOC, which can enable bi-direction communication 136, 138 therebetween. It should be noted that while the bi-direction communication between the gateway 204 and different users are referenced using the same numbers, this is merely for simplicity of illustration, and as would be readily understood the bi-directional communication of one user will inherently be different from the bi-directional communication of a second user. The gateway 204 can further provide communication with a plurality of users and is not limited to solely the particular users requesting the creation of a first QSR-E. It should be understood that a particular QSOC can create multiple QSR-Es simultaneously, and thus is not limited in this manner.

FIG. 1B is a block diagram of an QSR-E which is created by a QSOC, according to embodiments. FIG. 1C is a block diagram of a QSR-E which is created by a QSOC, according to embodiments, wherein the system includes the ability for the QSR-PN to establish a direct secure communication between a remote office worker and the headquarters of the enterprise.

FIG. 3 is a configuration of a quantum secure/resistant ecosystem (QSR-E), which is created by a quantum security operations center (QSOC), according to embodiments, wherein the QSR-PN monitoring and management resides within a QSOC. With reference to FIG. 1B, a QSR-E 100 includes a QSOC 101 and QSR-Apps 104 which can provide applications in order to provide functionality to particular tasks within QSR-E 100. As illustrated, a variety of users for example a remote worker 110, a remote office 108, a headquarters 106 and an industrial control system 112 can be interconnected within the QSR-E 100 through a collection of quantum private networks QSR-PNs. These QSR-PNs are created by interaction of each of the remote worker 110, a remote office 108 a headquarters 106 and an industrial control system 112 with a QSOC 101 via a communication network. The QSR-PNs are resultant of a two or more-step authorization and identification process which enables the creation of the QSR-PN by for example the creation of a secure communication tunnel. Each of these components will be discussed in further detail elsewhere herein.

According to some embodiments, a QSR-E includes one or more QSOCs and one or more quantum secure/resistant routers (QSR-Router), which is configured to provide policy-based network access to the QSR-E for QSR-E provisioned and managed devices in a multiplicity of security tiers. The QSR-E further includes one or more quantum secure/resistant user and endpoint devices. Each of these quantum secure/resistant user end-point devices as well as a QSOC have associated therewith a plurality of KPADs which are configured with a QSR-E key structure. The KPADs are minted and managed by a key management system (KMS) within the QSR-E.

In some embodiments, the QSR-E further includes one or more interoperability protocol (QIP) modules which are configured to provide an interoperability protocol layer (IPL) on top of a QSR-E, QSR-Platform to enable the functional connectivity of one or more of third-party software and third-party services with the QSR-E.

According to embodiments, a QSR-E (quantum secure/resistant ecosystem) is created by one or more QSOCs (quantum security operations centers) that deliver services to the users through their devices and accessories. A QSOC includes a collection of appliances, which can be one or more of hardware, software, firmware components, that serve numerous functions in order to manage the security of users, groups, roles and devices protected within a QSR-E.

According to embodiments, a QSR-E is configured to be scalable and provide the ability to interoperate with existing enterprise customers identity access management (IAM)/directory service solutions leveraging federated identity management, such as authentication and authorization services which may include Microsoft AAD™, OKTA™, PING™, or other access management and identity providers.

According to embodiments, a quantum secure/resistant ecosystem is modular in design, wherein there are multiple configurations of QSOC's which can be used to create and/or manage a QSR-E. In one embodiment, there is only one central QSOC within a QSR-E. In one embodiment, there can be separate QSR-Es, each configured with one or more QSOCs, such that each QSR-E is its own individual quantum secure/resistant and quantum-resistant ecosystem. In one embodiment, there can be separate QSR-Es, in which one QSR-E can initiate a quantum secure/resistant communication channel with another QSR-E. For example, if one government's QSR-E would like to communicate with another government's QSR-E, or if one multinational organization would like to communicate with another multinational organization on a restricted basis. In one embodiment, the organization of multiple QSOCs within a QSR-E can be configured in a hierarchical manner such that one QSOC is central or the master (primary) QSOC and the other QSOCs are subordinate or worker QSOCs, wherein the central (master) QSOC plays an interconnect role between the subordinate (worker) QSOCs.

In one embodiment, subordinate-QSOCs (sub-QSOCs) use the same appliances as QSOCs but are operated by third parties, and can connect through the central (master) QSOC to securely communicate with other subordinate (worker) QSOCs, and allow their users to communicate throughout this QSR-E. In one embodiment, a QSR-E with a hierarchy of QSOCs with a central (master) QSOC, the central QSOC will be the only QSOC that can mint and distribute KPADS, in order to maintain control over the security of the QSR-E.

In some embodiments, a QSR-E enables the quantum secure quantum resistant delivery of third-party services which may be included within a QSR-Apps category.

In some embodiments, the configuration of a QSR-E is agnostic to the interoperability of third-party services. For example, in contrast to a Microsoft™ or an Apple™ ecosystem, which primarily exclusively supports their own services, a QSR-E and in particular a QSOC can include an interoperability layer or transformation layer that renders the QSR-E to be agnostic to third-party providers such that the QSR-E can readily include or provide features or applications that may be applicable to Microsoft,™ Apple,™ and or other such third-party service provider in a manner that these features or applications can interact with one another application or feature that is distinct therefrom, while being compatible with other user interfaces through the QSR-E. In some embodiments, the QSR-E through a QSOC provides a quantum secure/resistant interface (for example an interoperability protocol layer (IPL) comprising one or more interoperability protocols (IP)) that can unify services within a QSR-E, regardless of their proprietary source. For example, in addition to the common security layer, namely the communication between users having a desired level of security, one user who may use Facetime™ to communicate with another user who is using Zoom™ in order to conduct their videoconference in a manner that is quantum secure/resistant.

According to embodiments, in order to generate a quantum secure/resistant virtual private network, two or more identification and authorization steps are used. A first identification and authorization step is to authenticate a particular device and subsequently authorize the specific person using that particular device. Upon authentication of the particular device a secure communication tunnel can be created. Upon authorization (which may be a multifactor authorization) of the specific person using the particular device can result in the particular user being permitted to use the secure communication tunnel which results in the enablement of a communication pathway that can be envisioned as a virtual private network. For the setup of the secure communication tunnel, the device authentication, which may include the use of a device fingerprint can be used for this authorization process.

According to embodiments, there is provided an identity and access management (IAM) module or component associated with the QSR-E. The IAM module can aid with reducing the attack surface associated with the communication link (since upon authorization the communication link is configured as a secure communication tunnel) and can be used to protect users, devices, data and the use of applications as enforced by managed security policies, which is further described below in associated with these particular contexts.

According to embodiments, for devices, each user device and network appliance is uniquely identified by QSR-E and is granted or refused access based on its privileges and state. For users, each user, including internal QSR-E personnel, is uniquely identified by QSR-E and is granted or refused access based on privileges and status. For data, users, including organizations, classify data and determine through selected security policies how this data is to be stored, shared and under what conditions this data can or must be retained or deleted. For QSR-Apps, whether an application is implemented as self-hosted or software-as-a-service (SaaS), applications are used to create and manage data and represent the most exposed and exploited components of the attack surface.

According to embodiments, a QSR-E can provide tools necessary for software developers to tightly integrate their applications into QSR-E, and when in compliance with QSR-E standards these applications can be classified as QSR-Apps which can be envisioned as an application that has a specific level of security associated therewith. Further discussions relating to this feature is provided elsewhere herein.

### Quantum Key Management System

According to embodiments, the key management system (KMS) 226 is configured to mint and manage the plurality of KPADS. The KMS 226 is the QSR-E product where KPAD keys are minted, persisted, managed, and audited. The KMS 226 is also responsible for centrally managing other types of keys including symmetric keys (AES transport keys, data encryption standard (DES) keys and the like), certificates, and digital signatures utilized for zero-trust security and encryption of components and services within QSR-E.

According to some embodiments, a KMS can be sourced from Nutanix (use a component of Nutanix). A KMS can also be sourced from Hashicorp, Microsoft or Entrust or other suitable key management system known to worker skilled in the art.

### Quantum Random Number Generator

According to embodiments, one or more true random number generators (TRNG) 220 are configured for generating true random numbers, configured to operate under the control of KMS.

The TRNG 220 is an application which relies on the intrinsic randomness of quantum mechanics to produce random numbers, for example true random numbers. These random numbers are referred to as entropy within the system and are utilized by the KMS to mint new KPADs utilized within the QSR-E. According to embodiments, entropy can also be sourced from a 3^{rd} party provider, customer, and leverage a different system which generates true random numbers.

According to embodiments, a TRNG can be sourced from GoQuantum. A TRNG can also be sourced from Synopsys, ID Quantique, or Quintel or other suitable random number generator known to worker skilled in the art.

### KPADs

According to embodiments, a QSOC 101 includes a plurality of KPADs 206, configured with a proprietary QSR-E key structure and are minted and managed by the KMS 226.

According to embodiments, a KPAD is a proprietary one-time pad key structure that is made up of random entropy data (raw key material) and metadata information that provides information about the KPAD, including an ID, Name, description, audit information, etc. The encryption methodologies enforced for the use of KPADs adhere to the rules necessary to guarantee information-theoretic security.

In some embodiments a KPAD can be configured to include a plurality of encryption keys, wherein each of these encryption keys are configured for single use during a communication transmission. For example, a KPAD can include encryption keys KPAD R1, KPAD R2 and the like, wherein each of the different notated KPADs represent a different encryption key.

According to embodiments, there are several products within the QSR-E that utilize KPAD's including QSR-Appliances (e.g., QSR-Gateway 204, QSR-Router), QSR-Devices (QSR-Books, QSR-Tablets, QSR-Phones), and bring your own devices (BYOD) that can be considered Tier 3 to 5 BYODs as will be further described in more detail elsewhere herein. Different QSR-E services and libraries will utilize the KPAD library to interact with the KPAD securely stored on a device. KPADs are also deployed on QSR-Adaptors to support the ability for a user to remotely connect a BYOD device to a QSOC with a QSR-PN encrypted network tunnel.

According to embodiments, KPAD management is central to all QSR-E solutions and KPAD key material is to be properly protected by for example leveraging Zero Trust, Defense-In-Depth, and other policies.

According to embodiments, KPADs are centrally managed including key entropy generation, secure key storage, KPAD minting (creation) and key encrypted key/data encryption key secured.

According to embodiments, key entropy generation can define the ability to generate raw entropy key material leveraging true random number generator (TRNG) devices. As entropy is created, it is recorded within the KMS system and made available to mint new KPADs.

According to embodiments, secure key storage can define the feature wherein all KPADs are securely stored in a key management system (KMS).

According to embodiments, KPAD minting can define wherein a KPAD is provisioned by minting new KPAD key from one or more entropy files. The “minted” KPADs are stored, along with associated metadata within the KMS.

According to embodiments, key encrypted key/data encryption key (KEK/DEK) security can define how KPAD key material is encrypted when at rest, and decrypted JIT (just-in-time) when used by QSR-Apps and services such as QSR-PNs.

### Universal Endpoint Manager

According to embodiments, a universal endpoint manager (UEM) 222 is configured to manage all systems deployed throughout QSR-E, including appliances, user devices and accessories.

According to embodiments, the UEM 222 is a management application product/module within a QSOC enterprise manager. The UEM is responsible for the management of all systems deployed within the QSR-E, including and not limited to QSR-Gateway 204, QSR-Routers, QSR-Books. Through the management interface, a QSOC administrator has the ability to remotely manage and monitor QSR-Es, applications, services, and the like. The UEM 222 communicates to QSR-Devices over QSR-PNs and has the ability to communicate with the QSR-Agent 208 running on the device. This communication connectivity can provide the ability to perform a variety of operations. The operations can include: 1) remotely read information from the device, including: system information (device fingerprint, memory/CPU utilization, serial no, mac address, etc.), KPAD information and utilization, device BOM (bill of materials) including all loaded applications, services and libraries including versions; 2) read and access device event logs and information; 3) remotely push policy updates from the PO policy server in near real-time to the device; 4) remotely quarantine or wipe a device if determined it is compromised based upon AI intrusion detection algorithms, or if the device is reported lost or stolen, or if the user's access permissions to the device has been revoked; and 5) remotely enable/disable device features. e.g. remotely enable USB filesystem access in order to import a KPAD from a QSR-PN provisioned encrypted USB drive.

According to embodiments, a UEM application can be sourced from ESET. A UEM application can also be sourced from Crowdstrike, Trend, or Sophos or other suitable UEM application known to worker skilled in the art.

### Identity and Access Management Service

According to embodiments, identity and access management service (IAM) 218 is configured to interface with a KMS 226 and a UEM 222 in order to provide authorization of a device and identity confirmation of a user prior to creation of a quantum private network.

According to embodiments, in order to generate a quantum secure/resistant virtual private network, two or more identification and authorization steps are used. A first identification and authorization step is to authenticate a particular device (which may be multi-factor authentication) and subsequently authorize (which may be multi-factor authorization) the specific person using that particular device. Upon authentication of the particular device a secure communication tunnel can be created. Upon authorization of the specific person using the particular device can result in the particular user being permitted to use the secure communication tunnel which results in the enablement of a communication pathway that can be envisioned as a virtual private network. For the setup of the secure communication tunnel, the device authentication, which may include the use of a device fingerprint can be used for this authorization process.

According to embodiments, there is provided an identity and access management (IAM) module or component associated with the QSR-E. The IAM module can aid with reducing the attack surface associated with the communication link (since upon authorization the communication link is configured as a secure communication tunnel) and can be used to protect users, devices, data and the use of applications as enforced by managed security policies, which is further described below in associated with these particular contexts.

According to embodiments, for devices, each user device and network appliance is uniquely identified by QSR-E and is granted or refused access based on its privileges and state. For users, each user, including internal QSR-E personnel, is uniquely identified by QSR-E and is granted or refused access based on privileges and status. For data, users, including organizations, classify data and determine through selected security policies how this data is to be stored, shared and under what conditions this data can or must be retained or deleted. For applications, whether an application is implemented as self-hosted or software-as-a-service (SaaS), applications are used to create and manage data and represent the most exposed and exploited components of the attack surface.

According to embodiments, a QSR-E can provide tools necessary for software developers to tightly integrate their applications into QSR-E, and when in compliance with QSR-E standards these applications can be classified as QSR-Apps, which can be envisioned as an application that has a specific level of security associated therewith. Further discussions relating to this feature is provided elsewhere herein.

According to embodiments, IAM 218 includes the authentication and authorization of users and devices (leveraging device fingerprints) based upon RBAC (role-based access control), ABAC (attribute-based access control) and directory services. IAM 218 can include both services/application program interfaces (APIs) and a web-based user interface that provides the ability to manage users, groups, roles, permissions, and the like defined within the QSR-E.

According to embodiments IAM can be sourced from OpenLDAP. IAM can also be sourced from Keycloak, FreeIPA, ManageEngine, IBM, Okta, or Ping Identity or other suitable identity or access manager solutions known to worker skilled in the art.

### Policy Orchestrator

According to embodiments, policy orchestrator (PO) 216 is configured to manage and deliver zero trust policy services within a QSR-E and orchestrates user, group, device, application, and other security policies.

According to embodiments, PO 216 is a QSR-PN application responsible for managing zero-trust policy rules within the QSR-E. The PO can include both an API (application programming interface) and user interface (UI) that allow a QSOC administrator to create policy sets including one or more conditional rules related to different resources within the QSR-E. The PO can control the one or more conditional rules associated with QSR-Devices, QSR-Apps, QSR-PN network services, and other QSR-PN services.

According to embodiments, the PO includes a policy definition point (PDP) and one or more policy enforcement points (PEP). The PDP is responsible for storing and managing a list of policies that are used by PEP's running dynamic policy enforcement engines throughout the QSR-E. Policies are managed within the PO management application. Policies may be imported/exported through a standardized format with one or more enterprises to support the ability to perform federated zero-trust policy management.

According to embodiments, a PO can be sourced from Open Policy Agent. It can also be sourced from McAfee, Splunk, SOAR or Symantec or other suitable PO known to worker skilled in the art.

According to embodiments, when a QSR-Device boots up and performs an associated device authentication, and optional end-user authentication for end-user access, immediately upon establishing network connectivity, the QSR-Agent 208 running upon that device will read the latest device and optional user policy from the PO. The QSR-Agent 208 will then run the PO policy enforcement engine to check and update device-specific policies. The policy on the device can be automatically updated upon a change in policy for the device, user, and all resources (applications, services, and configuration policies) applicable to the device and user.

According to embodiments, throughout the QSR-E there are a variety of policy enforcement points (PEP) which read their associated set of policy rules from the PO, and run the PO policy enforcement engine to determine whether a specific user/device or application service should have the ability (for example authority) to perform an operation.

According to embodiments, if authority is granted, then the user/device performs the associated operation, or alternatively if denied, then the operation will not be performed, and an event or notification will be generated and sent to the security information and event management (SIEM)/security orchestration, automation and response (SOAR) subsystem to take the appropriate corrective action as would be defined by operation within the PO policies or parameters.

According to embodiments, on QSR-Devices, the QSR-Agent 208 is responsible for many policy enforcement operations, including dynamic network creation within the QSR-PN, device system and application monitoring, and providing least-privilege principal access to device system, operating system, application, and service operations. When a QSR-Device/end-user initially authenticates to the QSR-PN, the QSR-Agent 208 reads the device/user policies from the PO and runs the policy enforcement engine to grant or deny (and optionally quarantine or wipe the device) access to the specified resource and associated operation.

According to embodiments, both the QSR-Router and QSR-Gateway 204 read the PO policy rules to dynamically implement NGFW (next-generation firewall) ingress/egress rules and network routing capabilities.

According to embodiments NGFW (IDP/IPS) can be sourced from Fortinet. NGFW can also be sourced from PaloAlto, Cisco, or Cloudflare or other suitable NGFW known to worker skilled in the art.

According to embodiments, when a QSOC administrator modifies the policy rule(s) for a specific device, application, service, or user, the PO service pushes out policy update notifications to appropriate resources through the QSR-Agent 208, which immediately applies the policy changes to ensure compliance.

### User and Endpoint Device Authorization

According to embodiments, user and endpoint device authorization (Auth) 501 services, are configured to interface with an IAM and to remotely manage the operational characteristics of devices, users and the like.

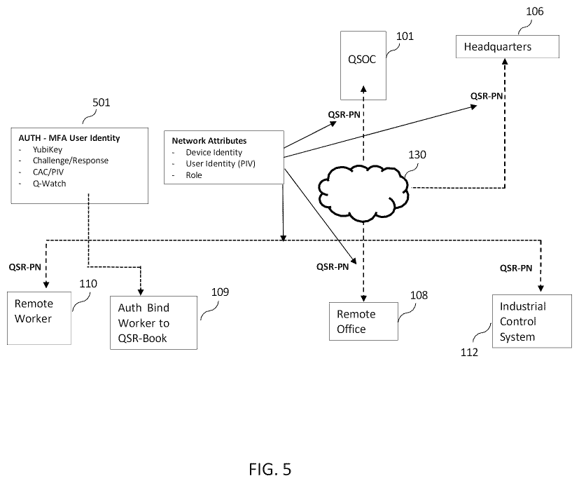

FIG. 5 is a block diagram of a quantum secure/resistant ecosystem (QSR-E) which is created by a quantum security operations center (QSOC), according to embodiments. As illustrated in FIG. 5 Auth 501 services to remotely manage the operational characteristics of devices, users and the like. For example, remote management of devices associated with quantum private networks (QSR-PN), wherein each of the QSR-PNs have a collection of network attributes that can be based on device identity, user identity and role associated with that particular device. Each of the QSR-PNs can be associated with a remote worker 110, a remote office 108, an industrial control system 112 and a headquarters 106 and these QSR-PNs, which can form one or more QSR-Es, can be created and managed by an associated QSOC 101.

According to embodiments, the Auth service is a library running on QSR-Devices through which both the QSR-Device and user are authenticated and authorized to access the QSR-E leveraging several types of MFA (multi-factor authentication) capabilities.

According to embodiments, Auth includes various levels of authorization where a given user is authenticated through their QSR-Devices to the QSR-E, validating that users are who they claim to be by ensuring that users are provisioned with credentials that can be validated against the centralized IAM directory service, or optionally leveraging federated identity to authenticate to an enterprise managed directory service. Upon successful authentication of the user, authorization to a QSR-Device is validated and enforced through security policies which are defined and managed within the PO.

According to embodiments, Auth also includes the authentication and authorization of a QSR-Device by verifying the device fingerprint with the centralized UEM system. Once the QSR-Device can be authenticated, specific authorizations can be validated against security policies ensuring that the QSR-Device only has access to predefined data, applications, servers and services within the QSR-E, and specific applications, services, and policies provisioned and accessible to the user through the QSR-Device user interface.

According to embodiments, QSR-Devices are connected to QSR-Accessories (for example a Bluetooth earpiece, Bluetooth speaker, wireless printer or other accessory format) with KPAD encrypted connections. These connections can be wired or wireless connections, for example Bluetooth low energy (BLE), near-field communication (NFC), 5G, WiFi or other wireless protocol). The KPADs are shared exclusively between QSR-Devices and QSR-Accessories).

According to embodiments, KPAD MFA can be embedded into a Q-Accessory (for example wearable technology such as a watch or earpiece) required as a component of the IAM process for QSR-Devices to access the QSR-E or to access specific resources within the QSR-E such as QSR-Spaces and QSR-Apps. KPAD MFA can be shared exclusively between a KPAD MFA enabled Q-Accessory and the KPAD KMS.

According to embodiments, a QSR-Wearable is a QSR-E connected device worn by a user primarily to offer MFA (multi-factor authentication) of a user to a device, but secondarily the user can also interact with a QSR-Wearable to receive information or to control the device or to communicate through the device, or it can be used offline to interact with QSR-Points.

According to embodiments, Auth can be configured to conduct multi-factor authentication (MFA). For example, an element can be operational on QSR-Wearable, operational on end-user device, and an element running within QSOC within the IAM system, thereby enabling the support of biometric authentication on QSR-Wearable such as a fingerprint.

According to embodiments, KPAD MFA and QSR-Accessories can be used outside the QSR-E for specific purposes. For example, they can be used in offline physical access solutions such as garage door openers, wherein in this type of instance the KPADs are shared exclusively between QSR-Points and QSR-Accessories or QSR-Devices).

According to embodiments, the QSR-E supports the ability to provide role-based-access-controlled (RBAC) and policy-controlled delegated management of enterprise resources and services, including enterprise owned QSR-Appliances, QSR-Devices, or specific applications, services or features.

In one embodiment, Auth requires that the wearable Q-Accessory have user biometric authentication capabilities built-in with match-on-device capabilities.

### Firewall

According to embodiments, a QSOC includes a firewall 210 that has direct access to a store of security policies 212 and a store of zero-trust policy enforcement information 214.

According to some embodiments, a firewall suitable for use with one or more QSOCs can be an off-the-shelf firewall that has been examined and confirmed to be “risk free” according to the standards that are set for the respective use of that firewall by the one or more QSOCs for creation of a QSR-E. For example, these standards can include examination of the firewall to ensure that there are no “back doors” or spyware thereon that could impact the security provided by the firewall.

### Quantum Secure/Resistant Gateway

According to some embodiments, each of the one or more QSOCs includes a quantum secure/resistant gateway (QSR-Gateway) 204, with a QSR-Agent 208 and a plurality of KPADs 206. The KPADs associated with the QSR-Gateway can be paired with the KPADs associated with user devices, which have the necessary credentials, that may request the creation of a QSR-E or a QSR-PN between a first device and a second device.

According to some embodiments, the QSR-Gateway 204 is a QSR-PN appliance that runs as a server-side component within a QSOC and supports the ability for multiple QSR-Devices to communicate with it. The QSR-Gateway can set up network communication between QSR-Devices and services within one or more QSOCs. Additionally, a QSR-Gateway is responsible for setting up communication tunnels (e.g. QSR-PN) between multiple QSOCs for inter-QSOC communications.

According to some embodiments, the QSR-Gateway 204 is a QSR-Appliance that connects disparate networks by translating communications from one QSR-Device or QSR-Appliance to another based upon policy enforcement rules. The QSR-Gateway 204 is configured as a single-board computer with a hardened operating system and operates in a “headless” fashion.

According to some embodiments, The QSR-Gateway 204 is configured within the QSR-E and communicates with other QSR-Devices and QSR-Appliances as a quantum secure/resistant network appliance.

### Quantum Secure/Resistant Endpoint Management Service

According to some embodiments, quantum secure/resistant endpoint management services (QSR-Agent) 208 can be installed on all QSR-E provisioned devices and configured to interface and be managed by a UEM;

According to some embodiments, the QSR-Agent 208 is a software application deployed on quantum secure/resistant managed QSR-Devices which run using a privileged user account, and provides the ability to remotely manage and monitor the devices. In an embodiment, a QSR-Agent (e.g. a software application) can be deployed on BYODs which can enable these BYODs to be manageable, however likely less secure that quantum secure/resistant managed devices. Quantum secure/resistant managed devices can include: 1) QSR-Appliances, such as QSR-Gateway and QSR-Routers; 2) QSR-Devices such as QSR-Books, QSR-Tablets and QSR-Phones; 3) QSR-Embedded devices that have been custom integrated into the QSR-E to enable devices to communicate securely over QSR-PN connections.

According to some embodiments, the QSR-Agent 208 enables QSR-PN hardware to be remotely managed, monitored, and controlled. The QSR-Agent 208 is a zero-trust application that manages QSR-PN hardware for identification, inventory control, authentication, authorization, user interface (UI) configuration including policy enforcement, and KPAD management where key materials can be securely managed and revoked remotely from UEM management control center.

According to some embodiments, the QSR-Agent 208 supports the QSR-PN solution on QSR-Devices by performing remote device and user authentication and authorization against the QSR-E IAM, UEM, and/or PO API's running within the QSR-E. This process can be performed in a number of ways as discussed is further detail elsewhere herein.

According to some embodiments, the QSR-Agent is a separate process from the encryption engine, API config KPAD and cipher algorithm. Communications to and from the QSR-Agent ride over the QSR-PN. The purpose of the QSR-Agent is to act as a local process that can enact changes, monitor the local device, enable/disable hardware components such as USBs for adding new KPADs and perform other actions, through an API supplied by the QSR-Agent process. The QSR-Agent provides an API to enable a QSOC operator or automated process to interact with the remote QSR-Device. The QSR-Agent is used to supply the secondary authentication to the QSOC security processes using a device fingerprint or similar mechanism, which is unique to that QSR-Device. According to some embodiments, the QSR-Agent is an expandable and adaptable process that is configured to take on roles, functions and features as the device and deployment situation warrants.

### Risk Manager

According to some embodiments, the Risk Manager (RM) 224 is an application hosted within one or more QSOCs that is responsible for assessing and managing risk within QSR-E. This product will provide insurance providers with a secure web portal and API(s) that enable them to get information about the devices, services, and applications within the QSR-E that can be used to perform cyber risk assessment.

According to some embodiments, the RM 224 comprises a risk analyzer, one or more engines, databases, user interfaces, an actuarial calculation module, a risk profile module, an API interface and/or internet portal application that will allow an insurance company to access their information.

### KPAD Distribution Processes

According to embodiments, several processes, applications, and services within the QSR-E can be utilized to support the ability to distribute newly minted KPAD's to QSR-Devices (both during the initial QSR-Device provisioning process), as well as adding KPAD key material to QSR-Devices in the field, namely in situ.

According to embodiments, within the QSR-E the KPADs can be distributed to the related devices within the QSR-E, and optionally the KPADs may be further encrypted, for example by transfer KPADs in order to ensure that there is a further level of security for this transfer of security keys.

### QSR-Router

According to some embodiments, the QSR-Router is a QSR-Appliance that is usually deployed within a remote environment that acts similar as an ISP router, except that it performs the function of securing the network communication channel (e.g. secure communication tunnel) via KPADs that have been provisioned upon the device to perform KPAD stream cipher encrypted communications with the QSR-Gateway 204 deployed within the corresponding QSOC. Every QSR-Router runs the QSR-Agent 208 application thereon to enable the ability to remotely manage and control the device. The QSR-Router is a QSR-Appliance used to setup a local area network, and connect one or more QSR-Devices or BYODs in a remote-worker environment. A QSR-Router is similar to a router that is provided by an Internet service provider (ISP) and provides both hard-wired and optionally WiFi network communications.

According to some embodiments, the QSR-Router does not replace the ISP router. The QSR-Router augments the connectivity such that end user devices are attached to the QSR-Router which is then attached to the ISP Router. In some embodiments, the QSR-Router is embedded within the ISP Router, in which case there would not be two separate entities based on this type of integration.

### Quantum Secure/Resistant User End-Point Devices

According to some embodiments, a quantum secure/resistant user end-point devices (QSR-UED), include a plurality of KPADS, configured with a proprietary QSR-E key structure and are minted and managed by one or more QSOCs. Examples of user end point devices can include personal computers, laptops, tablets, smart phones, or other computing device as would be readily understood. In order to be provided with the ability to operatively communicate within a QSR-E, a user device or end point device will have a QSR-Agent operating thereon which can provide a means for interaction with a QSOC for access and authorization for communication within a QSR-E.

According to some embodiments, the end-user devices such as QSR-Books have the QSR-Agent running and configured thereon, and use their preloaded KPADs to communicate with QSR-Gateway 204.

According to embodiments, an end-user device for use within a QSR-E includes one or more KPADs and an Auth configured to conduct multi-factor authentication (MFA) with the IAM within a QSOC.

### Quantum Secure/Resistant Adaptor

According to some embodiments, the quantum secure/resistant adaptor (QSR-Adaptor) is a hardware attached removable media product such as a USB drive or other removable entity having stored thereon code for provision of its functionality. The QSR-Adaptor enables the ability for a user to use a removable disk to securely connect to the QSR-E utilizing a KPAD stored on the device, and QSR-PN networking software deployed on the device. QSR-Adaptors can be used to support BYOD solutions where users can plug in a QSR-Adaptor and then enable the user to remotely connect the device using a KPAD QSR-PN encrypted network tunnel to the one or more QSOCs.

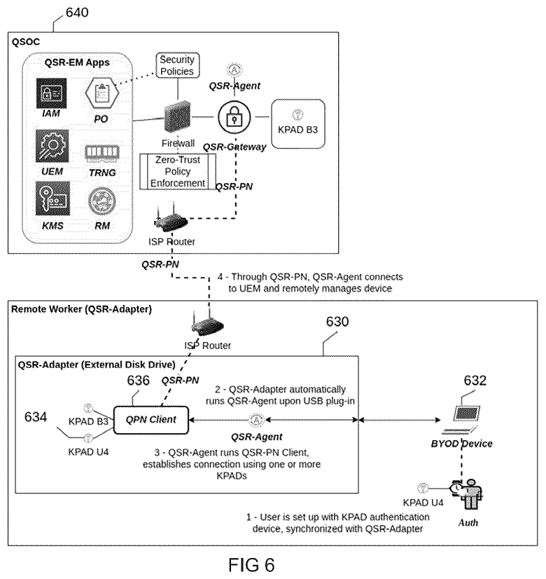

FIG. 6 is a block diagram of a QSR-Adaptor that can be operative connection with a quantum secure/resistant ecosystem (QSR-E), according to embodiments. According to some embodiments, with reference to FIG. 6 a quantum secure/resistant adapter QSR-Adaptor 630 attaches to existing bring your own device (BYOD) 632, such as a laptop with a USB port. The QSR-Adaptor is bound to the particular BYOD device, thereby providing a level of security that the QSR-Adaptor can only be used in association with that particular BYOD device. The QSR-Adaptor is an external disk drive including KPADs 634. The user of the BYOD is set up with KPAD authentication device, synchronized with QSR-Adaptor 630. The difference from the remote worker is that the system, for example a QSOC 640, is communicating with a BYOD device, not a QSR-Book, namely a device that is preconfigured for operation with a QSOC. The user is authenticated by the BYOD device, when the QSR-Adaptor 630 is plugged in. The QSR-E Client subsystem 636 is running on the QSR-Adaptor 630, rather than being installed as an application into a QSR-Book.

It will be readily understood that while a connection between the QSR-Adaptor and a computing device has been defined using an USB port as an example, other configurations of connection between a QSR-Adaptor and a computing device may include other wired or wireless connections between an “accessory” device and a computing device. Examples of other forms of connections may include a variety of different USB connector types including Type-A, Type-B and Type-C, or can be configured as an ethernet port or FireWire or other type of connection as would be readily understood by a worker skilled in the art.

According to some embodiments, there are plural components within a QSR-Adaptor. Primary components of a QSR-Adaptor include the QSR-PN client component (e.g., the virtual private network component that is running on a QSR-Book). The QSR-PN Client authenticates to the QSR-Gateway in a QSOC. The QSR-Agent is on the QSR-Adaptor. In order for the QSR-Adaptor to be “bound to the device,” the first time the QSR-Adaptor is plugged into a BYOD, it will install some QSR-Agent software on the BYOD. For example, the end-user will take the BYOD to an IT person within a QSR-E, and the IT person will plug in the QSR-Adaptor to bind it to the BYOD, and will configure it so that the QSR-Adaptor will only run on that BYOD. If someone looses an adapter, they won't be able to access the QSR-E. Furthermore if someone tries to plug a QSR-Adaptor into another computer, it will not work.

### Quantum Secure/Resistant Book

According to some embodiments, the quantum secure/resistant book (QSR-Book) is an end-user computer that is used by a remote worker to connect to a QSOC for creation of a QSR-E. A QSR-Book operates at tier-1 or 2 security levels where it is configured with all the necessary hardware and operating system hardening required to function as a zero-trust end-point device. All QSR-Books have a QSR-Agent 208 running upon them to enable remote management, monitoring, control, and risk assessment.

According to some embodiments, the QSR-Book is built upon a secure subsystem on both the local device and through the network connection, making it quantum secure/resistant utilizing KPAD shared symmetric keys. To provide a level of optimal security, data access is provisioned remotely, data is not stored locally and all internal memory is wiped upon shutdown leaving no residue on the QSR-Device, namely the QSR-Book.

### Quantum Secure/Resistant Input Accessories

According to some embodiments, the QSR-E incudes one or more quantum secure/resistant input (QSR-input) accessories that can be configured to be a KPAD secured Bluetooth low energy (BLE) or near-field communication (NFC) wireless accessory, such as, but not limited to Pods, keypads; mouse; trackball, controller and the like.

According to some embodiments, Pods represent one of a number of accessories, in this case KPAD secured BLE or NFC enabled earpieces, whereby the accessory is preloaded with a KPAD that is paired to a device to authenticate the two endpoints to each other and to encrypt all communications between them with quantum secure/resistant encryption.

### Quantum Secure/Resistant Embedded System

According to some embodiments, quantum secure/resistant Embedded (QSR-Embedded) systems are custom integrated solutions with other vendor's systems. As an example, QSR-PN can integrate with an ICS SCADA or IIOT (Ring camera) manufacturer to embed KPAD and QSR-PN network management to enable quantum secure/resistant security and management.

According to some embodiments, a QSR-Embedded system connects to in situ devices (such as existing SCADA devices) to effect a Tier 3 security upgraded connection to the QSR-E. QSR-Embedded systems represent third-party embedded systems, generally headless (e.g without a user interface), such as SCADA, ICS and Internet of things (IOT) devices, that are tightly integrated into the QSR-E to take advantage of common security foundations that offer a desired level of encryption and access controls as a benefit of standardizing on KPADs for these functions.

### Quantum Communication Codes and Protocols

According to some embodiments, the design of the QSR-E is such that it is scalable and is agnostic to the interoperability of third-party services. The QSR-E provides a QSR interface, an interoperability protocol layer (IPL) comprising one or more interoperability protocol (IP) modules, that can unify the optimal services within a QSR-E, regardless of their proprietary source. In one embodiment of the common security layer, for example, a user may use an Apple product operating Facetime™ to communicate with another user operating Zoom™ in order to conduct a videoconference in a manner that is quantum-secure.

According to some embodiments, the IP is configured to provide an interoperability layer (IPL) on top of the QSR-E, QSR-Platform to enable the functional connectivity of third-party software (services).

According to some embodiments, the QSR-E provides a common security layer to make all devices and QSR-Apps interoperable through QSOC systems and services. Above this security layer the QSR-E can provide a further interoperability function, namely that of helping competitive QSR-Apps to share, to agree to certain standard protocols, or to connect to a bridge, for protocols including those for communications, audio, video and messaging, so that users can interface through their preferred QSR-Apps and yet communicate with other users using competitive QSR-Apps.

According to some embodiments, QSR-E can be extended to a variety of QSR-Apps and may provide competitive ecosystems such as Google, Apple and Microsoft to interoperate for the benefit of its users without giving up the preference that their customers will have for one user experience over another. An objective of the QSR-E is to ensure that a truly QS, or at minimum a QSR-Platform underpins the security of all communications, transactions, privacy and data protection of users independent of their preferred QSR-Apps.

According to embodiments, a communication network that may be operative within a QSR-E can be configured as a wired network or a wireless network or a combination thereof. As would be readily understood by a worker skilled in the art a wired network can include cable networks or optical networks and wireless networks can include a variety of wireless networks operation different wireless protocols, including 3G, LTE, 5G, NewRadio, Bluetooth, WiFi or other wireless protocol or wireless network configuration as would be readily understood.

According to embodiments, endpoints that may be operative within a QSR-E can be configured in a variety of manners, for example personal computers, servers, laptops, tablets, smartphones or other devices that would have suitable communication and processing capabilities in order to function as described elsewhere herein in order to communication with a QSOC enabling the creation of a QSR-E.

According to embodiments, remote locations as used herein can include a wide variety of particular geographical locations, including earth bound locations or terrestrial locations. Furthermore, remote locations can be configured as single entity locations or remote networked facilities.

### Headquarters/Enterprise

One embodiment of an exemplary headquarters (enterprise) facility may be or may include any networked computer-based infrastructure. For example, the headquarters (enterprise) facility may be corporate, commercial, organizational, educational, governmental, manufacturing, utility providers, or the like. As home networks get more complicated and include more compute instances at home and in the cloud, a headquarters (enterprise) facility may also or instead include a personal network such as a home or a group of homes. The enterprise facility's computer network may be distributed amongst a plurality of physical premises such as buildings on a campus and located in one or in a plurality of geographical locations. The configuration of the enterprise facility as shown is merely exemplary, and it will be understood that there may be any number of compute instances, less or more of each type of compute instances, and other types of compute instances. As shown, the exemplary headquarters facility includes a firewall, a wireless access point, and one or more servers. It is to be readily understood that a headquarters will further include a plurality of internal end-points. Again, the compute instances depicted are exemplary, and there may be any number or types of compute instances in a given headquarters (enterprise) facility. For example, in addition to the elements depicted in the enterprise facility, there may be one or more gateways, bridges, wired networks, wireless networks, virtual private networks, other compute instances, and so on.

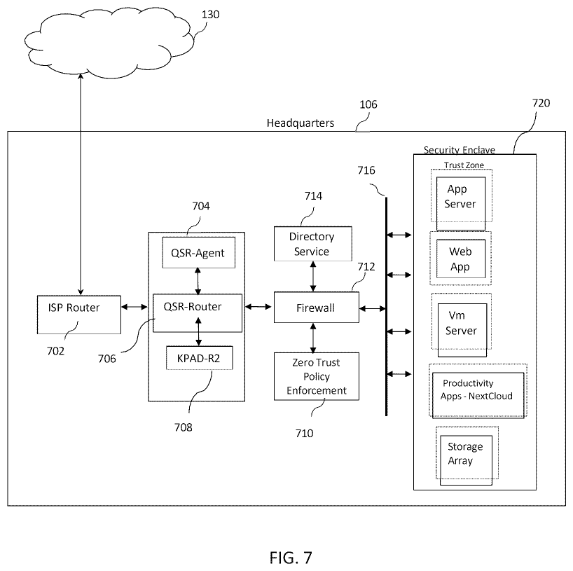

FIG. 7 is a block diagram of a headquarters that can be operative within a quantum secure/resistant ecosystem (QSR-E), according to embodiments. With reference to FIG. 7, the headquarters 106 can communicate with a communication network 130 via an ISP router 702 and thus is capable of communication with a QSOC for creation of a QSR-E with the headquarters. Within the headquarters is an QSR-Agent 704, QSR-Router 706 and a KPAD 708 which enable the headquarters to communicate with a QSOC for the authorization and identification of the headquarters as well as creation of a QSR-E for the headquarters. Also within the headquarters is a firewall 712 which restricts access to the security enclave 720 associated with the headquarters. The firewall 712 can access a directory service 714 and a zero trust policy enforcement 710 for suitable operation thereof. Further operational characteristics of these components are further discussed elsewhere herein.

FIG. 8 is another block diagram of a headquarters that can be operative within a quantum secure/resistant ecosystem (QSR-E), according to embodiments.

### Remote Office

According to some embodiments, a remote office is generally connected and subordinate to the headquarters. Often referred to as small office home office (SOHO), these offices allow individuals or groups to work closer to home or to smaller markets.

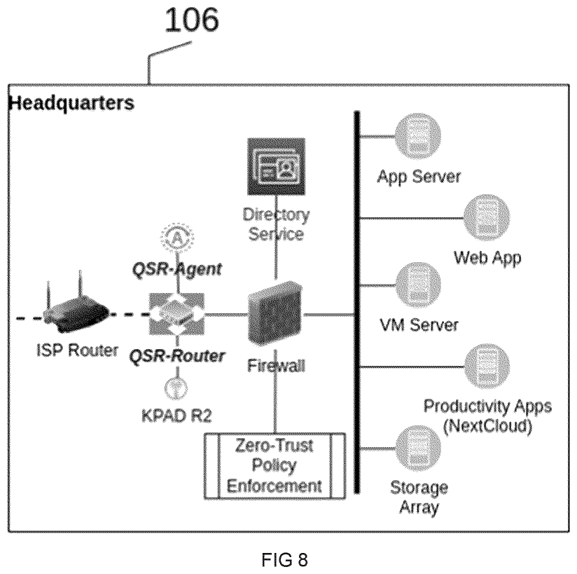

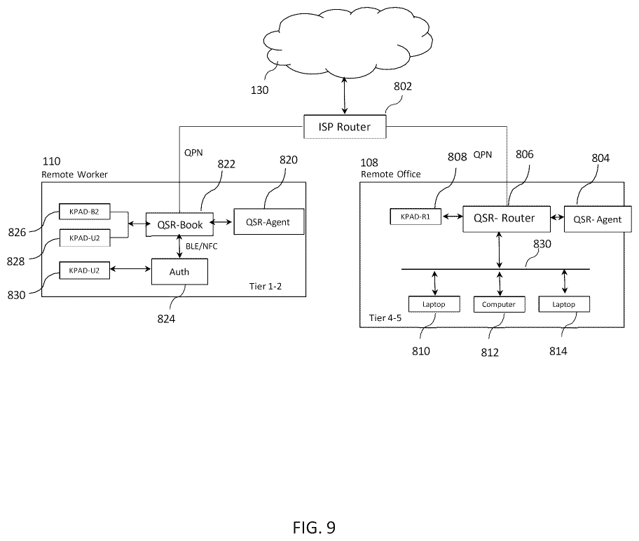

FIG. 9 is a block diagram of a remote worker and a remote office that can be operative within a quantum secure/resistant ecosystem (QSR-E), according to embodiments. With reference to FIG. 9, the remote office 108 can communicate with a communication network 130 via an ISP router 802 and thus is capable of communication with a QSOC for creation of a QSR-E with the remote office. Within the remote office is an QSR-Agent 804, QSR-Router 806 and a KPAD 808 which enable the remote office to communicate with a QSOC for the authorization and identification of the remote office as well as creation of a QSR-E for the remote office. Also, within the remote office are a collection of users 810, 812, 814 which are able to communicate with the QSR-Router 806 via a communication network 830, which can be a private network associated with the remote office. Further operational characteristics of these components are further discussed elsewhere herein.

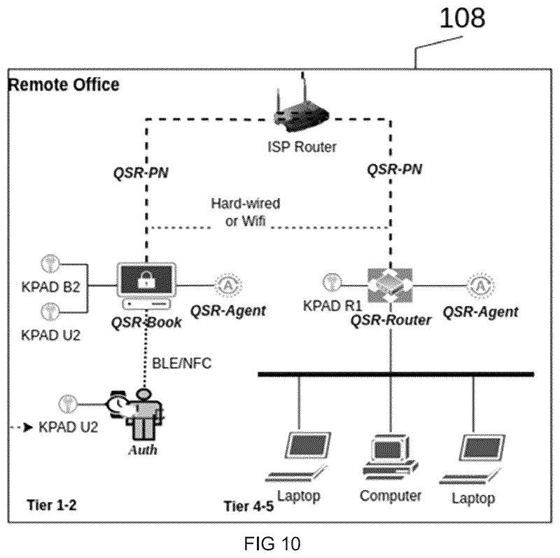

FIG. 10 is block diagram of a remote office that can be operative within a quantum secure/resistant ecosystem (QSR-E), according to embodiments.

### Remote Worker

According to some embodiments, a remote work (also known as work from home [WFH] or telecommuting) is a type of flexible working arrangement that allows an employee to work from a remote location outside of a corporate office. Remote work requires policies governing equipment use, access and network security. A remote worker can typically connect to the corporate office (headquarters) using a QSR-Book.

FIG. 9 is a block diagram of a remote worker and a remote office that can be operative within a quantum secure/resistant ecosystem (QSR-E), according to embodiments. With reference to FIG. 9, the remote worker 110 can communicate with a communication network 130 via an ISP router 802 and thus is capable of communication with a QSOC for creation of a QSR-E with the remote worker. Within the remote worker is an QSR-Agent 820, QSR-Book 822 and a KPAD security keys 826, 828, 830 which enable the remote worker to communicate with a QSOC for the authorization and identification of the remote worker as well as creation of a QSR-E for the remote worker. The Auth 824 associated with the remote worker provides for remote management of the remote worker for authorization and identification of the remote worker for access to the QSR-E. Further operational characteristics of these components are further discussed elsewhere herein.

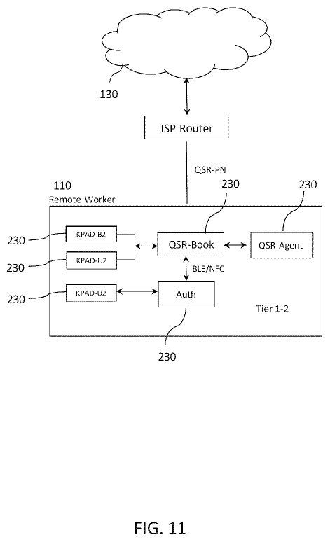

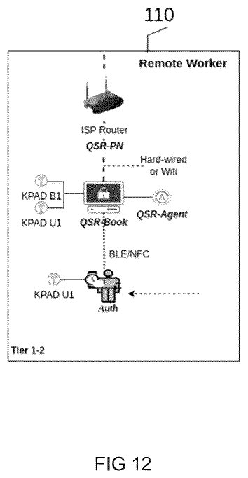

FIG. 11 is block diagram of a remote worker that can be operative within a quantum secure/resistant ecosystem (QSR-E), according to embodiments. FIG. 12 is another block diagram of a remote worker that can be operative within a quantum secure/resistant ecosystem (QSR-E), according to embodiments.

### Industrial Control Systems

According to some embodiments, industrial control systems can include a variety of remote locations where particular control systems are operating for example transformer stations, dams or industrial control systems that may require remote access and secure communication.

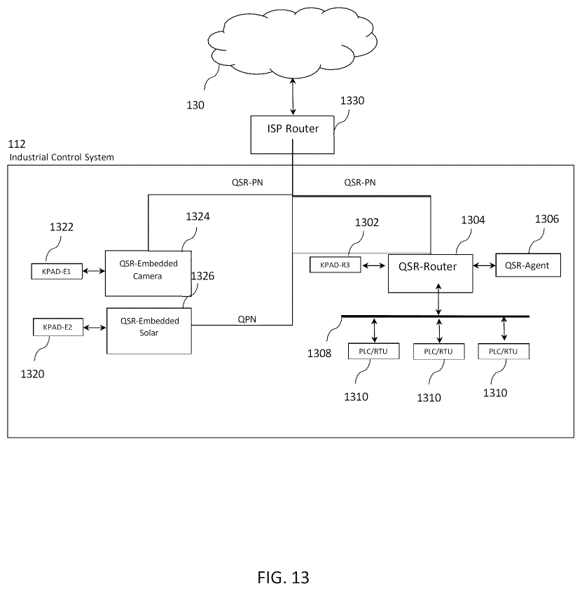

FIG. 13 is block diagram of an industrial control system that can be operative within a quantum secure/resistant ecosystem (QSR-E), according to embodiments. With reference to FIG. 13, the industrial control system 112 can communicate with a communication network 130 via an ISP router 1330 and thus is capable of communication with a QSOC for creation of a QSR-E with the industrial control system. Within the industrial control system is an QSR-Agent 1306, QSR-Router 1304 and a KPAD 1302 which enable the industrial control system to communicate with a QSOC for the authorization and identification of the industrial control system as well as creation of a QSR-E for the industrial control system. Also, within the industrial control system is a QSR-Embedded camera 1324 and QSR-Embedded solar 1326 wherein each have an associated KPAD 1322, 1320 enabling the creation of a QSR-E therefor. The QSR-Router 1304 provides secure access by one or more programmable logic controllers (PLC) or remote terminal units (RTU) 1310 to a QSOC. Further operational characteristics of these components are further discussed elsewhere herein.

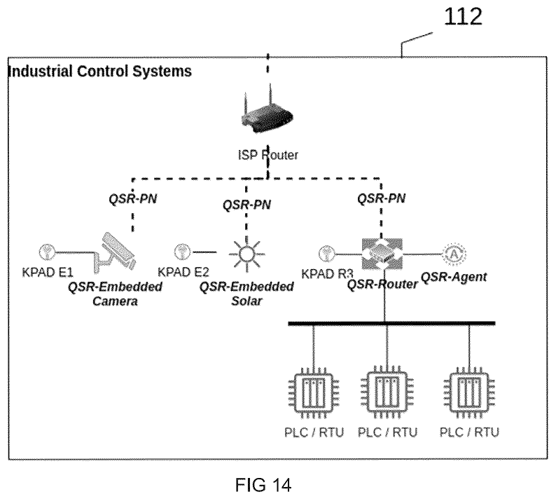

FIG. 14 is another block diagram of another industrial control system that can be operative within a quantum secure/resistant ecosystem (QSR-E), according to embodiments.

### Quantum Secure/Resistant Hosted Applications (QSR-APPS)

According to some embodiments, whether implemented as self-hosted or software-as-a-service (SaaS), applications are used to create and manage data and represent the most exposed and exploited components of the attack surface. QSR-E offers the tools necessary for software developers to tightly integrate their applications into QSR-E, and when in compliance with QSR-E standards these applications are classified as quantum secure/resistant hosted applications (QSR-Apps) 230.

According to some embodiments, QSR-Apps refers to a category of customized end-user applications, including: 1) simple applications similar to applications that are used on a phone or tablet computer; 2) integrated enterprise applications such as ERP, CRM, banking, or other solutions; 3) custom or embedded end-user productivity/collaboration tools, including: QSR-Spaces, QSR-Locker, and QSR-Pay. All QSR-Apps share a user-specific data storage location refer to as QSR-DR-Data Repository.

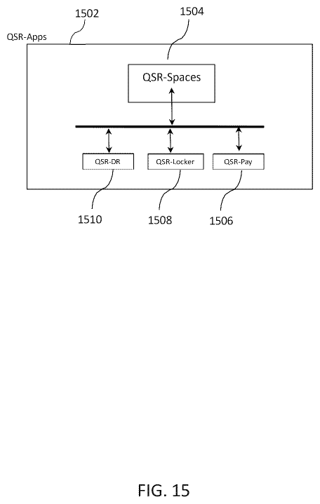

FIG. 15 is a block diagram of QSR-Apps that can be operative within a quantum secure/resistant ecosystem (QSR-E), according to embodiments. As illustrated a collection of applications can be present within QSR-Apps 1502 which can include QSR-Spaces 1504 associated with a particular user wherein within the QSR-Spaces 1504 can be a number of different user specific applications for example QSR-DR 1510, QSR-Locker 1508 and QSR-Pay 1506.

According to some embodiments, when integrating or building a QSR-Apps, there are several key aspects and capabilities that may be integrated into the QSR-Apps through the system, including identity, authorization, quantum secure/resistant communication.

According to some embodiments, with respect to identity, each QSR-Apps is provided with the identity of the user and the device that the user is running the app upon, as well as any network, policy, or optional geolocation attributes. Additionally, IAM provides the ability to implement and leverage SSO (single-sign-on) capabilities leveraging federated identity solutions integrating into the end-users enterprise(s).

According to some embodiments, with respect to authorization, each QSR-Apps is registered within the EAM, IAM, and UEM systems, and as such custom policies are enabled and managed within PO to enable the ability to define zero-trust policy enforcement rules.

According to embodiments, since the QSR-Apps is running within the QS Ecosystem, leverages the secure QSR-PN communications, and has access to the QS KPAD library, the application can take advantage of these services to enable quantum secure communications within other applications, services, or enterprises.

According to embodiments, with respect to QSR-Space/Q-DR integration, each end-user registered within the QSR-E will inherently have access to their personalized QSR-Space and associated persistent data/configuration storage location (QSR-DR) for storing application settings, application data, or accessing common “personalized” data such as credit cards, password lockers, personal address books and the like.

According to embodiments, the concept behind the QSR-Space acknowledges that there is provision for various types of digital asset (e.g. data is an asset) activities that need to be separately managed and protected:

According to embodiments, personal data related to one's finances, healthcare and education should always be under one's control, and one must be able to decide if any of this data should be shared, and if so for how long. Access to third-party data and applications must also be under the control of the user, to the extent that their granted privileges allow, and within the personal QSR-Space the keys used to access these must be manageable by the user, for example in a conventional sense would be a password locker, or QSR-Locker as applied in a QSR-Space. Each user determines and manages its own security policies. Every user must have a personal QSR-Space within the QSR-E before they can access a QSR-Space established for them by a group, such as an employer.

According to embodiments, work data is generally owned by an enterprise (a headquarters), whether you are an employee, contractor, volunteer, board member, or fall under some other classification. In some instances, work data may be jointly owned by you and an enterprise, such as employment information. Students share ownership of their transcripts with schools, and patients share ownership over health records with their health care providers. The same applies for professional services including financial and legal. Shared ownership and the rights of each party must be specified and enforceable. In each instance and for each data asset ownership and control privileges are governed by security policies. An enterprise controls its own security policies and can remove privileges from any user. Users must have the same controls over their personal data. With these capabilities users can share verifiable records with any parties that they choose; and the professional party, such as an auditor, is aware of and can validate the data when it is shared. This is an invaluable capability to validate user claims. These QSR-E features can be used by QSR-Apps to maintain privacy respecting security policies, and to provide confidence for reviewers of third-party validated data.

According to embodiments, a provision is also made to transfer control over a QSR-Space to assigns and successors. In the case of a personal QSR-Space, at the time of incapacity or death, the user's ownership of the personal QSR-Space and all data and keys within this QSR-Space is transferred to the user's estate. As in all instances the security policies for this are set by the user and can be triggered as a dead-mans-switch (eg. no activity for 30 days and access is transferred to the user's attorney).

According to embodiments, a group can share control over a QSR-Space. for example, a board of directors governs a company on behalf of its shareholders. The votes cast by the directors, a QSR-Vote (another QSR-Apps that can be provided by competitive SaaS providers or developers of self-hosted solutions) can be acted upon through keys protected within the entity's QSR-Space. Another example of group control over a QSR-Space is a special needs trust whereby the trustees collectively make decisions on behalf of a disabled adult.

According to embodiments, these capabilities can be provided through a QSOC managed API (application programming interface).

### Quantum Secure/Resistant Services

According to embodiments, quantum secure/resistant CommSec (QSR-ComSec) can be defined as a unified communication service that enables devices to securely communicate across public and private networks using voice, video, text and data exchanges. QSR-ComSec includes Auth protocols and QSR-PN services.

According to embodiments, QSR-Blocks can be defined as similar to a blockchain technology wherein this blockchain is made quantum secure/resistant within the QSR-E.

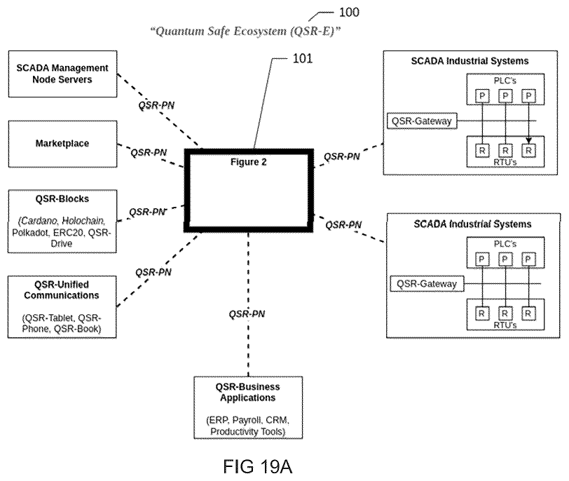

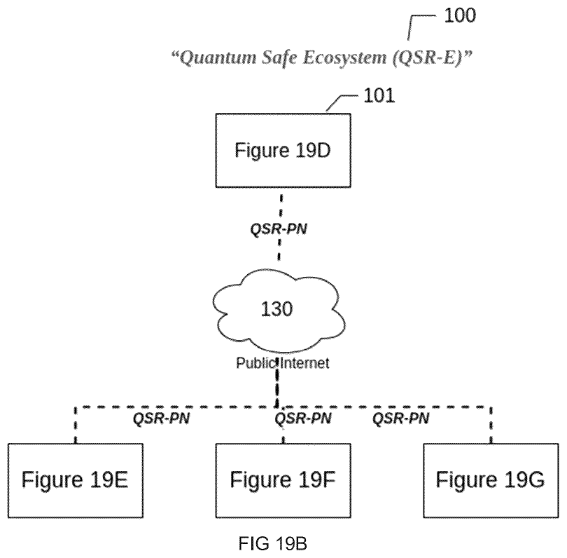

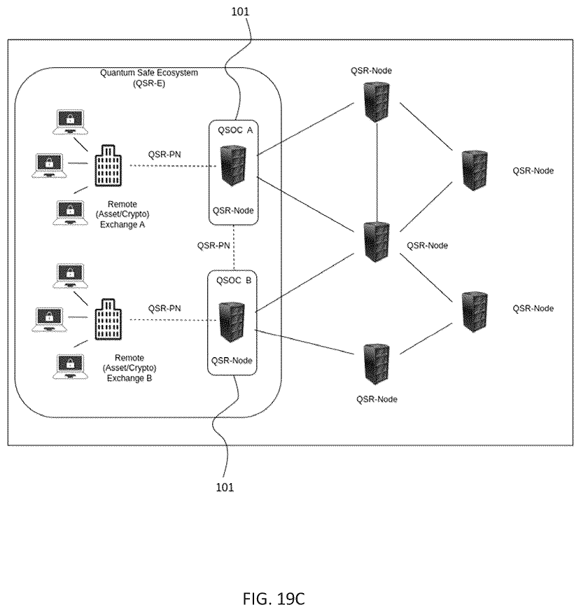

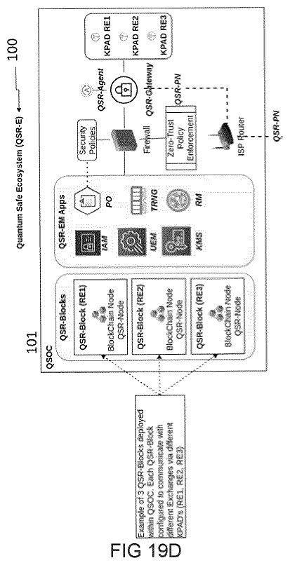

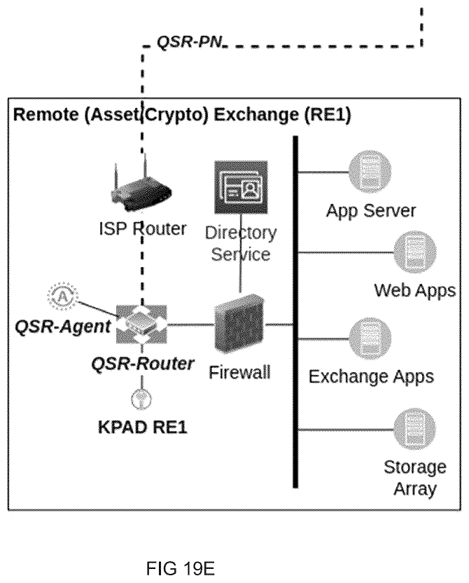

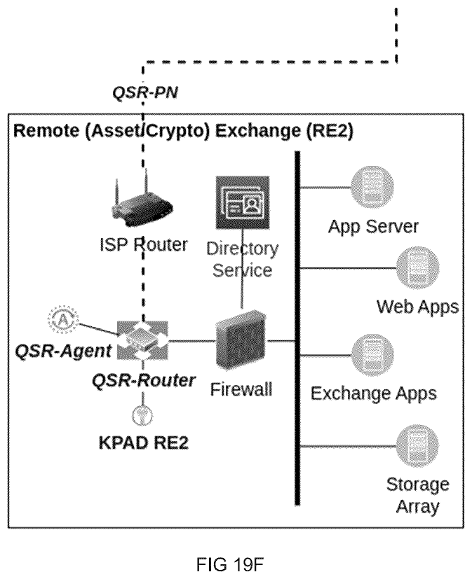

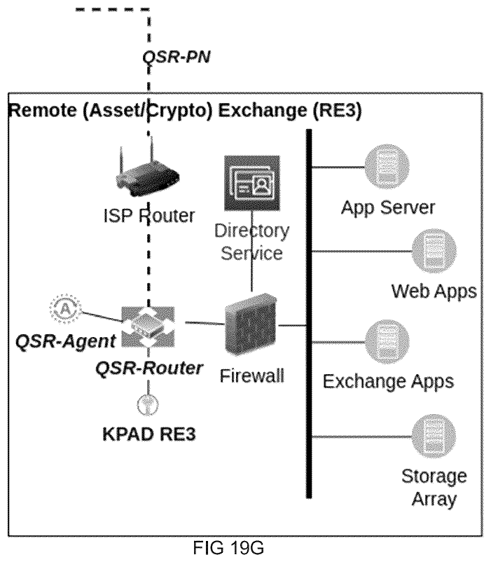

FIG. 19B is a schematic representation of a quantum secure/resistant Ecosystem illustrating networked QSR-PN enabled architecture features as listed in

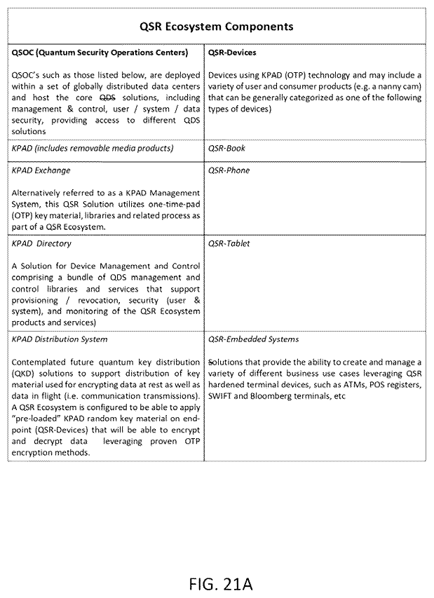

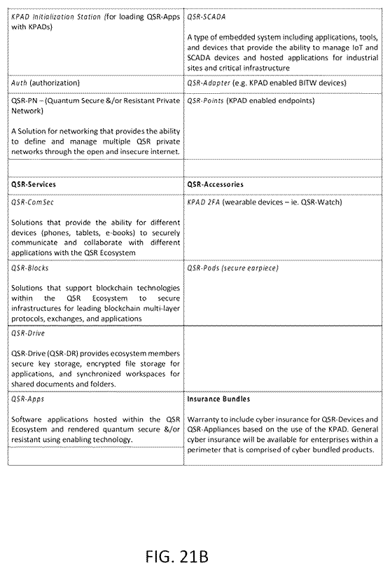

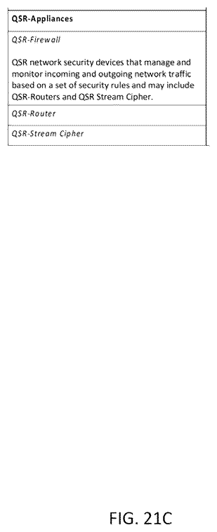

Table 1, FIGS. 21A, 21B & 21C according to embodiments.

FIG. 19B illustrates a quantum secure/resistant ecosystem, wherein a QSOC is configured to comprise one or more QSR-Blocks, (e.g., QSR-Blocks RE1, QSR-Blocks RE2 and QSR-Blocks RE3). Each QSR-Blocks is a blockchain node (i.e., a Q-node), hosted within a QSOC, and provides the QSR-PN communication with one or more Remote (Asset/Crypto) Exchanges. Each Q-Block is configured to communicate with different Exchanges via different KPADs (RE1, RE2 and RE3). For example, QSR-Blocks RE1 uses KPAD RE1, QSR-Blocks RE2 uses KPAD RE2, QSR-Blocks RE3 uses KPAD RE3, etc. It is to be understood that while above QSR-Blocks has been discussed with respect to Asset/Crypto exchanges, this is merely one of a plurality of use cases. These other use cases of QSR-Blocks are to be considered to be within the scope of the instant application.

FIG. 19B includes block diagrams of Remote (Asset/Crypto) Exchanges (e.g., RE1, RE2 and RE3) that can be operative within a quantum secure/resistant ecosystem (QSR-E), according to embodiments. With reference to FIG. 19B, the Remote (Asset/Crypto) Exchanges can communicate with a communication network via an ISP router and thus are capable of communication with a QSOC for creation of a QSR-E with the Remote (Asset/Crypto) Exchanges. Within the Remote (Asset/Crypto) Exchanges is a QSR-Agent, QSR-Router and a KPAD which enable the Remote (Asset/Crypto) Exchanges to communicate with a QSOC for the authorization and identification of the Remote (Asset/Crypto) Exchanges as well as creation of a QSR-E for the Remote (Asset/Crypto) Exchanges. Also within the Remote (Asset/Crypto) Exchanges is a firewall 712 which restricts access to the security enclave associated with the Remote (Asset/Crypto) Exchanges. The firewall can access a directory service and a zerotrust policy enforcement for suitable operation thereof. Further operational characteristics of these components are further discussed elsewhere herein.

FIG. 19C is a schematic representation of a quantum secure/resistant ecosystem illustrating networked QSR-PN enabled architecture features as listed in TABLE 1, FIGS. 21A, 21B & 21C according to embodiments supporting blockchain. FIG. 19C describes an embodiment of the QSR-E, wherein this embodiment represents the ability to support multiple nodes distributed amongst multiple QSOCs that are configured in operative communication with one another. In this embodiment, Remote (Asset/Crypto) Exchange A communicates with QSOC A and Remote (Asset/Crypto) Exchange B communicates with QSOC B.

The existing Q-nodes within this diagram, although they exist within the QSR-E, they are configured to support existing communication channels with other nodes over an internet located outside of the QSR-E

According to embodiments, QSR-Apps can be defined such that software applications hosted within the QSR-PN system are inherently quantum secure/resistant.

According to embodiments, QSR-Locker is an example of an end-user application that provides a secure location to store “personalized” user passwords for a variety of purposes, including browser passwords, system passwords, etc. into the user's personal QSR-DR within their QSR-Space.

According to embodiments, QSR-Pay is an QSR-Apps end-user application that provides the ability to perform secure payment processing.

### Quantum Secure/Resistant Data Repository

According to embodiments, a quantum secure/resistant data repository (QSR-DR) can be envisioned as a data repository is an online “personal” data storage location and drive accessible within the QSR-E. In some embodiments, a QSR-DR may be referred to as a QSR-Drive. One or more QSR-DRs can be configured for a user within the user's QSR-Spaces configuration to enable access to remote configuration data and storage. The QSR-DR may be optionally exposed through the device's filesystem as a virtual file system to support the ability of seamless access to the drive. Since QSR-Devices are QSR-E networked, all data transfer to and from the QSR-DR is encrypted in transit throughout the QSR-E.

According to embodiments, QSR-DR supports the ability to store data at rest where it is encrypted with QSR-PN managed keys stored within the QS KMS. This capability limits access to data files to authenticated QS users. Additionally, the QSR-DR provides users with secure key storage, encrypted file storage, and virtual workspaces for shared data.

### Identity Provider

According to embodiments, an identity provider may be any remote identity management system or the like configured to communicate with an identity management facility, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider. In an embodiment the IAM is responsible for device identity.

In embodiments, the identity provider may provide user identity information, such as multi-factor authentication, to a SaaS application. Centralized identity providers such as Microsoft Azure, may be used by an enterprise facility instead of maintaining separate identity information for each application or group of applications, and as a centralized point for integrating multifactor authentication. In embodiments, the identity management facility may communicate hygiene, or security risk information, to the identity provider. The identity management facility may determine a risk score for a user based on the events, observations, and inferences about that user and the compute instances associated with the user. If a user is perceived as risky, the identity management facility can inform the identity provider, and the identity provider may take steps to address the potential risk, such as to confirm the identity of the user, confirm that the user has approved the SaaS application access, remediate the user's system, or such other steps as may be useful.

In embodiments, information may be sent from the enterprise to a third party, such as a security vendor, or the like, which may lead to improved performance of the risk management. In general, feedback may be useful for any aspect of threat detection. For example, the types, times, and number of virus interactions that an enterprise experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

According to some embodiments, organizations increasingly request “federated services” for user management. With federated services, a single sign-on (SSO) to an identity provider, or “IDP,” provides user access to multiple software products at once, without requiring separate logins for each product. Federated services are usually easier for administrators to manage than are separate accounts for each product. For example, an administrator can create or disable a user's access to many software products at once, just by changing that user's settings in the IDP.

### Mesh Network Design

According to embodiments, a mesh network design is described with reference to FIG. 38. Several steps are illustrated in FIG. 38. In Step 1 the user authenticates to a QSR-Enterprise Asset Management (EAM) registered Q-Device such as a QSR-Book within the QSR-E using Auth MFA. In Step 2 the user authenticates to QSR-E IAM user directory. In Step 3 the user selects QSR-Device end-point to connect. In Step 4 a dynamic network config is downloaded from QSR-PN Device Directory Sync and an ephemeral symmetric session key as identified in 4a is downloaded from QSR-PN Key Exchange to the QSR-Book 1. In Step 5, a dynamic network config is downloaded from QSR-PN Device Directory Sync and an ephemeral symmetric session key encrypted with a KPAD identified in 6a is downloaded from QSR-PN Key Exchange for QSR-Book 2. The next step, QSR-Book 1 initiates a handshake with QSR-Book 2 encrypted with KPAD and forwards their ephemeral symmetric session key encrypted with a KPAD to QSR-Book 2. The next step QSR-Book 2 completes a handshake encrypted with KPAD and forwards their ephemeral symmetric session key encrypted with KPAD to QSR-Book1. In Step 7 a dynamic network encrypted tunnel is created with the ephemeral symmetric session keys. New keys are regenerated every variable time period and the handshake processes are repeated.

In one embodiment, the ephemeral symmetric session key encrypted with a KPAD is downloaded to both QSR-Book 1 and QSR-Book 2 at the same time.

The design for a basic virtual private network can be found in one or more publications, such as, for example U.S. Patent Application Publication No. 2022/0255905, herein incorporated by reference, which teaches systems, methods, and software to manage private networks for computing elements. In one example, a coordination service may obtain a request from a computing element to join a private network. In response to the request, the coordination service may identify communication rules associated with the computing element based on credential and device information in the request and may identify communication information to permit the computing element to communicate with one or more other computing elements in the private network. Once identified, the communication information may be communicated to the computing element.

The design for a basic virtual private network can be found in one or more publications, such as, U.S. Patent Application Publication No. 2022/0029973, herein incorporated by reference, which teaches systems, methods, and software to manage private networks for computing elements. In one example, a computing element may obtain credential information associated with a user and generate a public-private key pair for the computing element. The computing element may further communicate the public key from the pair with metadata to a coordination service to register the computing element at the coordination service. Once registered, the computing element may receive communication information associated with one or more other computing elements that permit the computing element to communicate with the other computing elements.

These descriptions for constructing a VPN teach that by providing coordination servers, the solution enables users to set up dynamic networks between different nodes by sharing network configuration information within the coordination servers that can be downloaded by individual nodes to enable the nodes to set up and configure a peer-to-peer tunnel between 2 nodes. When propagated throughout many or all of the nodes, the solution enables a mesh network, where encrypted network communication tunnels are established utilizing public/private keypairs between each node.

The detailed steps comprise: a) Each node generates a random public/private keypair for itself, and associates the public key with its identity; b) The node contacts the coordination server and leaves its public key and a note about where that node can currently be found, and what domain it's in; c) The node downloads a list of public keys and addresses in its domain, which have been left on the coordination server by other nodes; d) The node configures its WireGuard instance with the appropriate set of public keys.

These descriptions for constructing a VPN, for example using WireGuard, however, are not quantum secure/resistant and could be at risk of intrusion when quantum computing becomes more common. The system described herein generates a quantum secure/resistant version of a VPN, being a QSR-PN, wherein the improvements to render the VPN quantum secure/resistant are as follows.

As an overview, the QSR-PN securely distributes a shared dynamic ephemeral symmetric session key for communication, rather than generating and communicating public keys and communication information. Moreover, QSR-Devices use the QSR-PN to privately and securely obtain access to the QSR-Device Directory Service (which can be considered to be a more robust configuration of a coordination service).

The QSOC registers and identifies users and their associated computer systems (nodes) with a distributed set of Coordination Servers. Within the QSR-E, user identification and authorization is controlled by the IAM system which provides federated identity access to 3^{rd} party identity management and directory services such as Active Directory, OKTA, or Ping. Device identification/registration is performed within the UEM service which maintains device identity, attributes, network address, and other attributes about the QSR-Devices managed within the QSR-E. Since the QSR-E has these capabilities, the QSR-E will logically leverage these services that will provide some of the necessary capabilities within the QSR-Device Directory Service (the replacement to the Coordination Server).

Moreover, rather than creating an encrypted network connection utilizing public/private keys, the QSOC creates a dynamic encrypted network connection utilizing shared ephemeral symmetric session keys. The ephemeral symmetric session keys are shared between the nodes through the QSOC via QSR-PN quantum secure/resistant (QSR) KPAD encrypted tunnels whereby each peer has a QSR-PN KPAD pair with the associated QSR-Gateway within the QSOC and communicates through the QSOC leveraging the QSR-PN Key Exchange. The QSR-PN Device Directory Service within the diagram effectively performs the operations necessary to keep track of all QSR-Devices and their network addresses within the QSR-E, along with domain information. Instead of downloading public keys, every network connection is dynamically created using shared ephemeral symmetric session keys which are regenerated on a periodic basis (e.g., between 2-5 min).

In some embodiments, the encryption algorithm used by the QSR-PN is ChaCha20 Poly1305. The encryption algorithm used by QSR-PN can be replaced as the cyber security community evolves and generates new ones, therefore the architecture for integration of the encryption algorithm for use with creation of a QSR-PN is such that a new encryption algorithm can be added or removed in a relatively simple manner. Possible ciphers could be those proposed by NIST from the post-quantum cryptography project, such as CRYSTALS-Kyber, CRYSTALS-Dilithium, FALCON and SPHINCS+. Other algorithms that might be used are AES-GCM-SIV, AES-GCM, AES-CBC+HIMAC-SHA2, Elliptic Curve.

### Multiple Tiers of Service

According to some embodiments, the QSR-E assesses risk in multiple ways. In one embodiment, the QSR-E identifies the types of access that devices are granted based on the security policies that govern the types of encryption that they are permitted to use. The system is able to provide a plurality of tiers of security-level service. In one embodiment, the system provides 5 tiers of service representing 5 separate security levels.

According to some embodiments, according to a Tier 1 security level service, the supplied devices only have the ability to communicate with other Tier 1 devices. Tier 1 represents the highest security tier and is restricted to pure KPAD encryption, making the communications between Tier 1 devices QS (quantum secure). Tier 1 devices are hardened, meaning that the hardware and operating system of a Tier 1 device have been modified to reduce the surface of vulnerability. Tier 1 devices can be deployed through the QSR-E.

According to some embodiments, according to a Tier 2 security level service, QSR-PN supplied devices with the ability to communicate outside the QSR-PN System. Tier 2 devices can communicate with pure KPAD encryption for the most sensitive communications, but they can also communicate in QR (quantum resistant) mode, whereby a symmetric key exchange between KPADs replaces the key exchange mechanisms provided for with public key infrastructure (PKI), post quantum cryptography (PQC) and quantum key distribution (QKD) methodologies. Furthermore, Tier 2 devices could, if permitted by the security policies that govern their use, communicate with Tier 3, 4 and 5 devices. Tier 2 devices are hardened, meaning that the hardware and operating system of a Tier 2 device have been modified to reduce surface of vulnerability. Tier 2 devices can be deployed through the QSR-E.

According to some embodiments, according to a Tier 3 security level service, QSR-Adaptor w/KPAD and interactions with Tiers 2-5. Tier 3 devices have been upgraded with QSR-Adaptors. A QSR-Adaptor may also be referred to as a BITW (bump-in-the-wire). Furthermore, Tier 3 devices could, if permitted by the security policies that govern their use, communicate with Tier 3, 4 and 5 devices. The device that a QSR-Adaptor is connected to, such as a SCADA device, has not been hardened and may still be vulnerable if an attacker can physically access it. QSR-Adaptors, but not the devices they're connected to, can be deployed through the QSR-E.

According to some embodiments, according to a Tier 4 security level service, Client supplied devices with a physically uploaded QSR-Apps including a KPAD through a removable media product supplied by QSR-PN. Tier 4 represents an end user device that is upgraded with a QSR-Agent and enabled with PQC capabilities making the device QR (quantum resistant). Tier 4 devices may not be deployed through the QSR-E, but they may communicate with other QSR-E connected devices subject to the security policies that govern these other devices.

According to some embodiments, according to a Tier 5 security level service, client supplied devices that download the QSR-Apps-only conventional PKI capable-no KPAD included. Tier 5 represents an end user device that is upgraded with a QSR-Agent so that it can connect to the QSR-E and communicate with other QSR-E connected devices subject to the security policies that govern these other devices, but such a device is not QR as it can only communicate with conventional key exchange mechanisms, including PKI and TLS. Tier 5 devices may not be deployed through the QSR-E.

According to some embodiments, TABLE 1 describes the 5 different security Tiers w/modification via security policies for QSR-Devices deployed within the QSR-E. Note that Tiers 4 and 5 are provided as QSR-E delivered services to expedite on-boarding of new users to the QSR-E service. e.g. Clients within a Remote Office/SOHO environment can provision QSR-Router(s) with specific office locations and then utilize existing computers (such as Windows or Apple Mac desktop or laptop computers) within the office, and simply connect to the QSR-Router via hard-wired or WiFi LAN, and get access through the QSR-E Enterprise QSR-PN to their enterprise applications and services with a quantum secure/resistant (KPAD stream-cipher) or quantum secure/resistant (KPAD handshake+dynamic symmetric session keys) communication network.

TABLE 1

| Security | Key | Cipher | Device | |
|---|---|---|---|---|
| Tier | Security | Security | Security | Assessment |
| T1 | Q-Secure | Q-Secure | Hardened | Unbreakable key exchange |
| | | | | Unbreakable encryption |
| | | | | Secure platform |
| T2 | Q-Secure | Q-Resistant | Hardened | Unbreakable key exchange |
| | | | | Practically unbreakable encryption |
| | | | | Secure platform |
| T3 | Q-Secure | Q-Secure/ | Commercial | Unbreakable key security |
| | | Q-Resistant | | Q-Secure or Q-Resistant data in |
| | | | | transit |
| | | | | Vulnerable to device attacks |
| T4 | Advanced | Q-Resistant | Commercial | Resistant to quantum computer |
| | | | | attacks |
| | | | | key exchange and encryption |
| | | | | Vulnerable to device attacks |
| | | | | (commercial) |
| T5 | Vulnerable | Q-Resistant/ | Commercial | Vulnerable to quantum computer |
| | | Vulnerable | | attacks |
| | | | | key exchange can be broken |
| | | | | Vulnerable to device attacks |
| | | | | (commercial) |

According to embodiments, there are three elements to secure transmission of data. The key exchange can be considered to be one of the most vulnerable attack vectors by conventional and quantum computing capabilities. The key exchange is where quantum computer technology and Shor's algorithm enable cracking of classical key exchange algorithms is seconds. The cipher security is much stronger when the key is not known. Even for quantum computers with Grover's algorithm the current classical cipher algorithms can be considered to be very strong (which may be considered as Q-Resistant). Pure OTP cipher algorithm is mathematically proven to be unbreakable, but the rest of current classical cipher algorithms still are considered Q-Resistant. However, progress in quantum computer technology and new algorithms could change that perspective very quickly exposing the harvest now, decrypt later (HNDL) vulnerability. HNDL, also known as store now, decrypt later or retrospective decryption, is a surveillance strategy that relies on the acquisition and long-term storage of currently unreadable encrypted data awaiting possible breakthroughs in decryption technology that would render it readable in the future. The device security can be another attack vector. Attacks on the device could expose keys used for encrypting data in transit or could capture the data before being encrypted.

According to embodiments, the security tiers presented in TABLE 1, represent these three attack vectors in combination. Tier 1 has Q-secure security for both key security and cipher security with preloaded OTP keys on a hardened device mitigating the device attack vector. Tier 2 implements OTP methodologies for the Q-Secure key exchange with preloaded OTP keys and uses classical Q-Resistant cipher algorithms for data in transit, on a hardened device. However, if Q-secure security for both key security and cipher security is on a commercial, non-hardened, device then the device is vulnerable to cyber-attacks and would be classified as a Tier 3.

According to embodiments, the Tier 4 and Tier 5 difference is differentiated by the easiest and most vulnerable attack vector. Tier 4 uses the latest in key exchange algorithms (e.g. PQC) a significant improvement over Tier 5 key exchange algorithms. However, the device security would be the most vulnerable attack vector if on a commercial platform. Advances in quantum computing is expected to eventually break the key exchange algorithm. Tier 5 can be considered to have the most vulnerable attack vector which can be considered to be the key exchange even if the device is on a hardened device. If Tier 5 is on a commercial device, it is the most vulnerable. It is to be understood that there are some antiquated cipher algorithms that are known to be compromised, while still in use on some older equipment.

According to embodiments, there are multiple levels of key security which can include Q-secure, advanced and vulnerable. For a Q-secure level of key security, the keys are secure preloaded symmetric keys on the device, wherein an example is an OTP pad. For an advanced level of key security, there is advanced mathematical algorithms protecting key exchange, wherein an example is PQC Crystal-Kyber. For a vulnerable level of key security, there is mathematical key exchange algorithms that are known to be broken, wherein examples are PKI: RSA, Elliptic Curve Cryptography (ECC), Diffie-Hellman.

According to embodiments, there are multiple levels of cipher security which can include Q-secure, Q-resistant and vulnerable. For a Q-secure level of cipher security, mathematically proven unbreakable encryption, wherein an example is pure OTP. For a Q-resistant level of cipher security, which is considered practically unbreakable, even with current future expectations of quantum computing, wherein examples can be ChaCha20/Poly1305, AES 128/192/256. For a vulnerable level of cipher security, breaking the encryption is relatively simple, wherein examples are SSL/TLS, AES 128/192/256.

According to embodiments, there are multiple levels of device security which can include hardened and commercial. For a hardened device security, the device is security hardened mitigating cyber-attacks protecting keys and software, wherein an example is Center for Internet Security CIS L1-L5 and STIG (Security Technical Implementation Guides) (data at rest security, access controls and restrictions, disable physical ports). For a commercial level of device security, the device has minimal enhancements and is vulnerable to cyber-attacks, wherein an example is COTS commercial/consumer devices.

### Cyber Security and Privacy Risks

According to embodiments, cyber security risk is based on the probability of exposure or compromise of critical assets or information, occurring because of a cyber-attack or breach within an organization's infrastructure. The probability of reputational harm is also part of a cyber security risk profile. In a post quantum era, the probability of data loss or exposure due to advances in technology is also considered. Quantum risk can be characterized as the exposure of protected data because of increasing quantum computing capabilities. Quantum risk is only one of the many threat sources that an organization can face. It falls into the category of technology risk when conducting a risk assessment for an organization.

According to embodiments, QSR-E is a secure-by-design alternative to the open Internet within which users interact through QSR-E connected devices to create, edit, and manage data with the help of QSR-Apps, governed by self-managed security policies. QSR-E allows users and groups to assess and manage their cyber risk exposure through security policies, and to offer their insurers real-time access to their risk profiles. These risk profiles are used by integrated insurance products to dynamically calculate coverage, premiums and deductibles as changes are made by the user specifically and by the group, or enterprise, collectively.

In one embodiment, the QSR-E can provide the following information to an insurer about a customer's risk profile: 1) security policies and changes made to these policies; 2) the security tiers set for all devices used and the types of data and applications each has access to; 3) the IAM restrictions placed on user access to devices, data and applications; 4) the cost of exposure or value of data to be insured, the usage policies related to data classifications, and data loss prevention policies and safeguards to prevent damage, destruction or compromise of data; 5) the status of applications, ideally QSR-Apps, employed by users to create, edit and manage data.

According to embodiments, insurers can use QSR-E information generated about the insured's cyber risk profile, shared with them by their customers, as inputs to their proprietary risk assessment algorithms; insurers use these results to offer insurance products tailored to their customers' needs. QSR-E enabled insurance products allow for real-time changes to be calculated within the terms of the insurance contracts; as risk profiles change due to the addition of new devices, removal of devices, a change in the cost of exposure or value of data, applications employed, and any changes to the insured's security policies, the premiums, deductibles, and coverage can be revised.

According to embodiments, the QSR-E provides the following information to Insurers: QSR-E information generated about the insured's cyber risk profile, shared with them by their customers, as inputs to their proprietary risk assessment algorithms; insurers use these results to offer insurance products tailored to their customers' needs. QSR-E enabled insurance products allow for real-time changes to be calculated within the terms of the insurance contracts; as risk profiles change due to the addition of new devices, removal of devices, a change in the cost of exposure or value of data, QSR-Apps employed, and any changes to the insured's security policies, the premiums, deductibles, and coverage can be revised.

According to embodiments, the QSR-E model makes cyber insurance practical. At the present time many small customers are being denied cyber insurance or are finding that their current policies are not being renewed. Cyber insurance policies that are renewed are invariably stating new exclusions, offering lowered coverage, and present increases in both premiums and deductibles. For many of these customers cyber insurance is mandatory. Insurers are making these decisions because it is increasingly difficult for them to predict risk as they respond to a steady trend of increasing payouts, resulting in many of their customers becoming uninsurable. QSR-E offers the highest level of protection available in the market and dynamic mechanisms for customers and their insurers to make the business decisions that are right for them. The QSR-E Insurance Model is only applicable to protections offered within its ecosystem.

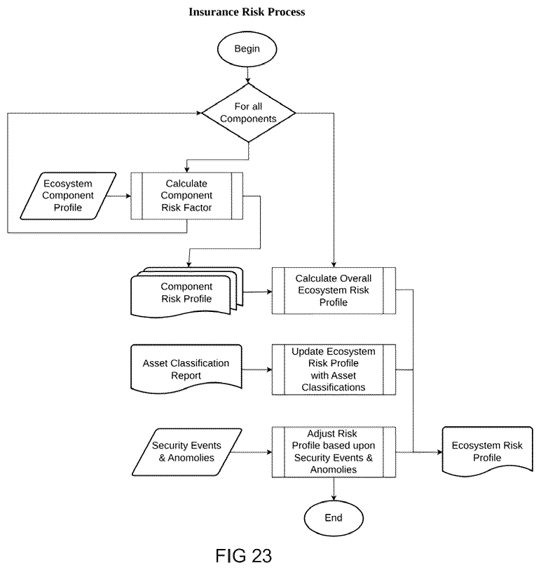

In one embodiment the QSR-E includes the capability to detect botnet activity and attack by identifying abnormal activity and patterns in traffic (see FIG. 23). Anomaly detection and remediation software offers the full automation of decision-making systems based on pre-defined business logic. If anomalous commands are issued they will not be executed leading to a number of options available to the system: do not execute and delete the command; do not execute and quarantine; defer execution until an administrator can review and either approve or disapprove the transaction-if approved then the business logic will need to be updated.

According to embodiments, a generalized cyber security risk assessment and mitigation (treatment) approach may include the steps of: 1) identifying assets and establishing risk acceptance (likelihood of exploit and impact probability); 2) identifying threat sources; 3) identifying vulnerabilities; 4) assessing likelihood of exploitation of a threat event; 5) determining impact (probability or weight-based scoring); 6) calculating risk as a combination of likelihood and impact; 7) evaluating against risk acceptance; 8) developing appropriate risk response; and 9) implementing controls & treatment plan.

According to embodiments, an insurance company can be provided access via a web portal and/or web API that required zero trust access credentials (permissions to RA threat analysis data. They must have a KPAD system (either a QSR-Book or QSR-Router). They would be provided with specific information to one- or more clients within the QSR-E as specified by fine grained permissions within the IAM system. The information provided would be summarized and “cleansed” of any personally identifiable information (PII) or client critical data. This can result in the provision of “redacted” system and network information reports.

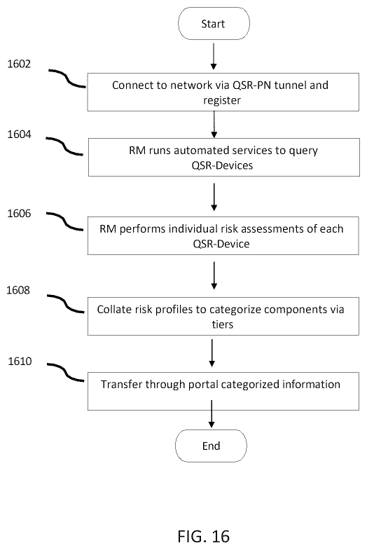

FIG. 16 is a workflow diagram for the provision of cyber security risk assessments and information, according to embodiments. With reference to FIG. 16 the workflow starts with device startup and when these devices start up and connect to the network 1602 over a QSR-PN tunnel, they register themselves with the QS ecosystem through their QSR-PN network attached QSOC service end-point (i.e., at or within a QSR-Gateway). The RM system runs regular automated services which reach out to the QSR-Devices 1604 and perform a set of introspection processes to gather system (device, operating system, configuration) information and usage information and record this information into a centralized database that RM utilizes. The RM then runs a set of algorithms to perform individual risk assessment 1606 on each of the devices, services, and applications that includes end-user device configuration and usage. This information is collated into risk profiles 1608 and reports are generated to categorize the components of the QSR-E into the different tiers defined above. Based upon the tier categorization, the summarized information 1610 is provided through a web API and/or web portal application to 3^{rd} party insurance providers for usage in calculation of insurance policy rates.

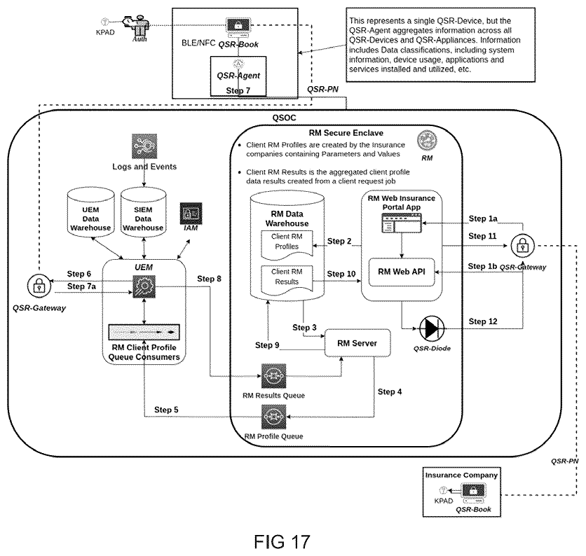

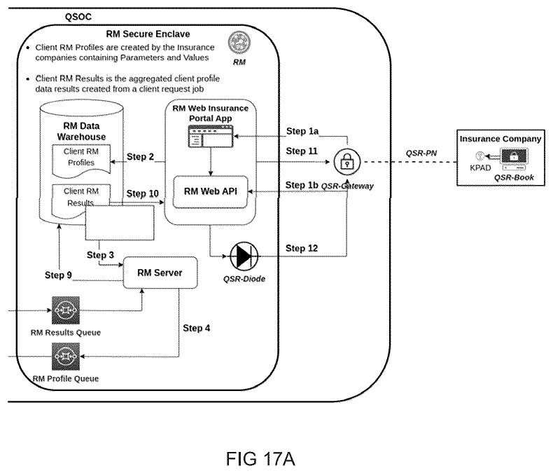

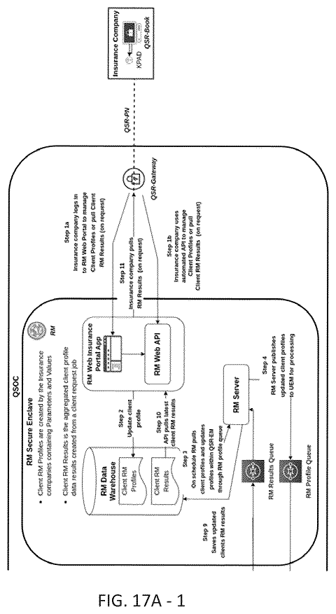

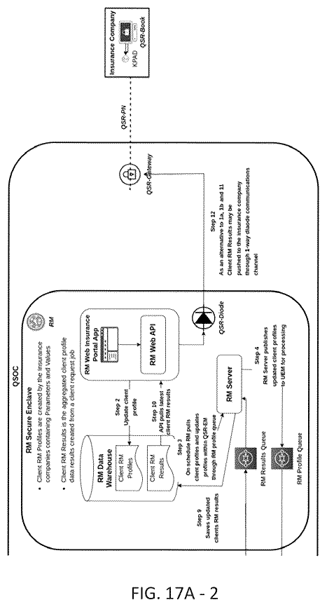

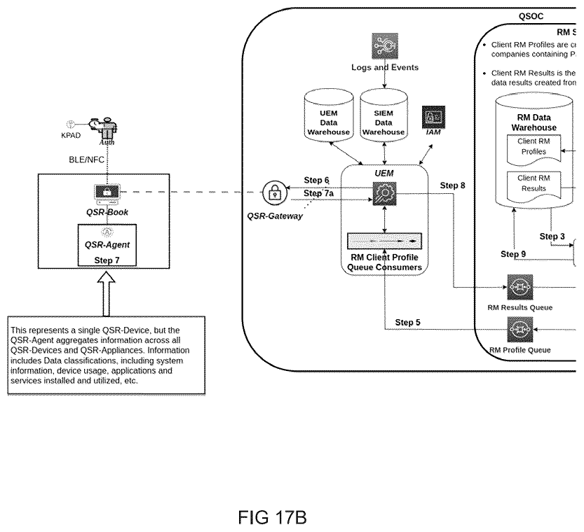

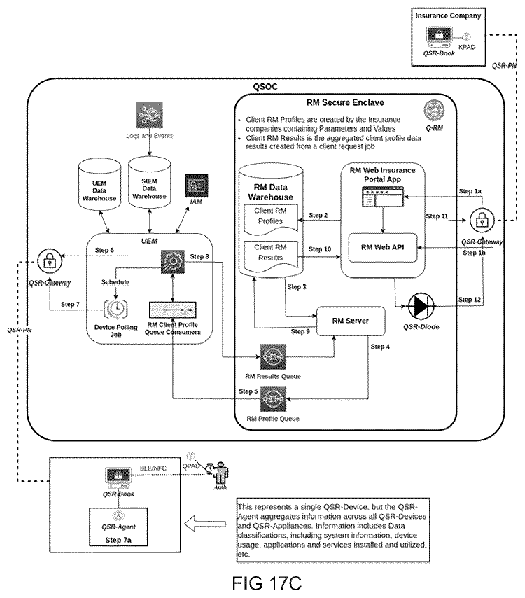

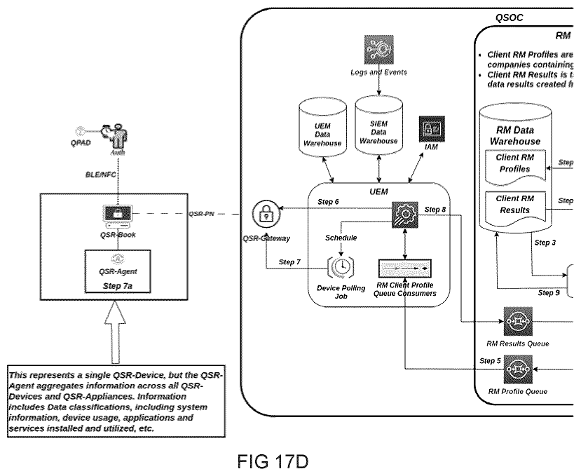

One embodiment of the Risk Manager (RM) is described with reference to FIG. 17 (the “UEM Push Configuration”). Close ups of different portions of the RM illustrated in FIG. 17 are provided in FIGS. 17A, 17A-1, 17A-2, and 17B. The portion of the illustration containing a close up of a first portion of the block diagram of a RM, depicted in FIG. 17 depicting one mode of communication between an insurance company and a QSOC, is presented in FIG. 17A-1.

In FIG. 17, there are several steps illustrated. In Step 1a the Insurance company logs into the RM Web Portal to manage Client Profiles or pull Client RM Results (on request). Step 2 is to update the Client Profile. In Step 3, on schedule the RM Server pulls Client Profiles and updates profiles within QSR-E through RM Profile Queue. In Step 4, the RM Server publishes updated Client Profile to UEM for processing. In step 9 the updated Client RM Results are saved in the RM Data Warehouse. In Step 10 the API pulls the latest Client RM Results. In Step 11, the Insurance Company pulls Client RM Results (on request).

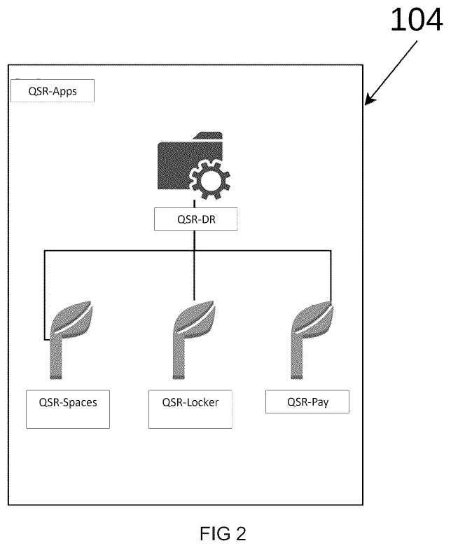

The portion of the illustration containing a close up of a first portion of the block diagram of a RM, illustrated in FIG. 17 depicting one mode of communication between an insurance company and a QSOC using a diode, is presented in FIG. 17A-2. In this embodiment, there are several steps illustrated. Step 2 is to update the Client Profile. In Step 3, on schedule the RM Server pulls Client Profiles and updates profiles within QSR-E through RM Profile Queue. In Step 4, the RM Server publishes updated Client Profile to UEM for processing. In step 9 the updated Client RM Results are saved in the RM Data Warehouse. In Step 10 the API pulls the latest Client RM Results. In Step 12, as an alternative to steps 1a 1b and 11, depicted in FIG. 17A, Client RM Results may be pushed to the Insurance Company through the 1-way diode communications channel.

The portion of the illustration containing the UEM Push Configuration is presented in FIG. 17B. In this embodiment, there are several steps illustrated. In Step 1a the Insurance company logs into the RM Web Portal to manage Client Profiles or pull Client RM Results (on request). In Step 1b Insurance company uses Automated API to manage Client Profiles or pull Client RM Results (on request). Step 2 is to update client profile. Step 3 is on schedule, RM server pulls Client Profiles and updates profiles within QSR-E through RM Profile Queue. Step 4 is RM Server publishes updated Client Profiles to UEM for processing. In Step 5 UEM consumes and processes different Client RM Profiles. In Step 6 Administrator can push out policy updates on demand. In Step 7, on schedule, based upon device policy, QSR-Agent gets device information from QSR-Device and sends the data back to UEM for storage into Data Warehouses. In Step 7a, QSR-Agent updates data in warehouses from devices based upon device policy. In Step 8 aggregated Client RM Results are published to the RM Results Queue and stored into RM Data Warehouse. In Step 9 updated Client RM Results are saved. In Step 10 API pulls latest Client RM Results. In Step 11 Insurance company pulls Client RM Results (on request). Step 12 is an alternative to Steps 1a, 1b and 11 where Client RM Results may be pushed to Insurance company through 1-way diode communication channel.

An alternate configuration (the “UEM Polling Configuration”) for the RM, according to an embodiment is described with reference to FIG. 17C, with a close-up of the portion containing the UEM Polling Configuration is presented in FIG. 17D. The close-up provided in FIG. 17A is the same for both the UEM Push Configuration and the UEM Polling Configuration. In FIG. 17D Steps 7 and 7a differ from those in FIG. 17B as follows. In Step 7, on schedule, poll devices through QSR-Agents for information and update of data warehouses. In Step 7a QSR-Agent gets device information from QSR-Device and sends the data back to UEM and SIEM Data Warehouse.

According to embodiments, the QSR-Agent is either installed on a QSR-E managed or unmanaged end user device, or on a QSR-Adaptor. The QSR-Agent is the end-user device component responsible for gathering information about the device as requested by a UEM device policy 0that includes information requested within a risk management profile.

According to embodiments, the RM Data Warehouse comprises Client RM Profiles, which are created by the Insurance companies and they contain Parameters and Values, etc. The RM Data Warehouse comprises Client RM Results, which include the aggregated client profile data. The RM Web Insurance Portal App obtains the Client RM results.

There are two different pathways for how an Insurance company can engage with the QSR-E: one pathway (the “Partner Configuration”) is described with reference to steps 1a, 1b, and 11 (wherein the Insurance company communicates within the QSR-E to initiate obtaining a report). Another pathway (the “Diode Configuration”) is described for an alternative configuration with reference to step 12, whereby an Insurance company only receives a report, in response to an arrangement and/or request sent to the QSR-E (e.g., an email request. text request, phone call, etc, without communicating with the QSOC from within the QSR-E.

Within the Partner Configuration, there are two ways that an Insurance company can engage with the RM Secure Enclave within a QSOC. The insurance company can log into the RM Web App from a securely QSR-PN attached QSR-Device, such as a QSR-Book or QSR-Router, within the Q-RM Secure Enclave to manage client profiles (see step 1a). Alternatively, the Insurance company communicates automatically through the RM Web application programming interface (API) (see step 1b.). In some embodiments, this may occur or be available 24 hours a day, 7 days a week. The Client RM results are pulled out from the RM Web Insurance Portal App by the Insurance company.

The sequence of events described with reference to steps 1a, 1b, and 11 (the Partner Relationship) are as follows.
1a. The Insurance company logs into the RM Web Portal to manage Client Profiles or pull Client RM Results (on Request).
1b. Insurance company uses Automated API to manage Client Profiles or pull Client RM Results (on request).
2. The Web Insurance Portal updates the Client Profile.
3. On schedule, the RM Server pulls Client Profiles and updates the profiles within the QSR-E through the RM Profile Queue.
4. The RM Server publishes the updated Client Profiles to the UEM for processing.
5. The UEM consumes and processes the different Client RM Profiles.
6. The QSOC Administrator can push out policy updates on demand to QSR-Devices including but not limited to settings requested within Client RM profiles.
7. On schedule, based upon the device policy, the QSR-Agent gets device information from each QSR-Device that is associated with a device profile, inclusive of settings specified by the Client RM Profile, and sends the data back to the UEM for storage in the Data Warehouses.
7a. The QSR-Agent updates data in warehouses from devices, based upon the relevant device policy.
8. The aggregated Client RM Results are published to the RM Results Queue and stored in the RM Data Warehouse.
9. The RM Server saves the updated Client RM Results in the RM Data Warehouse.
10. The API pulls the latest Client RM Results.
11. The Insurance company pulls Client RM Results (on Request).

The Diode Configuration follows the same overall steps, except that as an alternative to 1a, 1b, and 11, Client RM Results may be pushed to Insurance Company through a 1-way diode communications channel.

The QSR-Book and user image in this figure, represents a single QSR-Device, but the QSR-Agent aggregates information across all QSR-Devices, QSR-Appliances, applications, services, and IAM user information as may be pertinent to the Client RM Profile. Information includes Data Classifications, including system information, device usage, applications and services installed and utilized, etc.

An alternate configuration (the “UEM Polling Configuration”) for the RM, according to an embodiment is described with reference to FIG. 17C, with a close-up of the portion containing the UEM Polling Configuration is presented in FIG. 17D. The close-up provided in FIG. 17A is the same for both the UEM Push Configuration and the UEM Polling Configuration.

The sequence of events described with reference to steps 1a, 1b, and 11 (the Partner Relationship) are as follows.
1a. The Insurance company logs into the RM Web Portal to manage Client Profiles or pull Client RM Results (on Request).
1b. Insurance company uses Automated API to manage Client Profiles or pull Client RM Results (on request).
2. The Web Insurance Portal updates the Client Profile.
3. On schedule, the RM Server pulls Client Profiles and updates the profiles within the QSR-E through the RM Profile Queue.
4. The RM Server publishes the updated Client Profiles to the UEM for processing.
5. The UEM consumes and processes the different Client RM Profiles.
6. The QSOC Administrator can push out device policy updates on demand to one or more selected QSR-Devices.
7a. The QSR-Agent updates data in warehouses from devices based upon device policy.
8. The aggregated Client RM Results are published to the RM Results Queue and stored in the RM Data Warehouse.
9. The RM Server saves the updated Client RM Results in the RM Data Warehouse.
10. The API pulls the latest Client RM Results.
11. The Insurance company pulls Client RM Results (on Request).

The Diode Configuration follows the same overall steps, except that as an alternative to 1a, 1b, and 11, Client RM Results may be pushed to Insurance Company through a 1-way diode communications channel.

The QSR-Book and user image in this figure, represents a single QSR-Device, but the QSR-Agent aggregates information across all QSR-Devices and QSR-Appliances. Information includes Data Classifications, including system information, device usage, applications and services installed and utilized, etc.

According to embodiments, one or more of the above actions or systems may be enhanced through the use of artificial intelligence. For example, this can be configured as an artificial neural network which models complex relationships between inputs and outputs and find patterns in data. As another example, deep learning may be used wherein deep learning uses several layers of neurons between the network's inputs and outputs. The multiple layers can progressively extract higher-level features from the raw input. A worker skilled in the art would readily understand where and how to implement artificial intelligence into the instant technology.

FIG. 31 is a block diagram illustrating how an enterprise administrator can manage an enterprise QSR-E, including the ability to get enterprise risk management information, according to embodiments. FIG. 31 shows how the QSR-Risk Management (RM) component of the solution can be accessed to configure policies used to filter and partition a tenant's data for sharing with a potential insurance company, or other external organization such as a regulatory body (government and professional regulators), industry partner, service provider, research institute, certification organization, institutional lender, and legal authorities.

According to embodiments, using a QSR-Device a QSR-PN is established to a QSOC. The correct credentials are provided and verified to authenticate and authorize the user. This can include multi factor authentication (MFA) using devices/methods such as Yubikey, challenge and response, amongst many others. Once a QSR-PN is established the user navigates to the RM functionality through the Enterprise Management web application. The user's request is also checked against the rules defined within the Policy Orchestration (PO) module to ensure that it is allowed and if valid then the user is directed to the RM module within EM. Each request the user makes is validated against the rules defined within PO. Only valid requests are actioned. A user can subsequently access the RM functionality to establish the policies to be enforced for the sharing of information with an external organization, such as an insurance company. These policies can be used to filter and partition the data about the components the user has chosen to share. A user will also be able to select which insurance company(s) will be able to have access to which information based on the configured policies.

FIG. 32 is a block diagram illustrating how an enterprise administrator can manage an enterprise QSR-E, including the ability to obtain enterprise risk management information and enable the ability for an insurance company to receive risk reports about the QSOC and QSR-E, according to embodiments. FIG. 32 illustrates how the Risk Management component can be accessed by an insurance company representative. Using a QSR-Device a QSR-PN is established to a QSOC. The correct credentials are provided and verified to authenticate and authorize the user. This can include MFA using devices/methods such as Yubikey, challenge and response, amongst many others. Once a QSR-PN is established the user navigates to the RM functionality through the Enterprise Management web application. The user's request can also checked against the rules defined within Policy Orchestration (PO) to ensure that the user is allowed access and if valid then the user is directed to the RM module within EM. Each request the user makes is validated against the rules defined within PO. Only valid requests are allowed. An insurance company representative will have access to the information housed within the QSOC based on the policies configured by their client, in the RM module. The configured policies will limit access based upon the client(s) they represent, which could be all devices/applications or a subset. The RM Web Insurance App will allow the insurance representative) with the correct permissions to select information derived from the policies setup by their client, as a report/data dump and have it sent to them across the QSR-PN via the RM Web API. This API allows a one-way data push to be generated and sent through the QSR-Diode. In some embodiments, this data transfer can be initiated on an ad hoc bases, when relevant data changes are to be transmitted or the data transfer can be through a scheduled event.

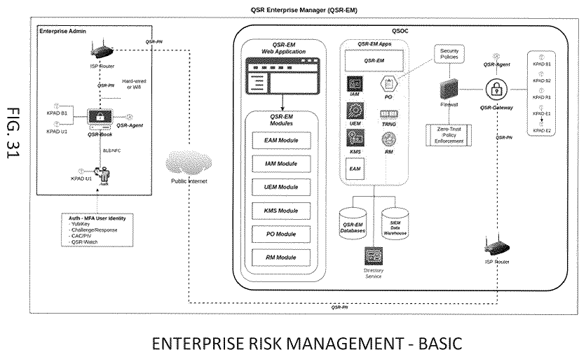

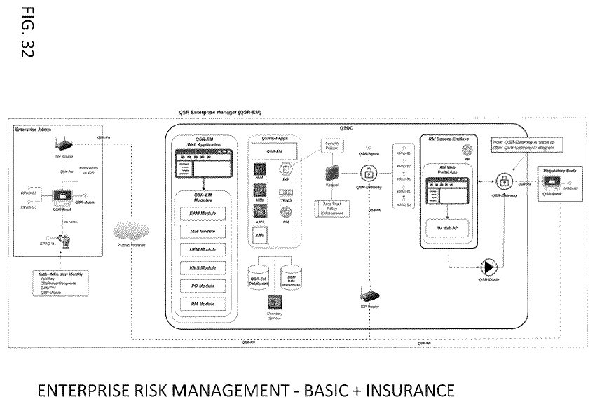

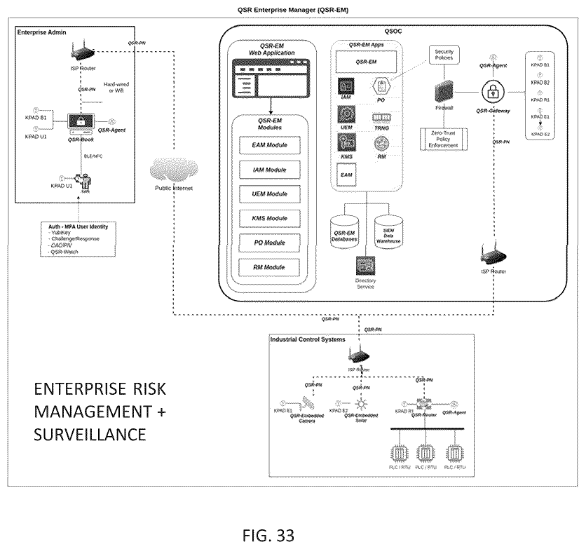

FIG. 33 is a block diagram illustrating how an enterprise administrator can manage an enterprise QSR-E including surveillance and providing the ability to obtain enterprise risk management information, according to embodiments. FIG. 33 shows how different devices forming part of the industrial control systems of an enterprise, can be connected to a QSR-PN and have the information made available within the RM module. The basic system configuration and process are the same as in FIG. 31, where the policies are built by the owner of the devices and specific external organizations, such as insurance company(s) are enabled to access the information. It is understood that the industrial control systems of multiple enterprises including partnered or cooperating enterprises carrying out business together (e.g., as a joint venture) can also be configured to share and exchange information from their industrial control systems and enterprise administration using the same QSOC, via additional QSR-PNs.

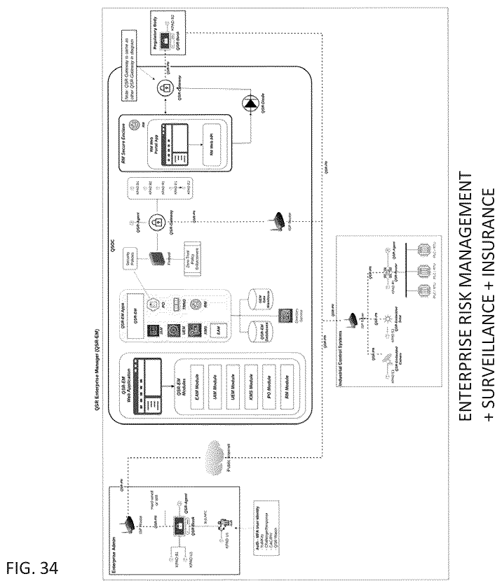

FIG. 34 is a block diagram illustrating how an enterprise administrator can manage an enterprise QSR-E including surveillance and providing the ability to obtain enterprise risk management information and additionally providing the ability for an insurance company to receive risk reports about the QSOC and QSR-E, according to embodiments. FIG. 34 shows how industrial control systems can be connected to a QSR-PN and have the information made available within the RM module. The basic system configuration and process are the same as in FIG. 32 where the external organization is an insurance company. The insurance company representative can access the system and select data from the client allowed set of information and then have the data transmitted to them by the RM Web API on an ad hoc or scheduled basis.

### Regulatory Body

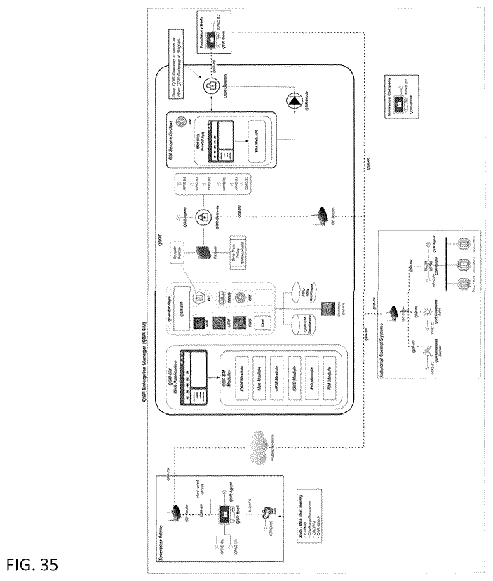

With reference to FIGS. 35-37, in addition to insurance companies, external reporting functions relating to assessing risk and compliance may be required by various regulatory bodies. Many regulatory bodies carry out different levels of oversight in different contexts and these functions will tend to be partitioned within the regulatory bodies and determine who within the organization has a need to know the information that would be pushed from the reporting organization. For example, health agencies may have drug and device approval, monitoring and investigative functions that require different types of reporting to go to different responsible groups within the regulatory body; and then from that body to other government legal authorities for further investigation as the case may be. Exemplary regulatory bodies that may require secure and sensitive information reports to different groups within their infrastructure. Exemplary regulatory bodies may include government ministries, departments, agencies, centres, commissions, boards, and non-governmental organizations established to manage self-governing professional groups, such as societies, colleges, and councils (not for profit entities). More specific examples may include health and disease control agencies, security commissions, privacy commissions, food inspection agencies, environmental protection agencies, law societies, immigration, border control and trade authorities, and other legal authorities.

FIG. 35 is a block diagram illustrating how an enterprise administrator can manage an enterprise QSR-E including surveillance and including the ability to obtain enterprise risk management information and additionally providing the ability for a regulator to receive risk reports about the QSOC and QSR-E, according to embodiments. It is noted that FIG. 35 is similar to FIG. 33), as it illustrates a system configuration ad process of the present disclosure for an enterprise with industrial control systems. The policies are built by the owner of the devices and other external organizations, and in addition to insurance companies, other external organizations can be enabled to access the information, including one or more regulatory bodies. For example, different levels of government may exercise regulatory jurisdiction over the business of the enterprise, e.g., commercial crop producers, mining operations and providers of hydro-electric power. To grant access to a regulatory body as shown in FIG. 35, the configuration and process of FIG. 31 can be implemented where the policies are built by the owner of the devices and multiple external organizations, including an insurance company, one or more regulator bodies and service provider(s), are enabled to access information partitioned for each to access. For example, in the case of a pharmaceutical company, clinical trials might be monitored by the responsible health and safety government regulatory body, while an insurance company might need to evaluate the security of the pharmaceutical company's patient information handling practices. Similarly, a mining company may need to interact with an array of regulatory bodies with respective oversight for environmental regulatory compliance and the transportation of dangerous goods.

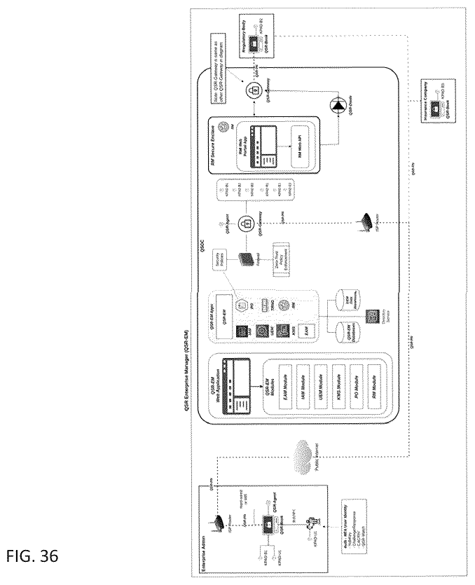

FIG. 36 is a block diagram illustrating how an enterprise administrator can manage an enterprise QSR-E and including the ability to obtain enterprise risk management information and additionally providing the ability for a regulator to receive risk reports about the QSOC and QSR-E, according to embodiments. It is noted that FIG. 36 is similar to FIG. 32 as it illustrates a system configuration and process that allows multiple external organizations, such as an insurance provider and regulatory body to access respectively partitioned enterprise information as established by the enterprise.

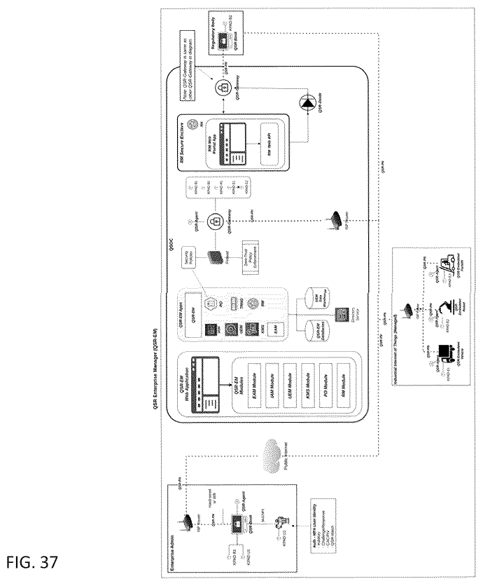

FIG. 37 is a block diagram illustrating how an enterprise administrator can manage an enterprise QSR-E including managed industrial internet of things (IIoT) devices configured as embedded devices that include customized QSR-Agents with customized parameter settings and metrics, and including providing the ability to obtain enterprise risk management information and additionally providing the ability for a regulator to receive risk reports about the QSOC and QSR-E, according to embodiments.

FIG. 37 shows how different devices from an industrially managed internet of things (IoT) for an enterprise can be connected to a QSR-PN and have the information made available within the RM module. The basic system configuration and process is the same as in FIG. 31 and FIG. 32, where clients can set up policies on what data to share with a regulatory body and/or an insurance company(s) and those external organizations can then have the data transmitted to them in a one-way data feed.

### Uses

According to embodiments, uses for the systems and processes (including components thereof) are generally for the purposes of securing digital network environments against cyber security and related privacy risks and for providing solutions to organizations to mitigate risks with access to insurance products based on predictable risk assessments.

According to embodiments, there can be unlimited business use cases that can leverage the QSR-E to secure their computing infrastructures and devices. Two possible use cases are: Supervisory Control and Data Acquisition (SCADA) and Banking Offices, however it is readily understood that a system according to embodiments, is not limited to these two cases. These two use cases are to be merely considered as exemplary.

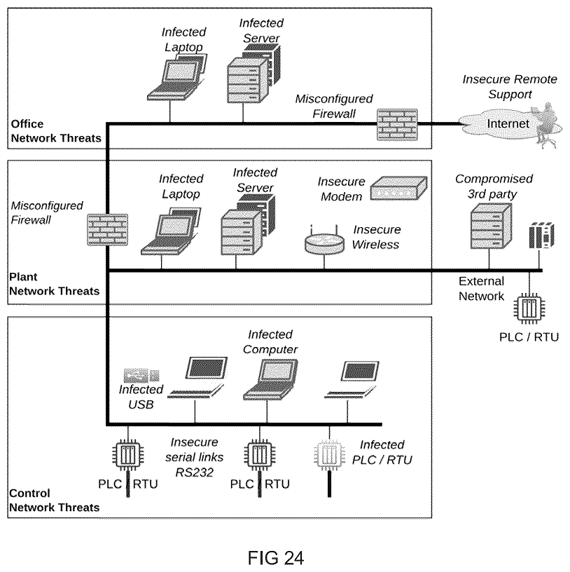

According to embodiments, a primary use case for a system according to embodiments, is for securing Supervisory Control and Data Acquisition (SCADA) sites (substations), systems, and devices utilized to monitor industrial facilities such as factory, plant operations, traffic lights, and other Programmable Logic Controller (PLC), Programmable Automation Controllers (PAC), and Remote Terminal Unit (RTU) devices. These devices are used in industrial processes and are part of a nation's industrial and manufacturing infrastructure. SCADA devices are monitored from server control and monitor systems and remote sites. Research from the Ponemon Institute states that “70 percent of companies responsible for the world's water, power and other critical functions reported at least one security breach that led to the loss of confidential information or disruption of operations in the last 12 months.” The diagram presented in FIG. 24 presents the many attack vectors upon SCADA infrastructures that QSR-PN can protect against.

According to embodiments, one of the primary issues with SCADA systems is caused by open systems and access to external networks that open the site to attacks from malicious actors. QSR-PN solutions create cryptographically closed systems that secure SCADA devices within the QSR-E.

According to embodiments, another use case for this solution is securing bank teller systems, automatic teller systems (ATMs), SWIFT terminals and Bloomberg terminals. These systems are commonly built on desktop computer technologies that utilize PKI-based VPN services to communicate over public networks. By using these solutions banks are increasingly at risk from many attack vectors. Rather than adding complex security solutions, using a QSR-PN according to embodiments, can transform these desktop computers into essentially dumb terminals that run their applications on virtualized servers within a QSR-E (i.e. instead of trying to defend against attack vectors that these terminals are exposed to, and essentially eliminating these threats entirely by converting these terminals into QSR-Devices).

One embodiment for a use of the system is for a business to provide cyber-security technology, either as a security technology vendor, as a managed security service provider, or some combination thereof. In one embodiment, such a business could describe and promote their business and technology as: “Company ABC offers unique and disruptive technologies. We provide inviolable solutions that shield, protect, and safeguard sensitive communications, critical infrastructure and data assets, today and into the Quantum era. Company ABC provides impermeable protections and safeguards against cyber threats using a unique secure-by-design NIST Zero Trust ecosystem. We are ready for Q-Day.”

### Cyber Threat

At the current time, the cyber security community is struggling to protect their clients. Conventional solutions are being overwhelmed by the rising number of cyber threats and many organizations are left scrambling to safeguard sensitive data from being accessed by bad actors once harvested.

Data privacy regulations and rising financial costs from breaches make it harder to obtain cyber insurance. Data breaches also cause losses in public trust and confidence long after the attack itself.

Quantum computing promises to revolutionize fields like medical research and traffic optimization, but it's also the greatest emerging cyber threat. That's because Q-Day isn't just a prediction, we expect that quantum computers will render conventional encryption obsolete within five years. This will allow bad actors to break into encrypted files in seconds and will grant them access to the billions of sensitive records already harvested.

### Company ABC Solution

The Company ABC solution is built for today and the quantum era. It is a secure-by-design, NIST Zero Trust architecture, providing impenetrable communication and access to applications and data assets, including a secure layer for application services. This greenfield implementation can be achieved through a comprehensive and integrated security management suite, quantum secure/resistant technologies, enabling sensitive communications, and hardened, managed endpoint devices.

### Three Core Pillars

According to embodiments, there are three pillars, namely a Security Management Suite, Quantum Secure/Resistant Communications and Secure Managed Endpoint Devices.

According to embodiments, security management suite can provide, a secure-by-design, NIST Zero Trust solution, eliminating attack vectors; comprehensive policies and controls to safeguard equipment, access, and identity management and scalable, out of the box capability enabling rapid integration into existing IT infrastructure.

According to embodiments, Quantum Secure/Resistant Communications can provide locked down a quantum secure/resistant access to enterprise infrastructure only from secure trusted end point devices, provide security to sensitive communications with quantum secure/resistant technologies leveraging One-Time Pad (OTP) methodologies, wherein OTP is currently the only proven encryption impermeable to quantum computing.

According to embodiments, Secure Managed Endpoint Device can ensure data residue does not remain on secured remote devices; the use of a NIST Zero Trust Policy Enforcement Point can restrict access; and the use of remotely managed hardened devices using multi factor authentication and encryption.

In this embodiment, the Security Management Suite comprises a secure-by-design, NIST Zero Trust solution, eliminating attack vectors. By integrating a number of classes of internet security solutions, such as anti-virus software, threat-detection software, etc., with policy management orchestration software, designed to meet the needs of the NIST Zero Trust paradigm, in addition to the VPN components, the security aspects of this system have been designed in a manner to prevent (via VPN and antivirus software), monitor via threat-detection and policy management orchestration solutions and respond to any attacks in a manner that meets the NIST Zero Trust paradigm requirements & standards.

In this embodiment, the Security Management Suite comprises comprehensive policies and controls to safeguard equipment, access, and identity management. In order to provide a system that can be used to generate a multi-enterprise ecosystem, the policy management orchestrator can be designed to be able to accommodate the policies of different organizations, and/or branch offices of multinational organizations that might be located in diverse countries such as Japan, Germany, England, USA, etc. The system will be designed with a policy translation service which will enable not only the language translation aspects, but also the respective interpretations of those policies which might vary from country and culture to country and culture.

In one embodiment, a centralized policy management orchestration node is provided in a manner that is analogous to a Federated Identity Management Provider, as a centralized location where a set of recommended policies can be provided, selected, added to and perhaps a concurrence of security policies evolved and/or determined.

In this embodiment, the Security Management Suite comprises scalable, out of the box capability enabling rapid integration into existing IT infrastructure. For example, the architecture of the security software can be designed such that it comprises a number of modules, hosting the latest best-in-class security software for each class of software. Examples of classes of security software include, but are not limited to antivirus software, threat detection software, and policy management orchestration software.

In some embodiments, the system comprising the best-in-class software included within each module can be provided in a top-shelf out of the box solution. The system, however, can be designed such that if a customer prefers to use a different software solution for a class of security software, they can swap out the best-in-class software and use the software that they prefer to use in their system. This design feature to the security software aspect of the system enables rapid integration into existing IT infrastructure.

In this embodiment, the Quantum secure/resistant Communications comprises locked down quantum secure/resistant access to enterprise infrastructure only from secure trusted end point devices. This aspect of the system not only describes the security features of a secure system (i.e., secure end-point devices), but also emphasizes the state-of-the art identity management capabilities of the system (i.e., trusted end point devices), which includes the identity of the users of these devices.

In this embodiment, the Quantum Secure Communications comprises sensitive communications are secured with quantum secure technologies leveraging One-Time Pad (OTP) methodologies. There are a number of ways that OTP technologies can be used within the system according to embodiments. For example, they can be used in a more conservative manner to only be used to securely exchange non-OTP encryption keys between users and their end-point devices. They can be used to secure data-at-rest. They can be used to secure data-in-flight. The flexibility of the design of this system is such that it supports the ability to be able to leverage OTP methodologies where they are appropriate and efficient.

In this embodiment, the Quantum Secure Communications comprises OTP is the only proven encryption impermeable to quantum computing. As described in the paragraph above, the system is designed with flexibility to deploy OTP where it is deemed to be required, given the context of the system and the cyberspace and regulatory environment.

In this embodiment, the Secure Managed Endpoint Devices comprise ensuring no data residue remains on secured remote devices. In this embodiment, the system includes devices designed to be used by remote users of the system, which are primarily configured to be secure (e.g., hardened), and to connect to a remote desktop located in the QSOC, and/or the Enterprise head office or regional office. For example, this design eliminates the risk of a remote worker who might be travelling such as a sales representative or someone attending a conference, losing their laptop and the risk of whoever attains it getting access to company information. Because of the identity access management and the multi-factor authentication aspects of the security system, in addition to the design of the remote device simply being an access point to the system, not only will no data residue remain on the device, but it can be considered a “secured remote device” even if it falls into the hands of a “bad actor.”

In this embodiment, the Secure Managed Endpoint Devices comprises the feature that the NIST Zero Trust Policy Enforcement Point restricts access. This security design of the system not only leverages the policy management orchestration aspects of the system (e.g., who gets access to what information within the system and/or who gets to browse which internet sites on the internet in a manner related to their position at the organization), but elevates it with the combination of the design of the identity access management and the multi-factor authentication aspects of the security system. For example, it may be relevant to an individual's position within the organization to be able to freely conduct research on the internet. For an individual working in a finance department, for example, it may be deemed not part of their job description, so they won't be provided access to the sites on the internet, which fall outside of the usual tasks of their job description.

In this embodiment, the Secure Managed Endpoint Devices comprises remotely managed hardened devices using multi factor authentication and encryption. As described above, the identity access management and the multi-factor authentication aspects of the security system, in addition to the design of the remote device simply providing an access point to the remove user's virtual desktop within the system, not only will no data residue remain on the device, but it can be considered a “secured remote device” even if it falls into the hands of a “bad actor.” The hardened devices aspect refers to the manner that the remote devices will be hardened to remove all possible “ports of entry” for cyber-attack.

### System Configurations

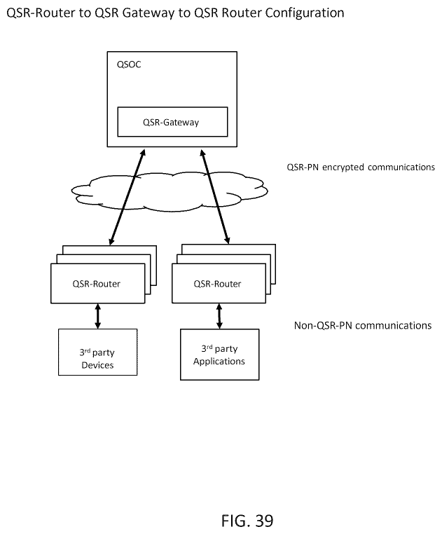

FIG. 39 is a block diagram depicting QSR-Router to QSR-Gateway to QSR-Router Configuration, according to embodiments. This configuration can be considered to be flexible with multiple applications. QSR-Routers can be incrementally deployed securing individual links one-by-one. According to embodiments, below are a plurality of potential applications of this configuration, including QSR-PN QSR Router applications and QSR router connectivity application.

### QSR-PN QSR-Router Applications

### Industrial Control System Applications (SCADA Systems)

Power Plants/Electric Grid
Chemical Plants/Refineries
Water & Pipeline Systems

### Enterprise Applications

Branch to Head office
Work from home employees
Remote worker

### Mobile Applications

Mobile Employee (various enterprise locations where a Q Router deployed)
   Employee traveling to different corporate locations
   Employee accessing SCADA applications over SCADA network
      University campus and inter University for research and collaboration

### QSR-Router Connectivity

### 3^{rd} Party Devices:

SCADA Remote Terminal Units
Laptops, Tablets, etc.,
LAN & Edge Routers.
Home Router/Home Gateway
WiFi router

### 3^{rd} Party Applications:

SCADA Control Center/Remote Terminal Units applications
Remote Office LAN interconnect to Head office LAN
   applications and data access
Remote employee accessing corporate applications & data
   productivity applications, financial systems, HR systems

According to embodiments, this configuration can be sold to MSPs, Telcos, and Enterprises for their independent operation. In addition, this configuration can be operated as a service by a service provider with a QSOC supporting the identified applications.

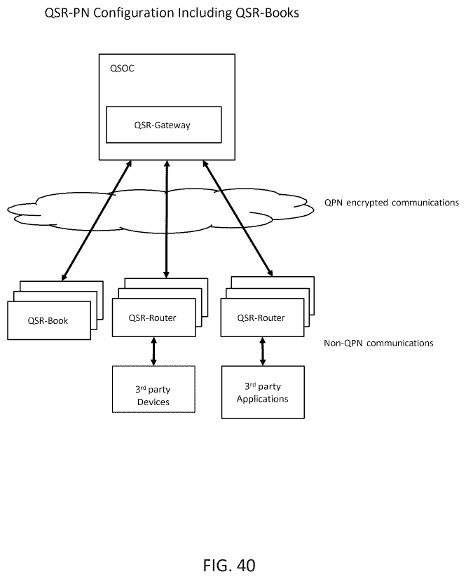

FIG. 40 is a block diagram depicting QSR-PN Configuration including QSR-Books, according to embodiments.

### QSR-Book Applications

QSR-Book Browser or Remote Desktop into 3^{rd} Party Applications
Industrial Control System operating center
Enterprise remote access applications & files

### QSR-Book Connectivity

### QSR-Book Connectivity to Network Devices

Wireless connection to local router
Ethernet wired connection to local router

### Applications

Enterprise application connectivity via various browser and remote desktop applications as required (legacy systems)
   General RDP access, Citrix etc.
ICS Control Center applications
Enterprise applications
   Proprietary/custom applications
   Productivity Applications (e.g., MS Office, NextCloud, FileFlex)
   CRM/ERP/Finance/HR systems
File storage/Database access

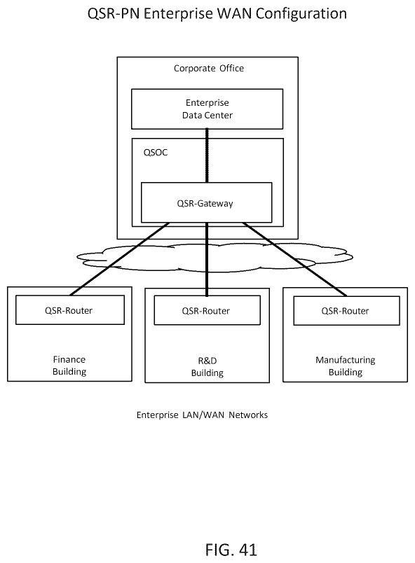

FIG. 41 is a block diagram of QSR-PN Enterprise WAN Configuration according to embodiments. The configuration can enable the securing of communications between buildings/sites/organizations, Medium/Large Businesses & Governments (for example multiple large locations, Fortune 100 companies and can be scalable for global coverage.

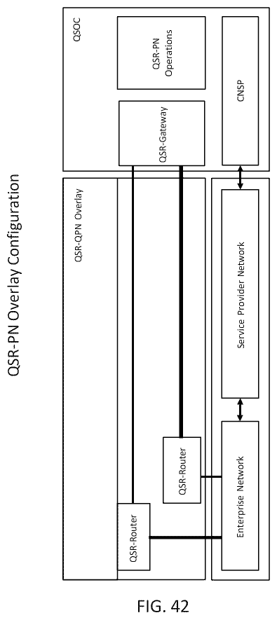

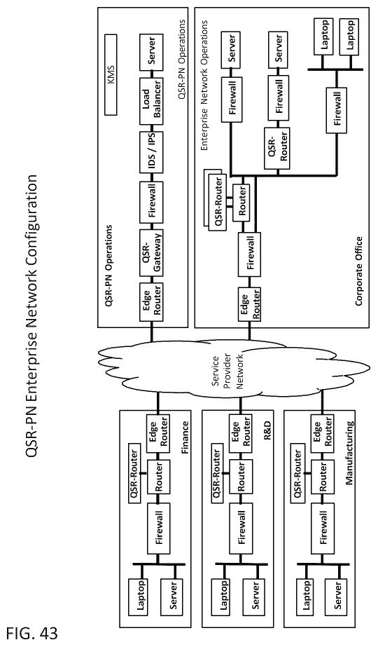

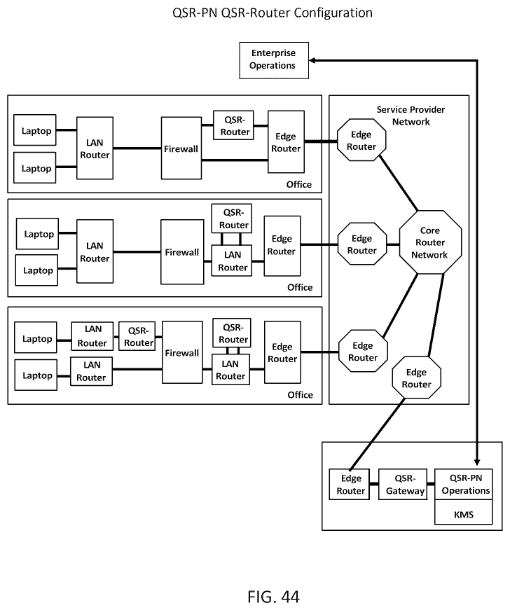

FIG. 42 is a block diagram of a QSR-PN Overlay Configuration, according to embodiments. This represents the overlay separation between the Enterprise Network and the QSR-PN logical overlay. More details of the QSR-PN overlay configuration are presented in FIG. 43 and FIG. 44.

FIG. 43 is a block diagram of a more detailed representation of a possible configuration for FIG. 42, according to embodiments. Enterprise networks can have complex networks wherein the following may be included in considerations:
Selected high value traffic, sensitive traffic will be routed by the enterprise network to the QSR-Router
QSR-PN device portfolio supports various capacities and environmental/reliability hardened products
High availability for the QSR-Router and QSR-Gateway is achievable by load shared or N+1 units architecture and/or internally redundant QSR-Router/QSR-Gateway hardware
QSR-PN can be configured so there is no single point of failure
QSR-PN and Enterprise Network Operations share information ensuring network security, performance and integrity

According to embodiments, this configuration can be either a service provider operating the QSOC or an Enterprise purchasing the QSOC and running it independent of the corporate IT operations and infrastructure. The QSR-PN is designed to support flexible deployment and ownership/service provider models.

FIG. 44 is a block diagram depicting a QSR-PN QSR-Router Configuration, according to embodiments. The QSR-PN is a flexible, high reliability, quantum-secure/resistant communications between QSR-PN devices. According to embodiments, considerations or functionality of this configuration can include:
QSR-PN devices send traffic to other QSR-PN devices determined by the packets address and header information
QSR-Router and QSR-Gateway can be deployed in multiple locations within the enterprise network
Enterprise network could determine which traffic is to be carried over the SPN
QSR-Router deployment inline or as a one-arm adjunct to enterprise network device
A location can have one or multiple QSR-PN devices enabling the securing of the location and/or a specific resource.
The QSR-PN devices connect to Enterprise network equipment via a networking interface such as ethernet
QSR-PN is scalable across many different locations and wider geographic coverage.
Capacity can be scaled by adding more or higher capacity QSR-PN devices at a location.
QSR-PN Operations monitors the health and performance as well as providing assurance the QSR-PN is performing as expected.

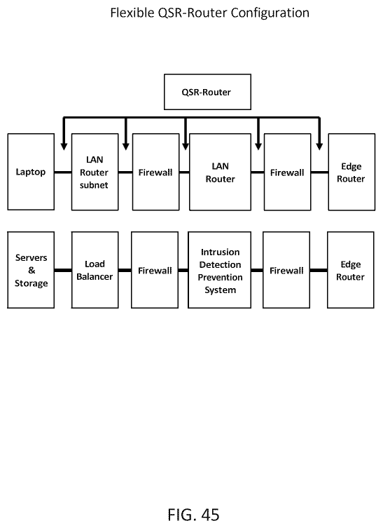

FIG. 45 is a block diagram depicting a Flexible QSR-Router Configuration, according to embodiments. The QSR-Router flexible deployment enables optimum placement, near network edge placement for broad internal coverage, near resource placement for more security and can be optimally placed into network security stack.

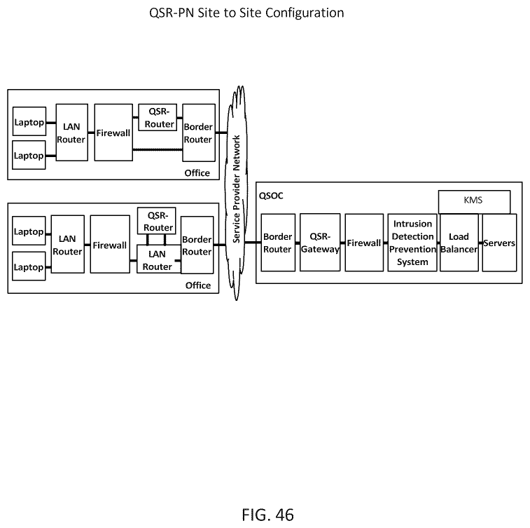

FIG. 46 is a block diagram depicting QSR-PN Site to Site Configuration, according to embodiments. The QSR-Routers can be deployed in line or as a one arm to a LAN router. According to embodiments, this configuration can be considered to be a typical configuration for a service provider providing secure communications between two offices. Service providers from small MSPs to large telco's (Bell Canada, Verizon), cable companies (Xfinity, Rogers) etc. fit into this model. The scale and geographic coverage of service providers would have hundreds or thousands of QSR-PN QSR-Routers deployed in different offices/locations.

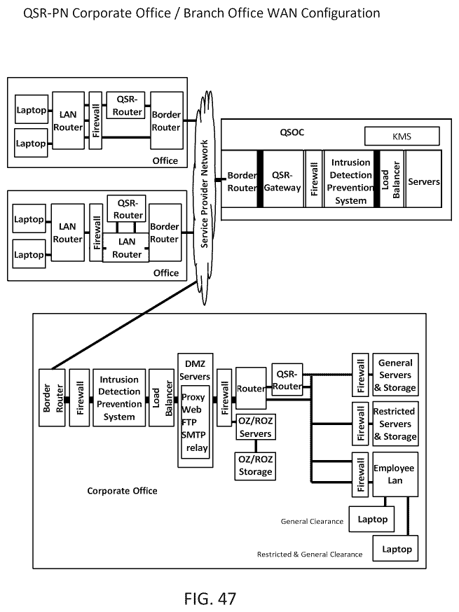

FIG. 47 is a block diagram depicting a QSR-PN Corporate Office/Branch Office WAN Configuration, according to embodiments. Deployment of the QSR-Router into the IT network security stack has many possibilities, one of which is to place it after the IT Network Security. This is also a likely service provider deployment. It shows branch offices connected to a corporate office via a QSR-PN provided by a service provider (MSP, Telco, Cable companies).

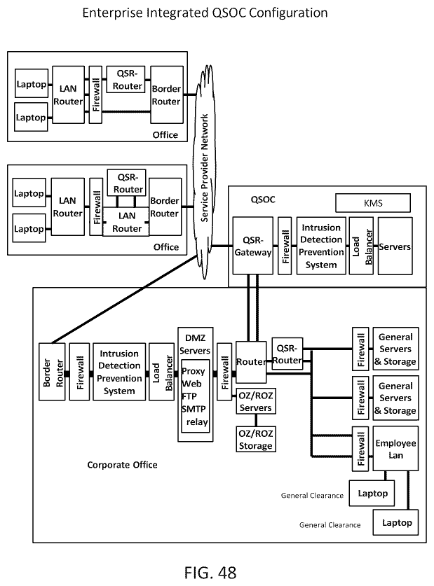

FIG. 48 is a block diagram depicting an Enterprise Integrated QSOC Configuration, according to embodiments. This integration simplifies Enterprise operations and enables a QSOC to be deployed in the Enterprise data center. This would be a common deployment for customers buying their own QSOC's for their Enterprise Network. This is a representation of an Enterprise deploying a QSOC into their own IT infrastructure. The QSOC will most likely be owned by the Enterprise and integrated into the Enterprises' operations enabling complete control. The QSOC is integrated directly into the Enterprise network providing QSR-PN connectivity to the branch offices and corporate office.

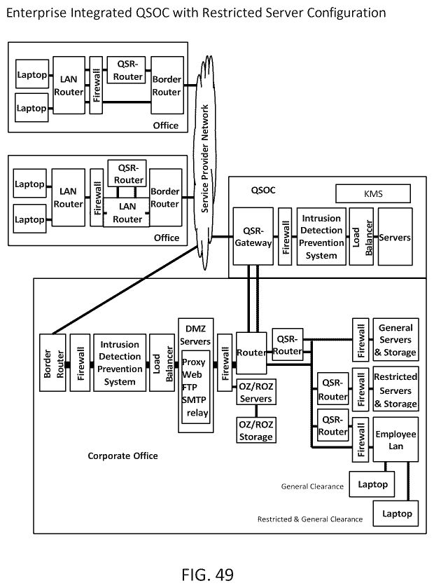

FIG. 49 is a block diagram of an Enterprise Integrated QSOC with Restricted Server Configuration, according to embodiments. The QSR-PN is deployed internal to the Corporate Office Enterprise LAN, wherein Corporate Office Employee LAN users require QSR-PN access to Restricted Servers & Storage. The QSR-PN is deployed securing access to restricted Servers & Storage from either external access or internal access. A QSR-Router is deployed in the LAN providing QSR-PN access to internal employees. This representation shows when an Enterprise owns its QSOC it can easily deploy QSR-PN QSR-Routers internally securing restricted servers and storage under their control.

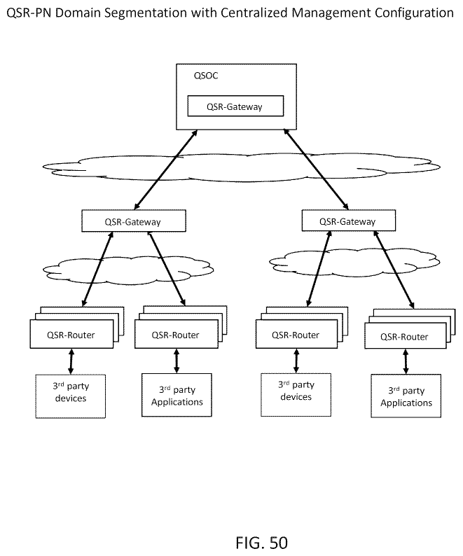

FIG. 50 is a block diagram depicting QSR-PN Domain Segmentation with Centralized Management Configuration, according to embodiments. Considerations or functionality of this configuration can include:

### Domain Segmentation Applications

Contain traffic within scoped domains, such as
   different industrial plants with centralized QSOC management
      a coal power plant segmented from a nuclear power plant
      power plants segmented from the transmission network
   Enterprise locations containing sensitive information
      Corporate finance/M&A
      Government intelligence, military, etc., information containment
Centralized management of segmented QSR-PNs
Removes the management of the segmented QPN and devices from the domain operations
   Enabling focus on domain's operational management and controls.
Cross domain communication is enabled by the QSOC QSR-Gateway

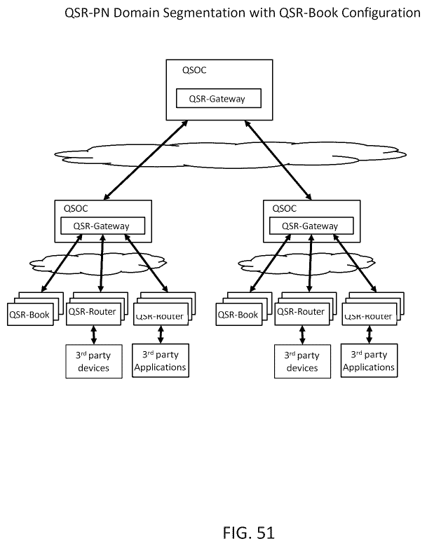

FIG. 51 is a block diagram depicting QSR-PN Domain Segmentation with QSR-Book Configuration, according to embodiments. Considerations or functionality of this configuration can include:

### Q Book Domain Segment Access

Q Book has remote desktop or browser access to domains applications
Restrictions can be enforced to limit access to other domains
A device can be limited to just one or multiple QPN segments via
   Different KPADs for different domain segments
   QD Device Management policies and controls
   QPN configuration, policies and controls
Application identity management and access restrictions would be controlled by the 3^{rd} party applications
   i.e., coal power plant maintenance personnel could not access nuclear power plant systems

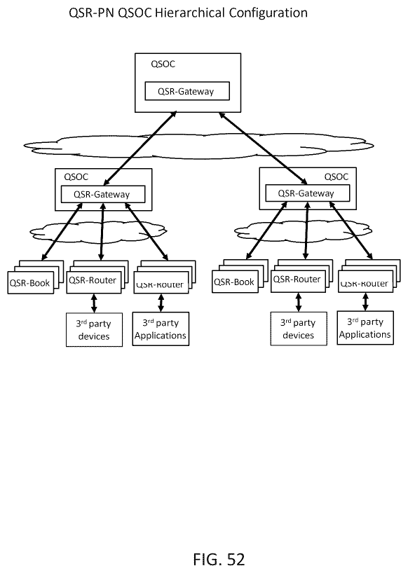

FIG. 52 is a block diagram depicting a QSR-PN QSOC Hierarchical Configuration, according to embodiments. Independent QSOCs deployed in a region (city, province, state) or a specific domain (electrical grid, power plants). Considerations or functionality of this configuration can include:
QSR-Router deployments, management, and operations maintained by the sub QSOC
Cross region or domain communications through a hierarchical hub
Hierarchical hub easy to expand with each additional QSOC just requiring a single link to the hub
Sub QSOC to hub QSOC a QSR-Gateway to QSR-Gateway connection
Interdomain hub KPAD keys distributed to sub QSOCs by hub QSOC
Sub QSOC K-Pad key generation and distribution can be from hub QSOC or locally at the sub QSOC

### Applications

Contain traffic within scoped domains,
Different industrial/manufacturing plants
a coal power plant segmented from a nuclear power plant
power plants segmented from the transmission network
automotive assembly plants segmented from corporate network

Enterprise locations containing sensitive information
Multi-national companies with operations in different countries
Corporate finance/M&A
Government intelligence, military, etc., information containment

Sovereign states
Maintain sensitive information within borders

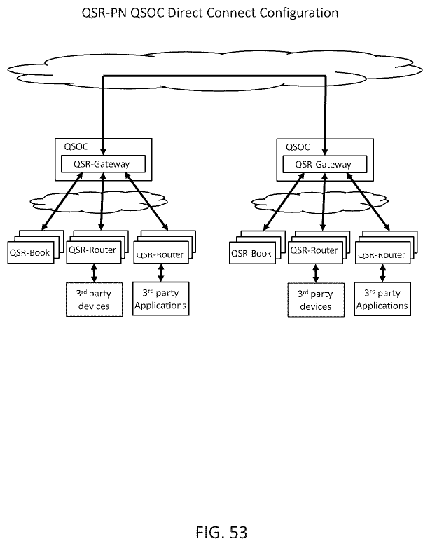

FIG. 53 is a block diagram depicting a QSR-PN QSOC Direct Connect Configuration, according to embodiments. Sub QSOCs are linked directly together through Q Gateway. Considerations or functionality of this configuration can include:
Provides efficient link for high volume traffic, eliminating hub QSOC.
Each QSOC coordinate directly with each other ensuring matching key pairs deployed on connecting links
Enables ad hoc domain interconnect without centralized management

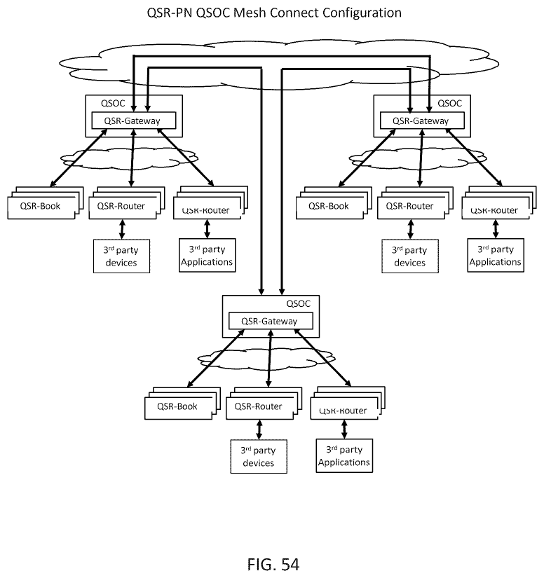

FIG. 54 is a block diagram depicting a QSR-PN QSOC Mesh Connect Configuration, according to embodiments. Considerations or functionality of this configuration can include:
Multiple QSOCs can be directly connected with dedicated links
Very efficient for high-capacity links.
Initially easily expandable but can become unwieldly when mesh becomes too large
QSOCs coordinate directly with each other ensuring matching key pairs deployed on connecting links

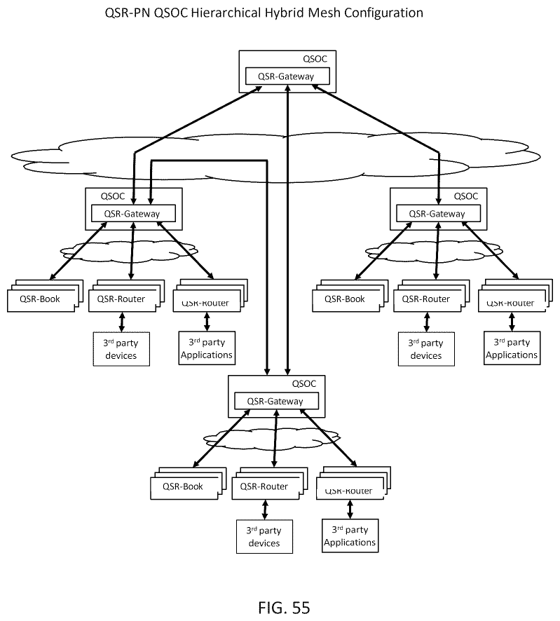

FIG. 55 is a block diagram depicting a QSR-PN QSOC Hierarchical Hybrid Mesh Configuration, according to embodiments. Considerations or functionality of this configuration can include:

### Ownership/Business Models

There are multiple ownership models for the hierarchical, mesh, and hybrid deployment scenarios
Each different domain can be owned/run by the same company including the hub
   Power plants connected to the hub.
   Transmission and corporate domains have a direct connection
   Multi-national companies with domains in various countries
Each different domain can be owned/run by different companies
   Sovereign nations each have a domain, connected through a 3^{rd} party operated hub.
Mix and match of the above with companies owning some but not all domains

### Hybrid Hub and Mesh Interconnect

Direct domain interconnect for high capacity/utilization links
Direct links more secure & reliable than adding a hub into the path
Hub QSOC connects domains with more disperse traffic patterns not justifying direct interconnections

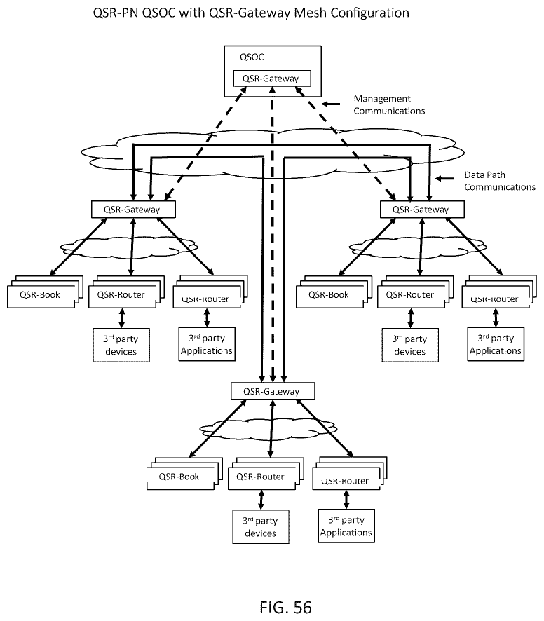

FIG. 56 is a block diagram illustrating a QSR-PN QSOC including a QSR-gateway mesh configuration, according to embodiments. This configuration can provide centralized management of QSR-Gateways directly interconnected enabling localized network performance and security optimizations. Centralized management can enable pooling of security resources, offloading of security operations from the local domains, and cost sharing of QSOC operations. According to embodiments, individual domain traffic engineering can be optimized for network efficiencies, performance, and security.

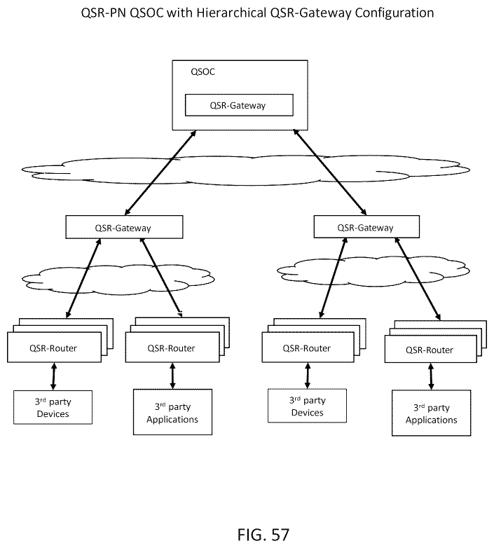

FIG. 57 is a block diagram depicting a QSR-PN QSOC with Hierarchical QSR-Gateway Configuration, according to embodiments. In this configuration, QSR-Gateways are deployed to optimize secure communications and network efficiency (bandwidth, latency, etc.), Gateways are deployed to optimize secure communications and network efficiency (bandwidth, latency, etc.). Considerations or functionality of this configuration can include:
Gateways have secure communications to QSOC for monitoring and management functions
Data plane communications contained between QSR-Devices (QSR-Book, QSR-Router, QSR-Gateway) with Control plane functions directed to the QSOC.

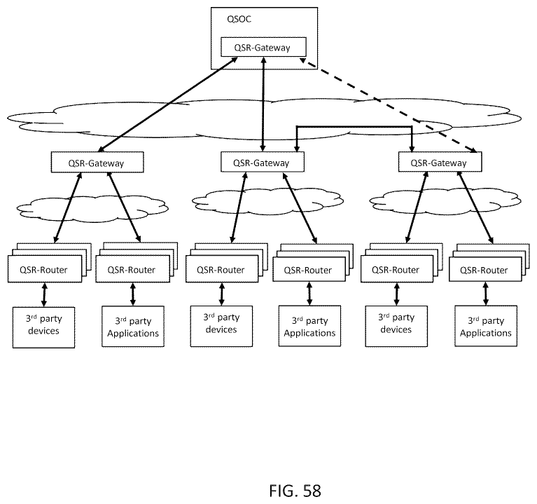

FIG. 58 is a block diagram depicting a QSR-PN QSOC with Hybrid QSR-Gateway Hierarchical and Mesh Configuration, according to embodiments. In this configuration a central QSOC provides a hierarchical configuration between two QSR-Gateways and a mesh QSR-Gateway,

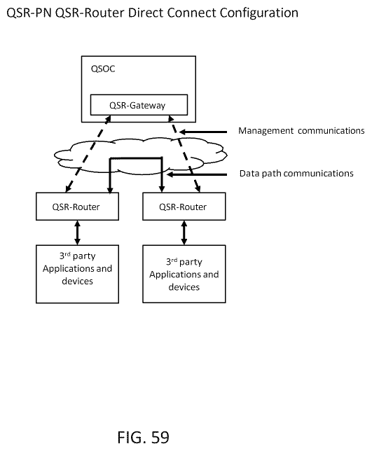

FIG. 59 is a block diagram depicting a QSR-PN QSR-Router Direct Connect Configuration, according to embodiments. The QSR-Router to QSR-Router configuration provides for secure point to point connections. Considerations or functionality of this configuration can include:
Each router has a connection to the QSOC for management and monitoring communications.
QSR-Router to QSR-Router direct connection for data path communications

### Applications

Building to Building connectivity
High capacity links point to point but not required for general connectivity

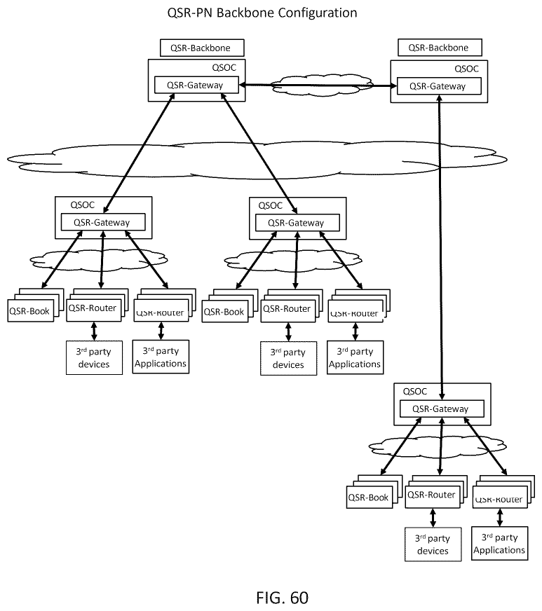

FIG. 60 is a block diagram depicting a QSR-PN Backbone Configuration, according to embodiments. Considerations or functionality of this configuration can include:
Q Backbone Network securely interconnects different Enterprises or independent network segments
   Different companies forming a supply chain;
   Different operations of the same Enterprise, such as operations in different countries or global Manufacturing, R&D, and Finance;
   Different regional service providers requiring connections to another region;
Q Backbone Network can be deployed as a private backbone (large corporations or governments) or can be an independent Service Provider.

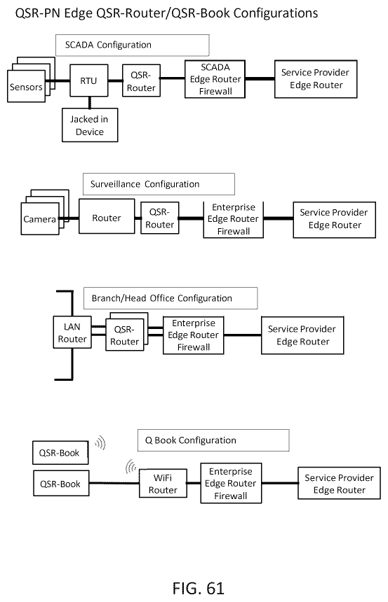

FIG. 61 is a block diagram depicting QSR-PN Edge QSR-Router/QSR-Book Configurations, according to embodiments. According to embodiments, a QSR-Router can be flexibly placed encrypting traffic close to the source providing maximum security for the different applications, which can include SCADA, video surveillance, branch office deployment, home office deployment, home office WiFi deployment and QSR book.

According to embodiments, application attributes that are addressed by this confirmation can include:
Placement meeting environmental requirements;
Streaming real time traffic;
Aligning with capacity requirements;
Aligning with reliability requirements;
Number of ports required to connect devices; and
Connecting with wireless router configurations.

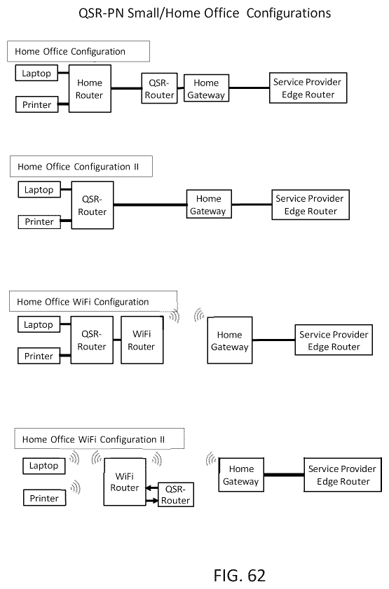

FIG. 62 is a block diagram depicting QSR-PN Small/Home Office Configurations, according to embodiments. The QSR-Router can be deployed in various configurations to secure the small/home office communications. The QSR-Router can connect to the home/WiFi router providing secure communications to everyone in the house/office. It can also be direct attached to the computers providing secure transmission directly from the source.

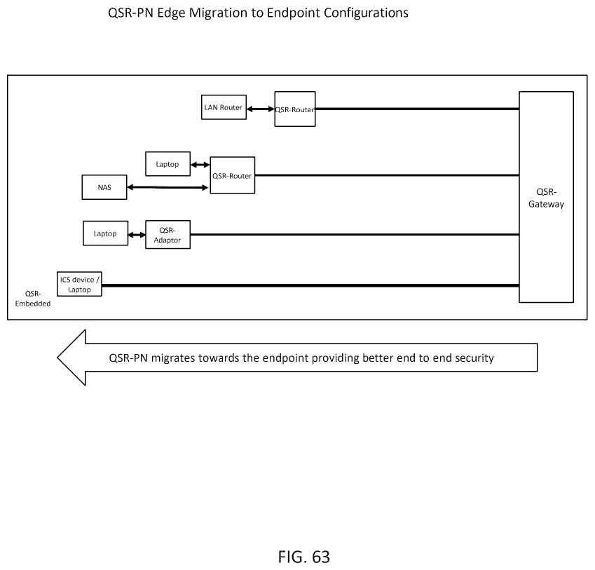

FIG. 63 is a block diagram depicting a QSR-PN Edge Migration to End-point Configurations, according to embodiments. QSR-PN edge migration to end-point can provide a better end-to-end security. Considerations or functionality of this configuration can include:
QSR-Router/LAN provides QSR-PN site to site security;
QSR-Router/Laptop/NAS provides workspace to workspace security;
QSR-Adaptor provides BYOD device to device security;
QSR-Embedded can be integrated with various ICS or computing devices providing internal device to internal device security.

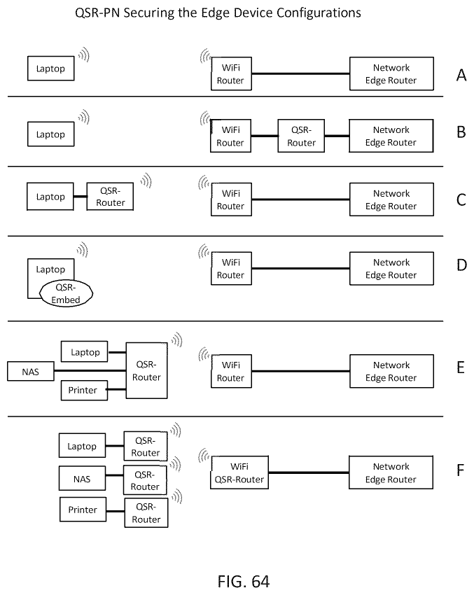

FIG. 64 is a block diagram depicting a QSR-PN Securing the Edge Device

Configurations, according to embodiments. Various configurations showing unsecured communications and then the QSR-PN securing the edge device with QSR-Router, QSR-Embed, QSR-Adaptor, and QSR-Router with WiFi. Examples of this configuration can include:
A: Non QSR-PN secured communication.
B: QSR-PN secured WAN.
C: QSR-PN secured WiFi and WAN
D: QSR-PN embedded in device
E: QSR-PN secured workspace
F: QSR-PN individually secured devices connected to WiFi QSR-Router

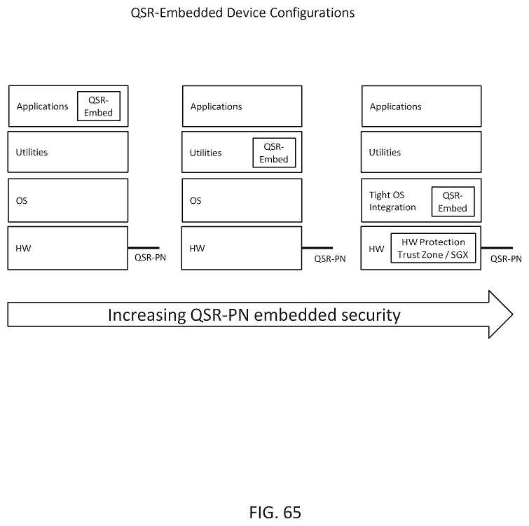

FIG. 65 is a block diagram depicting QSR-Embedded Device Configurations, according to embodiments. QSR-Embed can be embedded into any of the layers. According to embodiments, the higher up in the stack this configuration is integrated the easier the development and deployment. According to embodiments, the lower down in the stack this configuration is integrated the more secure and accessible by more applications/utilities. According to embodiments, integrating with the processor's protection architecture can provide the strongest security. According to embodiments, the security can be considered as being is for the integrity of the QPN and Q Agent functionality and data, for secure transmission.

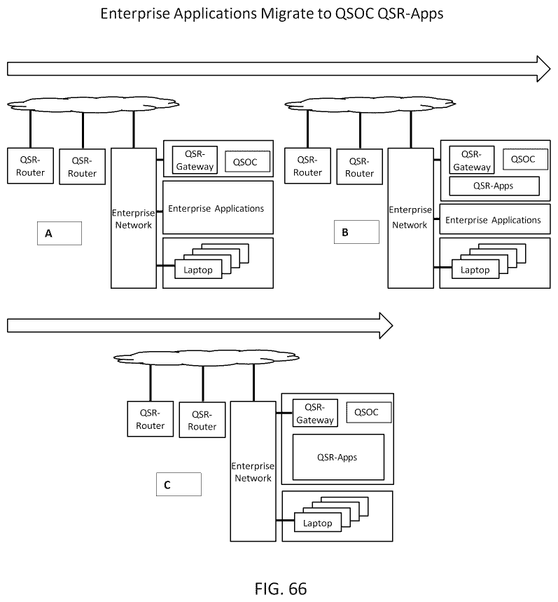

FIG. 66 is a block diagram depicting Enterprise Applications Migrate to QSOC QSR-Apps, according to embodiments. The QSR-PN is deployed to provide to secure access to Enterprise applications, Enterprise applications migrate to QSOC secure hosted application environment. According to embodiments, QSR-Apps (migrated Enterprise applications) integrated with CNSP security infrastructure. According to embodiments, Enterprise data center repurposed to other applications or decommissioned.

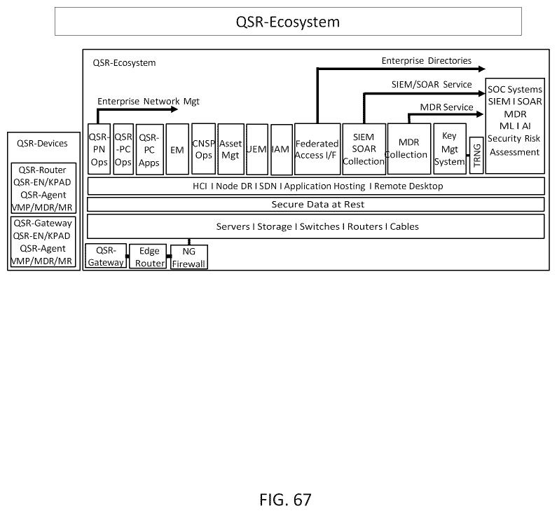

FIG. 67 is a block diagram depicting the features, functions and capabilities of a QSR system, according to embodiments. FIG. 67 depicts the features, functions, and capabilities supporting the QSR-PN, QSR-PC, and QSOC products on a fully featured CNSP. This can be configured as a fully integrated system that can provide comprehensive security for the individual products and when deployed in combination can increase the overall security of each individual product.

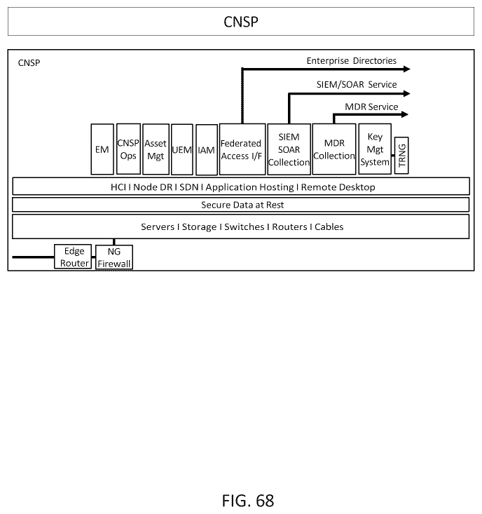

FIG. 68 is a block diagram depicting the features, functions and capabilities of the CNSP, according to embodiments. FIG. 68 depicts the features, functions, and capabilities of the Cloud Native Security Platform (CNSP), which can be considered to be the underpinning for QSR products. The CNSP can provide the capabilities enabling the secure operation of the products and applications. The CNSP includes the network and data center infrastructure, a hyper converged software layer, and capabilities providing monitoring, management, security capabilities for the products, and the key management system.

The network and data center infrastructure includes network facing routers and firewalls, data center servers, storage, switches, and routers providing a scalable infrastructure. The hyper-converged infrastructure (HCI) provides a comprehensive set of capabilities for the product applications, which can include:
software defined networking configuration and management of the network infrastructure;
processing and storage scalability for the software applications and data.;
manageability of the software including upgrades and isolation from other applications;
secure data at rest capabilities;
high availability and disaster recovery capabilities;
application hosting and remote desktop.

According to embodiments, there is a suite of monitoring, management and security systems utilized by the product applications enabling comprehensive operations and security coverage. This can include:

The network and data center infrastructure includes network facing routers and firewalls, data center servers, storage, switches, and routers providing a scalable infrastructure. The hyper-converged infrastructure (HCI) provides a comprehensive set of capabilities for the product applications, which can include:

Asset Management, Unified End-point Management, and Identity and Access Management and the aggregation of SIEM, SOAR, and MDR alarms, events, and logs to be forwarded onto the SOC for cyber-security threat analysis and response.

According to embodiments, there is a management capability integrating the CNSP system operations into a “single pane of glass”. This capability also integrates the QSR-PN, QSR-PC, and QSOC operations making this “single pane of glass” the one point all deployed products can be viewed providing an integrated comprehensive operations capability.

According to embodiments, the key management system generates the True Random Numbers that are made into key material and loaded onto QSR-Devices to be deployed.

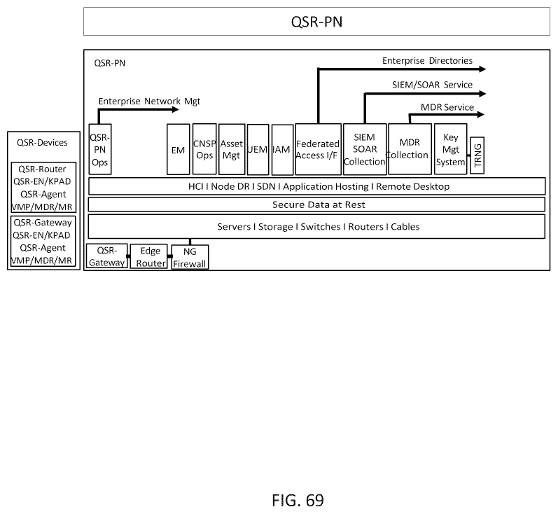

FIG. 69 is a block diagram depicting the features, functions and capabilities of the QSR-PN, according to embodiments. The QSR-PN includes two main functions, the data plane securing of the traffic and the management plane performing the monitoring, management, and configuration of the network.

According to embodiments, the QSR-PN Ops, the management plane, performs the network configuration and management of the QSR-PN. The QSR-PN Ops also manages and monitors the devices, their configurations, alarms, events, and logs relevant to the performance and availability of the QSR-PN network operations. The QSR-PN is an overlay to existing Enterprise networks and will feed QSR-PN operational and performance information to the Enterprise network management functions for end-to-end performance monitoring and co-ordination of the Enterprise network.

According to embodiments, the QSR-PN Ops management functions utilize the capabilities in the CNSP Asset Management, UEM, and IAM for device and administrator configuration and controls. The QSR-PN Ops management functions are integrated into the CNSP's “single pane of glass” Enterprise Manager.

According to embodiments, the QSR-PN operations can be an important part of providing secure data in transit. The QSR-PN will likely be a target by nefarious actors. The CNSP HCI capabilities can be utilized to provide secure, reliable, and robust operation.

According to embodiments, alarms, events, and logs are forwarded from QSR-Devices and QSR-PN Ops to the SIEM, SOAR, and MDR collection capabilities in the CNSP to be further analyzed by the SIEM, SOAR, and MDR systems and SOC personnel identifying cyber-threats and appropriate responses.

According to embodiments, there is provided QSR-Devices, QSR-Router and QSR-Gateway and a secure data plane. According to some embodiments, a QSR-Device can incorporate:
QSR-EN the encryption securing the traffic in transit across the network
KPAD—the key material preloaded on the device used by the QSR-EN
Q-Agent—configuration and controls mitigating unauthorized operations.
MDR—forwards relevant MDR information (alarms, events, logs, stats) to MDR Collector
MR (Monitoring & Reporting)—forwards relevant information (alarms, events, logs, stats) to QSR-Ops & SIEM/SOAR Collector
QSR-EP (End-point Protection)—monitors the device for viruses and malware

According to embodiments, the QSR-Devices are preloaded with KPAD keys for use by the QSR-EN. These KPADs are minted by the CNSP's Key Management System and TRNG.

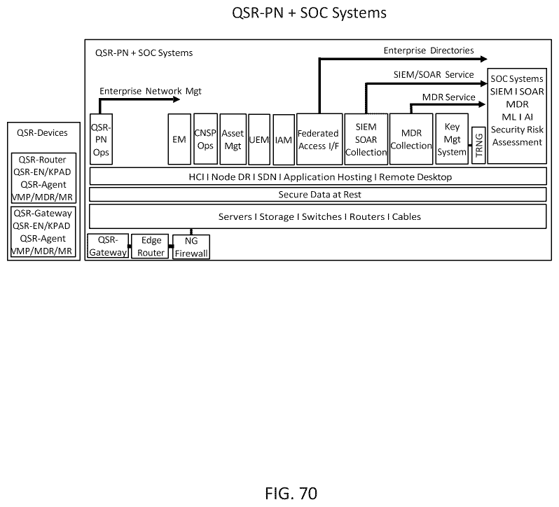

FIG. 70 is a block diagram depicting the features, functions and capabilities of the QSN-PN+SOC Systems, according to embodiments. Security Operations Center (SOC) systems are deployed on the CNSP. These SOC systems consist of the SIEM, SOAR, and MDR systems analyzing the alarm, event, logs, and statistics data forwarded to them from the CNSP Ops, QSR-PR operations and QSR-Devices via SIEM/SOAR and MDR Collection functions. The SOC systems incorporate Machine Leaning (ML) and Artificial Intelligence (AI) capabilities to identify cybersecurity threats and recommend or initiate appropriate responses based on configuration. The SOC systems management, configuration, and security posture status are also integrated into the CNSP's “single pane of glass” Enterprise Management system. In this case the EM has the combined view of the CNSP, QSR-PN, and SOC operations and status.

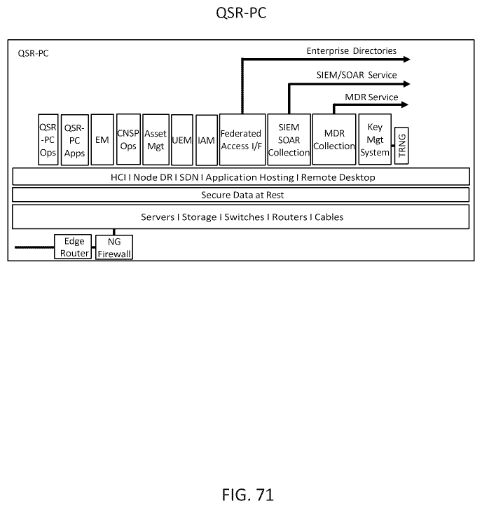

FIG. 71 is a block diagram depicting the features, functions and capabilities of the QSR-Private Cloud, according to embodiments. The QSR-PC utilizes the CNSP comprehensive capabilities to host applications on the platform. The QSR-PC Ops is the monitoring, management, and configuration for the hosted applications.

According to embodiments, the QSR-PC Ops management functions utilize the capabilities in the CNSP Asset Management, UEM, and IAM for end user, administrator, and application configuration and controls. The QSR-PC Ops management functions are integrated into the CNSP's “single pane of glass” Enterprise Manager.

According to embodiments, hosted applications require scalable processing and storage, secure data at rest, on a secure, reliable, and robust platform. For added security cloud applications are accessed via remote desktop functionality. The CNSP HCI capabilities are optimized for these demands and applications.

According to embodiments, when integrated with Enterprise IT operations, user and application data may be in multiple systems and locations. The CNSP Federated Access I/F enables sharing and cross populating of data for efficient operation.

According to embodiments, alarms, events, and logs are forwarded from Hosted Applications and QSR-PC Ops to the SIEM, SOAR, and MDR collection capabilities in the CNSP to be further analyzed by the SIEM, SOAR, and MDR systems and SOC personnel identifying cyber-threats and appropriate responses.

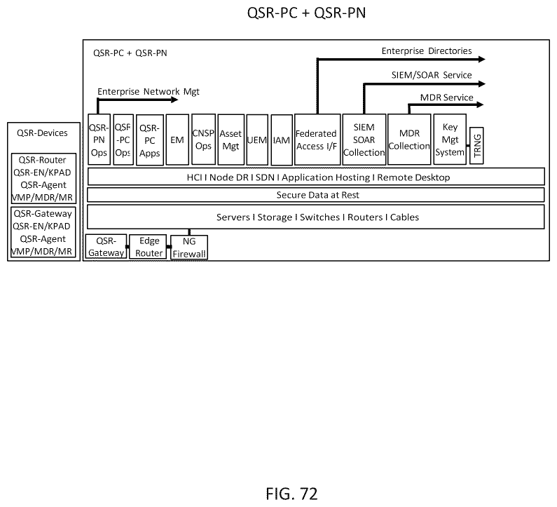

FIG. 72 is a block diagram depicting the features, functions and capabilities of the QSR-PC+QSR-PN, according to embodiments. The deployment of QSR-PC and QSR-PN provides a very secure environment. The QSR-PN provides secure access from the QSR-PN access point to the QSR-PC. This is added security ensuring only authorized users access the QSR-PC and the communications between the user and the application is secure. The “single pane of glass” Enterprise Manager has the combined view of the CNSP, QSR-PN, and QSR-PC operations and status.

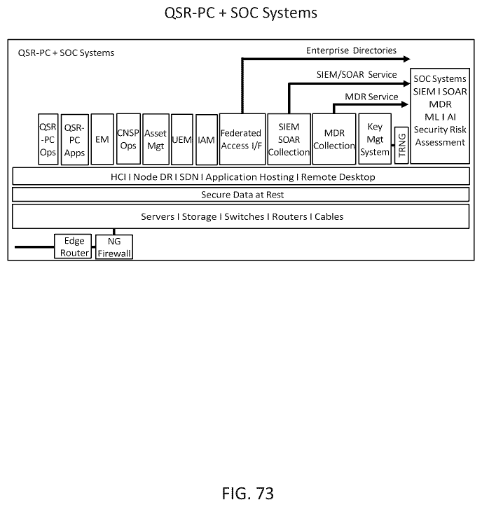

FIG. 73 is a block diagram depicting the features, functions and capabilities of the QSR-PC+SOC Systems, according to embodiments. Security Operations Center (SOC) systems are deployed on the CNSP. These SOC systems consist of the SIEM, SOAR, and MDR systems analyzing the alarm, event, logs, and statistics data forwarded to them from the CNSP Ops, QSR-PC operations and Hosted Applications via SIEM/SOAR and MDR Collection functions. The SOC systems incorporate Machine Leaning (ML) and Artificial Intelligence (AI) capabilities to identify cybersecurity threats and recommend or initiate appropriate responses based on configuration. The SOC systems management, configuration, and security posture status are also integrated into the CNSP's “single pane of glass” Enterprise Management system. The Enterprise Manager has the combined view of the CNSP, QSR-PC, and SOC operations and status.

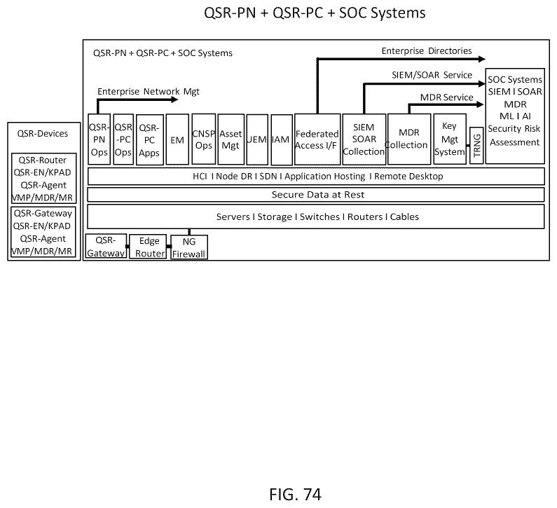

FIG. 74 is a block diagram depicting the features, functions and capabilities of the QSR-PN+QSR-Private Cloud+SOC Systems, according to embodiments. This is a comprehensive integrated solution providing secure communications and secure hosted applications on a scalable, secure, reliable platform with a full suite of security monitoring and analysis systems.

According to embodiments, security Operations Center systems (SIEM, SOAR, and MDR) analyze the alarm, event, logs, and statistics data forwarded to them from the CNSP Ops, QSR-PN, QSR-PC operations and Hosted Applications. The SOC systems incorporate Machine Leaning (ML) and Artificial Intelligence (AI) capabilities to identify cybersecurity threats and recommend or initiate appropriate responses based on configuration. The SOC systems management, configuration, and security policies and status are also integrated into the CNSP's “single pane of glass” Enterprise Management system providing a comprehensive view of the CNSP, QSR-PN, QSR-PC, and SOC operations and status.

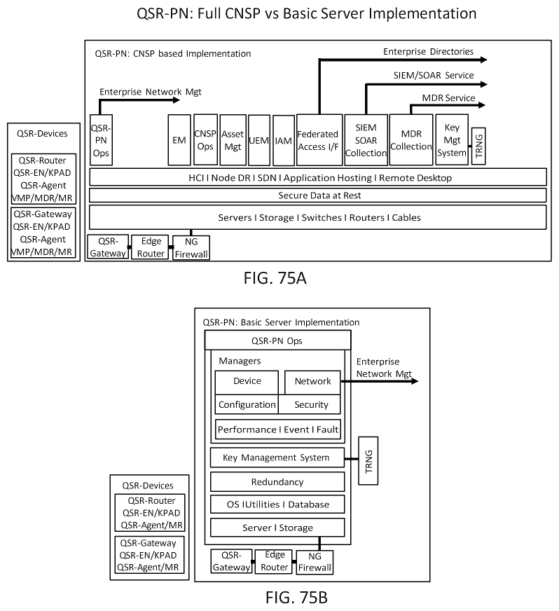

FIG. 75A is a block diagram illustrating a QSR-PN with a full CNSP configuration, according to embodiments. The QSR-PN can be implemented on a scaled down basic server implementation. This demonstrates the flexibility of QSR-PN providing focused secure connectivity and when implemented into the broader CNSP security offerings. FIG. 75B is a block diagram illustrating a QSR-PN with a basic server configuration, according to embodiments. According to embodiments, the QSR-PN Manager software functions providing the necessary device and network management capabilities. The Manager software functions would be implemented for greater scale and complex management and security capabilities in the CNSP's Asset Management, UEM, IAM, SIEM/SOAR/MDR collection systems. This server can be typically arranged in a n+1 Redundancy configuration providing continuous operation if a fault occurs where the CNSP will take advantage of the full capabilities of the HCI infrastructure. Both configurations have their place depending on the application.

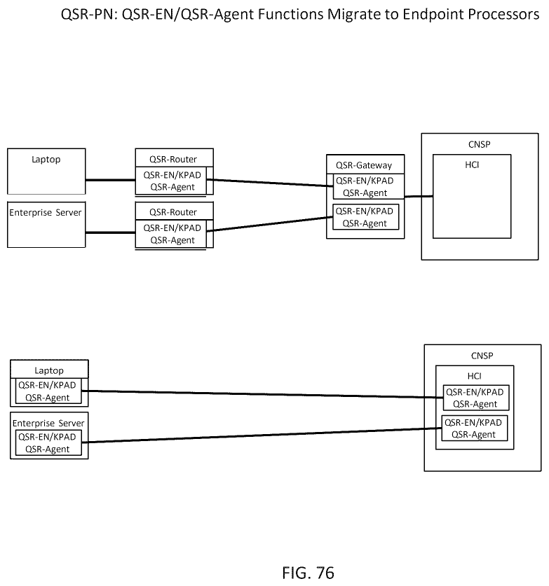

FIG. 76 is a block diagram illustrating QSR-PN QSR-EN/QSR-Agent Functions implemented in Endpoint Processors, according to embodiments. The QSR-Router and QSR-Gateway enable the QPN to be deployed into existing infrastructure without any significant changes. However, this configuration can add additional components into the network. As networks and data centers adopt QSR-PN the core QSR-PN management and encryption functions can migrate into different equipment and processing elements. This is the QSR-Embed configuration. The QSR-Embed functionality can be embedded into many different devices network routers, home/SMB routers, ICS equipment, laptops, servers, IoT, etc.

FIG. 77A is a sequence diagram illustrating a sequence of QSR-EN for the establishment of a secure tunnel between an originating device and a destination device, according to embodiments.

FIG. 77B is another sequence diagram illustrating a sequence of QSR-EN for the establishment of a secure tunnel between an originating device and a destination device, according to embodiments.

According to embodiments, QSR-Encryption addresses many of vulnerabilities of current encryption methodologies. There are three components to QSR-Encryption (QSR-EN), the KPAD, encryption engine, and the cipher algorithm.

According to embodiments, the KPAD is preloaded onto the device. This eliminates the key exchange vulnerability especially with quantum computers. The KPAD is a large amount of key material that is used once and then destroyed. The KPAD structure can have multiple embodiments, single large flat file, linked list of smaller sizes, or other data structures. One embodiment is to use a keypad of true random numbers eliminating any pattern in the key material that could be used to determine the key and break the cipher text.

According to embodiments, the cipher algorithm using the cipher key transforms the plaintext into cipher text. There are various embodiments of cipher algorithms, ChaCha20/Poly1305, AES 256/512/1024/2048, etc.

According to embodiments, the encryption engine performs the logic of providing the cipher algorithm with the required key (cipher key) and the subsequent destruction of key material. The QSR-Encryption uses a key for a short period of time and then replaces it with another. This ensures the amount of key material encrypted with the key is limited and then another key is used. The duration can be fixed or variable, but the duration is typically in the less than 3-minute range. The keys duration of use can be determined by the encryption engine or the cipher algorithm. The size of the key is determined by the cipher engine but the larger the key the more secure the encryption. According to some embodiments, it is recommended that key sizes of 256 bits or larger are used.

According to embodiments, the destination or receiving device, and in particular the destination encryption engine received the encrypted packet and can also receive the key id (e.g., information indicative of the key) and if necessary, gets the identified KPAD bytes and loads the cipher algorithm enabling decryption. The key id can be incorporated into the cipher packet or can be a separate sequence of encrypted messages.

According to embodiments, the cipher algorithm can be replaced as stronger algorithms are required and/or developed. Since the QSR-Encryption is point to point upgrading the algorithms can be done on an incremental basis, only requiring upgrading of the origination/destination pair.

According to embodiments, a QSR-PN provides the ability to custom integrate and/or extend existing open source or proprietary virtual private network (VPN) solutions such as Wireguard, OpenVPN, StrongSwan among other solutions. Different VPN solutions provide and utilize different networking protocols.

According to embodiments, a method for establishment of a quantum secure/resistant private network (QSR-PN) includes a plurality of steps. These steps can include a configuration step, an initialization step, a handshake step, a tunnel establishment step and a data transfer step. In some embodiments, the tunnel establishment step and the data transfer step provide a means for the secure transfer of data using a QSR-PN. The configuration step, the initialization step and the handshake step are provided in order for an originating device and a destination device to be aligned with respect to or agree upon, the specific encryption that will be used for tunnel establishment and data transfer.

According to embodiments, the following phases or operations are relevant to the establishment of a QSR-PN:
Configuration—This phase is where the VPN configuration and properties for setting up a connection are provided. Each VPN system requires some form of configuration settings, either statically defined within a configuration file and/or set through a server repository. Configuration settings can also be dynamically configured when setting up software-defined networks (SDN) and/or mesh networking.
Initialization—During this phase the VPN client and server are configured to create a secure tunnel, including setting up IP addresses, ports, etc. and initializing the end-points for communication with each other.
Handshake—The VPN client and server initiate communication and agree upon security settings and authenticate with each other. They may negotiate encryption algorithms, hash methods, and authenticate using certificates or pre-shared keys in order to establish a secure communication tunnel. Authentication and authorization of devices and/or users is also performed within the handshake phase.
Tunnel Establishment—After completing the handshake, a secure communication tunnel is established using encryption and hashing algorithms agreed upon during the handshake phase. The appropriate cipher is configured as negotiated with the other end.
Data Transfer—This is the actual phase where data packets are securely transmitted between the VPN client and server using the secure tunnel. Different VPN solutions provide different types of algorithms for performing encryption and decryption of data during the data transfer phase. There are 3 primary types of encryption ciphers:
   Symmetric Ciphers: These ciphers use the same key for both encryption and decryption. Symmetric ciphers can be further divided into block ciphers and stream ciphers. Block ciphers, such as AES, DES, 3DES, Blowfish, Twofish, Camellia, and CAST5, encrypt data in fixed-size blocks. Stream ciphers, like ChaCha20, Salsa20, RC4, and One-Time-Pad (OTP), encrypt data one bit or byte at a time. Additionally, the OTP cipher is the only theoretically secure cipher and serves as the basis for the QSR-PN technology.
   Asymmetric Ciphers: These ciphers use different keys for encryption and decryption. They are often employed for key exchange or initial authentication rather than encrypting large volumes of data. Examples include RSA, DSA, ECC, DH, ECDH, as well as quantum-resistant options like CRYSTALS-Kyber, CRYSTALS-Dilithium, SPHINCS+, and FALCON.
   Quantum-Resistant Ciphers: These algorithms are believed to offer security against quantum computing attacks. They are emerging technologies that aim to future-proof cryptographic systems against the potential risks posed by quantum computing. Examples include CRYSTALS-Kyber (covered in FIPS 203), CRYSTALS-Dilithium (covered in FIPS 204), SPHINCS+ (covered in FIPS 205), and FALCON (expected to receive its own draft FIPS in 2024).

It is understood that open source solutions work sufficiently well and are secure for current network solutions, however it has been realised that quantum computers and artificial intelligence (AI) technologies will be able to break many of the encryption techniques within these open source solutions in the near future. As such, according to embodiments, a QSR-PN has been designed and created to protect from future quantum and AI cyber attacks by leveraging one time pad (OTP) based solutions. At the present time, OTP-based solutions are considered to be the only encryption solution that provides substantially perfect secrecy and/or highly quantum resistant solutions.

As discussed elsewhere herein, the QSR-PN includes a set of libraries, source code, and techniques that leverage OTP-based keys (e.g., KPADs) to augment existing cryptography solutions such as VPN's. Leveraging these libraries, existing VPN solutions can be extended and/or augmented to create quantum-secure/quantum-resistant solutions.

FIG. 77B is a sequence diagram illustrating a sequence of QSR-EN for the establishment of a secure tunnel between an originating device and a destination device, according to embodiments. FIG. 77B depicts an embodiment of a Tier 1 OTP implementation. The encryption engine and cipher algorithm can be configured and initialized similar to the previous description of a Tier 2 implementation. The difference is in the encryption algorithm where KPAD bytes are requested for each plaintext message. The number of KPAD bytes needs to be the same as the number of bytes in the plaintext message both on the transmitting and receiving side. Given new KPAD material is used for each message, it may be considered that the session timeout and reestablishment can be optional.

In one embodiment, QSR-PN integrates and extends the Wireguard (WG) VPN solution as further discuss below. However, while the desired modifications to WG have been presented as an example, it would be readily understood that embodiments of the instant application can be integrated into other formats or protocols of VPNs for the creation and operation of a QSR-PN. The steps for the creation of a QSR-PN can include:
Configuration—The WG configuration has been modified to add additional metadata information to a peer-to-peer communication, including:
   KPAD ID's—For each peer configuration, two KPAD ID's have been added (one for sending and one for receiving). Each KPAD ID references KPAD's that have been provisioned on the client and server devices, such as QSR-Router, QSR-Gateway, QSR-Book, etc.
   Peer ID's—Pre-shared keys have been added to the configuration of each peer end of a communication channel which will be used for authentication during the handshake.
   Session Timeout Properties—Session timeout properties have been added to the WG configuration to support dynamic session timeout. The current WG solution times out sessions and/or rekeys (creates new encryption keys) every 2 minutes or after a certain amount of data has been transferred. It then performs a new handshake to share the new ephemeral keys. The modified Session timeout properties provide the ability for the timeout period to dynamically timeout based upon a range of time rather than a single specific time (i.e., on a random periodic basis, for example, on a random basis between every 2 to 5 minutes). This protects the communication channel from nefarious actors sniffing the wire, so that they are not aware of when the handshake may occur.
   QSR-PN Encryption Tier Properties—The specified communication tier and protocol(s) are specified in the configuration file, including: Tier Level, Encryption Type, etc. These configuration properties are read during the initiation of a communication channel between two QSR-Device peers, and are consistent in each peer's configuration file in order to properly establish the necessary communication protocol and encryption type.
According to embodiments, the WG Tools library and API have been modified to support the additional metadata and data structures within the WG communication libraries have been modified to support utilization of this additional metadata and data structures. In addition, the APIs associated with WG have been expanded to support the ability to perform dynamic configuration for use in mesh networking solutions.
Initialization—When the VPN client and server are started up and/or are initiated through a dynamic configuration modification through the API, the WG system process utilizes the modified WG configuration to create a secure tunnel, leveraging the IP addresses, ports, etc. within the WG configuration settings. During this phase, the WG system has been extended by calling QSR-PN libraries to perform initialization of the KPAD subsystem, which validates the underlying KPAD libraries and services are available and the required KPAD's are accessible with necessary key material to establish a secure tunnel.
Handshake—During the handshake phase, the WG system has been modified to support the ability to read the appropriate KPAD's from the KPAD service and utilize the KPAD entropy data as part of the handshake phase initiating communication between two WG peers (QSR-Devices). During the handshake, the WG system utilizes a solution to create a key exchange mechanism to share a dynamic ephemeral symmetric session key. The current WG solution utilizes a PKI-based public/private key and generate and share the dynamic ephemeral shared session keys with each other using a Diffie-Hellman algorithm.
According to embodiments, a QSR-PN has modified the handshake to read unique random bytes (configurable # of bytes defaulting to 64 bytes) from the KPAD specified within the WG configuration, and utilizes these values along with the pre-shared key defined within the configuration to perform the handshake.
According to embodiments, periodically, based upon a certain amount of data or by dynamic period timeout, the session can time out and a peer can re-initiate communication with its peer and perform another handshake establishing a new session key.
According to embodiments, the logic of utilizing pre-shared public/private keys within the configuration settings to authenticate with each other during the handshake has been extended by the QSR-PN to utilize pre-shared symmetric peer keys instead of public keys to defend against future quantum threats.
Additionally, according to embodiments, after the handshake has been performed, additional metadata about the peer system (QSR-Device), including device fingerprint and authenticated user information is sent across the QSR-PN secure tunnel to the server (i.e., QSR-Gateway) and a secondary authentication and authorization process is initialized. During this process the device fingerprint, end-user credentials, and additional information is sent to the server embedded within the WG system which has been modified. The WG system interact with the QSR-UEM service to authenticate the device, the QSR-IAM service to authenticate the end-user, and the QSR-PO system to get dynamic access policies and permissions for the QSR-Device and the associated end-user running on the device. The WG system modifications will then interact with the QSR-Platform systems to dynamically configure network policies and routing information establishing up stream communication channels for the device and user within the QSR-Ecosystem (QSR-E).
In one embodiment, the WG system will be modified to perform a multi-phased authentication and authorization process. Within this process, rather than embedding and integrating the detailed authentication and authorization phases directly within the WG system, the QSR-PN has been configured to perform one or more external secondary API calls to the QSR-Agent on the client QSR-Device to perform authentication and authorization of the QSR-Device and end-user on the client platform. Upon receiving the request to authenticate and/or authorize a device and user on the system will make a call over the QSR-PN tunnel to the associated QSR-IAM, QSR-UEM, and QSR-PO services running on the QSR-Platform to perform authentication and authorization of the device and user to the QSR-Platform and QSR-Ecosystem. If the QSR-Device and/or end-user running on the QSR-Device does not have appropriate permissions, then the QSR-PN communication tunnel will be terminated.
Tunnel Establishment—The QSR-PN solution has modified the WG system when establishing a tunnel in several ways. As elsewhere herein, the QSR-PN solution runs in multiple different tier configurations, including: Tier 1-Pure OTP-based encryption and Tier 2-OTP-based handshake/dynamic ephemeral session key data transfer. Additionally, in order to support cross VPN interoperability and ability to choose different cryptographic algorithms and ciphers, properties are specified in the QSR-PN Encryption Tier Properties. After the system performs its handshake with its peer and performs authentication and authorization processes, the QSR-PN solution will dynamically read the encryption properties and establish a secure communication tunnel. There are multiple different types of configurations including:
   Tier 1—OTP-based Tunnel—In this embodiment, the WG system has been modified with a QSR-PN encryption library and OTP-based cipher (which may be a stream cipher or a block cipher) that will utilize the appropriate send and receive KPAD's defined in the configuration to perform pure OTP encryption where every data packet that is sent is KPAD encrypted using unique one time use random numbers from the KPAD.
   Tier 2—WG Default Tunnel—In this embodiment, the QSR-PN will use the default WG cryptographic communication mechanisms that it inherently uses to establish a tunnel and perform appropriate network routing and network address translation (NAT).
   Tier 2—Custom Encryption Cipher—In this embodiment, the QSR-PN system will read the configuration file to determine the appropriate encryption cipher to utilize, including but not limited to one of the many different Open SSL encryption ciphers, digital signatures, and MAC solutions:
   Tiers 3-5—Other tiers within the QSR-PN solution refer to devices that are not using QSR-PN encryption libraries specifically.
Data Transfer—Once the tunnel is established, and the QSR-PN initiates the appropriate QSR-PN encryption library module based upon the configuration, and established a tunnel, the secure tunnel will send and receive data packets across this tunnel utilizing the appropriate algorithms. It is to be noted that dynamic session timeouts can be enforced causing the QSR-PN to perform regular handshakes and re-establishing keys and communication channels.

The above describes how QSR-PN extends and integrates with Wireguard VPN to support interchangeable encryption algorithms and ciphers and the creation of a variety of different types of quantum-secure and/or quantum-resistant network communications between different communication devices. Leveraging the Wireguard version of QSR-PN, the QSR-PN provides the ability to provide secure communications between many different types of operating systems and devices, including: Linux, Windows, macOS, FreeBSD, OpenBSD, NetBSD, Android, IOS, and other platforms. The QSR-PN libraries also support the ability to extend and integrate into other VPN solutions including Open VPN, StrongSwan, and others.

According to embodiments, in order to achieve a level of cross VPN interoperability and interchangeable encryption algorithms and ciphers, the QSR-PN solution has been developed as a set of modular libraries. The cryptographic operations, including: handshake, initialization, and data packet encryption/decryption are performed, wherein the appropriate QSR-PN library or libraries are selected based on the selected tier of the QSR-PN.

FIG. 77C is a sequence diagram illustrating a sequence of QSR-EN for the establishment of a secure tunnel between an originating device and a destination device, according to embodiments.

In order to establish a tunnel between the origination peer and the destination peer a number of steps are followed, after which the session is established, an ephemeral session key is in place and encrypted data communications can begin. The same mechanism can be used for both Tier 1 and Tier 2 handshakes. A high-level description of these steps includes:

### Step 7701

According to embodiments, only on an initial handshake does the configuration of the QSR-PN need to be read. This obtains the necessary information to establish and maintain a communications tunnel. According to embodiments, further handshake messages do not require this as the configuration is cached.

### Step 7702

According to embodiments, a handshake message is initialized with data, including the peer identification which can then be used by the destination peer to determine which KPAD should be used to decrypt and encrypt.

### Step 7703

According to embodiments, a variable number of bytes of KPAD material are read from the correct KPAD. The number of bytes can be varied by tunnel. FIG. 77C illustrates this number of bytes being 64 bytes, however this is to be considered as an example and non-limiting.

### Step 7704

According to embodiments, the handshake message is encrypted using the KPAD material and other information.

### Step 7705

According to embodiments, the handshake packet is transmitted to the destination peer along with the index from where the material was read within the KPAD.

### Step 7706

According to embodiments, on receipt of the initial handshake message by the destination peer, the QSR-PN configuration is obtained using the specified peer identifier (ID). According to embodiments, further handshakes do not need to do this as the configuration is cached.

### Step 7707

According to embodiments, a response message is prepared with data confirming the correct configuration was used.

### Step 7708

According to embodiments, the correct KPAD is read for the variable amount of key material as specified by the configuration and using the index supplied in the handshake message.

### Step 7709

According to embodiments, the handshake message is decrypted using the KPAD material and other information.

### Step 7710

According to embodiments, the content of the decrypted message is used to verify the originating peer.

### Step 7711

According to embodiments, an ephemeral session key is created, derived or generated and cached for the duration of a configured timer, after which a new key is established. The timer duration can be varied between tunnels and even within a given range.

### Step 7712

According to embodiments, this concludes the first part of the handshake where the originating peer information is received by the destination peer and verified. Now the destination peer goes through a similar process to the originating peer. Steps 7702 through 7705 are executed by the destination peer.

### Step 7713

According to embodiments, the originating peer now goes through a similar process to the destination peer when it receives a handshake message. Steps 7708 through 7711 are executed.

According to embodiments, after the originating peer successfully sends a handshake message to the destination, the destination verifies the handshake, the destination generates its own handshake message and finally the originating peer verifies the destinations handshake message, a tunnel is established, and data packets can then be encrypted/decrypted and sent/received across the tunnel.

Having further regard to FIG. 77C, it can be envisioned that the combination of the initiating of the initial handshake by the originating device and the handshake response by the destination device can be considered as a single complete handshake. As such, it may be considered that a handshake includes multiple components, for example the initiating of the handshake and the response to the handshake (or the initiating of the handshake).

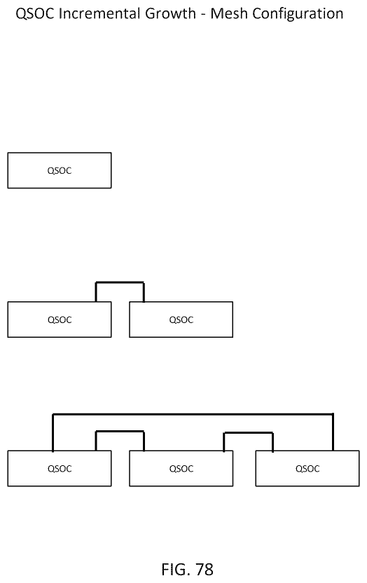

FIG. 78 is a block diagram depicting QSOC Incremental Growth-Mesh Configuration. This figure depicts an embodiment of incremental growth as QSOCs are deployed and their interconnection in a mesh configuration. The QSOCs are interconnected as required.

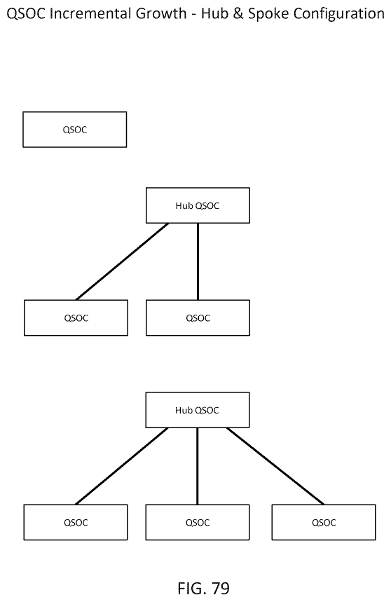

FIG. 79 is a block diagram depicting QSOC Incremental Growth-Hub & Spoke Configuration. This figure depicts an embodiment of incremental growth as QSOCs are interconnection in a hub and spoke configuration. The hub and spoke configuration provide the connectivity between QSOCs to be used when required. There are no actions required to connect to other QSOCs connected to the hub QSOC.

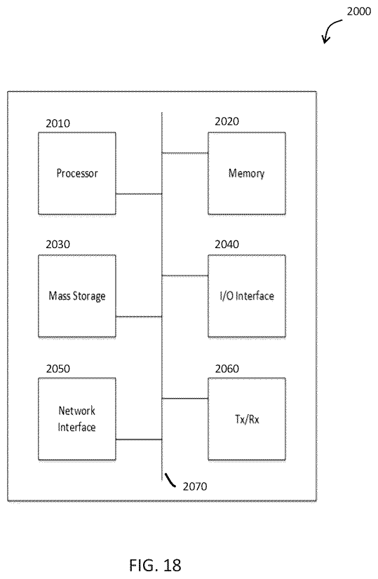

The following examples illustrate embodiments of the disclosure implemented using standard computing devices. A standard computing device is illustrated in FIG. 18. FIG. 18 is a schematic diagram of an electronic device 2000 that may perform any or all of operations of the above methods and features explicitly or implicitly described herein, according to different embodiments of the present disclosure. For example, a computer or server may be configured as electronic device 2000. In some embodiments, the electronic device 2000 may be a user equipment (UE), a server, an access point, a station, a gateway, communication network entity, an appliance or the like as would be readily appreciated by a person skilled in the art.

As shown, the electronic device 2000 may include a processor 2010, such as a central processing unit (CPU) or specialized processors such as a graphics processing unit (GPU) or other such processor unit, memory 2020, non-transitory mass storage 2030, input-output interface 2040, network interface 2050, and a transceiver 2060, all of which are communicatively coupled via bi-directional bus 2070. According to certain embodiments, any or all the depicted elements may be utilized, or only a subset of the elements. Further, electronic device 2000 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 2020 may include any type of non-transitory memory such as static random-access memory (SRAM), dynamic random-access memory (DRAM), synchro-nous DRAM (SDRAM), read-only memory (ROM), any combination of such, or the like. The mass storage element 2030 may include any type of non-transitory storage device, such as a solid-state drive, hard disk drive, a magnetic disk drive, an optical disk drive, USB drive, or any computer program product configured to store data and machine executable program code. According to certain embodiments, the memory 2020 or mass storage 2030 may have recorded thereon statements and instructions executable by the processor 2010 for performing any of the method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, personal digital assistant (PDA), or the like and pursuant to one or more, or a part of one or more, program elements, modules or objects generated from any programming language, such as C/C++, Rust, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes instructions that enable a computer device (personal computer, server, or network device) to execute the methods provided in the embodiments of the present disclosure. For example, such an execution may correspond to a simulation of the logical operations as described herein. The software product may additionally or alternatively include instructions that enable a computer device to execute operations for configuring or programming a digital logic apparatus in accordance with embodiments of the present disclosure.

To gain a better understanding of the invention described herein, the following examples are set forth. It will be understood that these examples are intended to describe illustrative embodiments of the invention and are not intended to limit the scope of the invention in any way.

### EXAMPLES

### Example I: Exemplary Ecosystem and Solutions

### Secure Architecture

One embodiment of a representative architecture of a secure digital network environment (e.g. Quantum Secure Ecosystem) is illustrated with reference to FIG. 19A and FIGS. 21A, 21B and 21C. In these examples an embodiment the QSR-E is referred to as a QSR-PN Ecosystem

The architecture consists of different features that are securely deployed within the Ecosystem. Quantum Security Operations Centers (QSOC's) are provided for the exemplary centralized, or delegated, management of an Ecosystem, alternatively referred to in the present disclosure as a QSR-PN Core Ecosystem. A QSOC is a highly available, fault tolerant, scalable, and geographically distributed to meet enterprise level reliability and security requirements and facilitate the building of networks within a QSR-PN Ecosystem Perimeter and in some instances securely connecting this type of a secure digital network environment with networks or environments that go beyond the QSR-PN Ecosystem Perimeter.

Within a QSR-PN Ecosystem, there are several (sub) systems. These include the KPAD Exchange, KPAD Directory and KPAD Distribution Systems.

A KPAD Exchange (KPAD management system) comprises one-time-pad (OTP) key material and libraries attached to QSR-Devices and QSR-Accessories within a secure digital ecosystem (the QSR-PN Ecosystem) to manage and exchange additional keys in a quantum secure/resistant (QS) manner.

A KPAD Directory provides a QSR-PN Solutions (devices, applications, libraries, services, and processes) that support the ability to manage (provision, revoke, monitor, and control) all devices, users, groups, authentication mechanisms, and permissions within the QSR-PN Ecosystem.

A KPAD Distribution system provides quantum key distribution (QKD) solutions to support distribution of key material used for encrypting data at rest as well as data in flight. In an embodiment, QSR-PN capabilities for prepositioning OTP technology throughout a secure digital network environment avoids the need for QKD enabled delivery of networked OTP technology.

### Secure Threat Defense

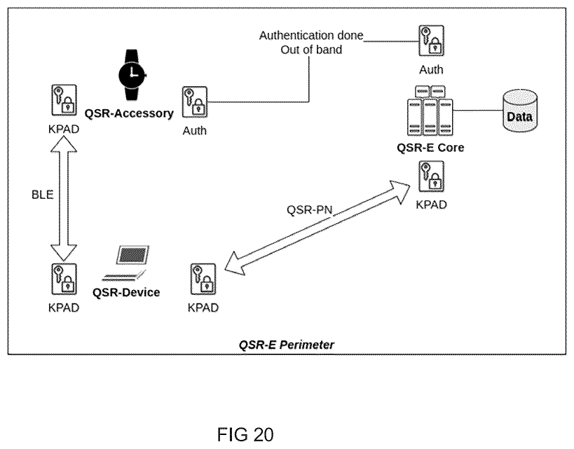

A QSR-PN Ecosystem is configured to apply various lines of defense against cyber security threats including related privacy threats. In one embodiment, a QSR-PN Ecosystem is configured to carry out “Identity and Access Management” (IAM) processes so that only authorized devices (QSR-Devices) can access the QSR-PN Ecosystem through their respective, unique KPADs (OTP keys) and they are then further limited to only those services and data that each is authorized to access. Individual users are bound to their QSR-PN enabled devices through multifactor authentication as shown in FIG. 20. Any breach of the user authentication process can, based on individual or organizational security polices (e.g. digital protocols for determining access), prevent the device from retaining access privileges. Organizational (e.g. private and public enterprises) controlled devices (e.g, SCADA controlled devices) are controlled exclusively through KPADs by the QSOC and are restricted from any other types of access. The QSR-PN IAM subsystem combined with rigid whitelist policies prevents phishing, denial of service attacks, email and phone SPAM, as well as insider threats.

In another embodiment, a QSR-PN Ecosystem deploys unbreakable (quantum secure/resistant and future-proof) encryption (KPAD). After participating in the IAM process the KPAD is then used to encrypt all data transmitted between the device and the QSR-PN Ecosystem. All data encrypted with the KPAD is ITS (Information Theoretically Secure) against all cryptographic attacks. Regardless of the extent of the attackers' resources these KPAD encrypted communications will remain quantum secure. The unbreakable characteristics of KPAD and QSR-PN services prevents man in the middle attacks data harvesting, endpoint device compromise and data loss because the data cannot be found on the devices that are hacked.

In another embodiment a QSR-PN Ecosystem is configured to provide for centralized data storage and prevent data residue on devices. Every device, unless otherwise specified by individual or enterprise (organizational) security polices, acts simply as an access point to the QSR-PN Ecosystem. All data and security keys are protected in the user's secure storage areas within the QSR-PN Ecosystem. Failover and redundancy provisions are defined by security policies. QSR-Drive ensures that all data is encrypted, centrally protected, remains confidential and available only to the data owner. QSR-PN end-points (e.g., at or within QSR-Devices) feature “no data residue”. Lost or stolen devices provide no actionable data and devices and cannot compromise a QSR-Drive.

### Secure Authentication

A QSR-PN Ecosystem deploys one or more authentication mechanisms and processes.

QSR-Devices are connected to QSR-Accessories (ie. a Bluetooth earpiece) with KPAD encrypted connections (wired or wireless—ie. BLE, 5G) (these KPADs are shared exclusively between QSR-Devices and QSR-Accessories).

KPAD MFA is embedded into a QSR-Accessory (e.g., a wearable such as a watch or earpiece) required as a component of the Identity Access Management (IAM) process for QSR-Devices to access the QSR-PN Ecosystem, or to access specific resources within the QSR-PN Ecosystem such as Q-DR's and QSR-Apps (KPAD MFA is shared exclusively between a KPAD MFA enabled Q-Accessory and the KPAD Exchange).

KPAD MFA and QSR-Accessories can be used outside the QSR-PN Ecosystem for specific purposes (ie. offline physical access solutions such as garage door openers; in this instance the KPADs are shared exclusively between QSR-Points and QSR-Accessories or QSR-Devices). Examples of QSR-Points include garage door openers and key fobs to open and start cars. QSR-Points must be minted and bound to users with systems inside the QSR-E but can afterwards be used independent of a current QSR-E data connection.

Auth may require that the wearable Q-Accessory have user biometric authentication capabilities built-in with match-on-device capabilities.

### Secure Communications

A QSR-PN Ecosystem is contemplated to and may provide one or more Q-Services (QSR-PN Solutions). Q-ComSec refers to a unified communication services that enable devices to securely communicate across public and private networks using voice, video, text and data exchanges. Q-ComSec includes Auth protocols and QSR-PN services. QSR-Blocks render every block chain technology quantum secure/resistant within the QSR-PN Ecosystem. A QSR-Drive provides for quantum secure/resistant (QSR) data storage within a QSR-PN Ecosystem. QSR-Apps are all software applications hosted within the QSR-PN Ecosystem and rendered quantum secure/resistant using QSR-PN enabling technologies described herein.

### Application of a QSR-PN Ecosystem and QSR-PN Solutions: Business and Industrial Scenarios

There are unlimited business and industrial use cases that can leverage the QSR-PN Ecosystem to secure their computing infrastructures and devices. Below are follow two exemplary use cases.

A first use case for the application of a QSR-PN Ecosystem and related QSR-PN Solutions provided by it, is for securing Supervisory Control and Data Acquisition (SCADA) sites (substations), systems, and devices utilized to monitor industrial facilities such as factory, plant operations, traffic lights, and other Programmable Logic Controller (PLC), Programmable Automation Controllers (PAC), and Remote Terminal Unit (RTU) devices from server control and monitor systems and remote sites. With reference to FIG. 24, one of the primary issues with SCADA systems is caused by open systems and access to external networks that open the site to attacks from malicious actors. QSR-PN Solutions create cryptographically closed systems that secure SCADA devices within the QSR-PN Ecosystem.

Another use case for the application of a QSR-PN Ecosystem and related QSR-PN Solutions provided by it, is for securing bank teller systems at a branch or corporate offices, or SWIFT and Bloomberg Terminals. These systems are commonly built on desktop computer technologies that utilize PKI-based VPN services to communicate over public networks. By using these solutions banks are increasingly at risk from many attack vectors. Rather than adding complex security solutions QSR-PN transforms these desktop computers into dumb terminals that run their applications on virtualized servers within the QSR-PN Ecosystem (i.e. instead of trying to defend against all the attack vectors that these terminals are exposed to, eliminate the threats entirely by converting these terminals into QSR-Devices).

### Example II: Cyber and Digital Insurable Risk Management

To address cybersecurity risks organizations must apply best practices to manage their digital systems and processes, as well and seek to mitigate the impact of potential cyber intrusions and attacks by seeking to insure losses, corruption and the theft of data and digital assets. As the insurance industry evolves to meet these types of business needs, the assessment of insurable risk can be achieved in real time using the QSR-PN systems and processes of the present disclosure while at the same time allow organizations to monitor and be responsive to assessed risks.

A data breach, together with associated costs have immediate and long-term consequences including loss of an organization's custodial credibility and diminished reputation. Forensic investigation, operational downtime and future insurance and security costs are added to the accumulated damages. QSR-PN enabled continuous stress testing and attack simulations combined with System Assurance & Audit consistently ensures high values of confidence, reliability, availability and maintainability to provide quantum secure/resistant services to the organization. Quantum secure/resistant services delivered through a QSR-PN Ecosystem translates into business and consumer confidence and insurability for the organization.

In one embodiment, a QSR-PN Ecosystem provides “fully managed” QSR-PN Solutions, whereby all devices that are part of the QSR-PN Ecosystem are centrally managed and controlled, and all network traffic between devices is fully secured leveraging KPAD encryption techniques, methodologies and supporting QSR-PN technologies. It is this approach that makes it possible for provide for unique warranty/insurance bundles and upgrades to provide customer protections from cyber risks. Additionally, the QSR-PN System supports the ability to provide role-based-access-controlled (RBAC) and policy-controlled delegated management of enterprise resources and services, including enterprise owned QSR-Appliances, QSR-Devices, or specific applications, services or features.

In one embodiment, a QSR-PN Ecosystem provides 5 Tiers of service representing 5 separate security levels. Tier 1 includes devices that can only directly communicate with other Tier 1 devices. Tier 2 includes devices with the ability to communicate outside the QSR-PN Ecosystem. Tier 3 includes devices with a physically uploaded QSR-Apps including a KPAD through a removable media product supplied from within the QSR-PN Ecosystem. Tier 4 includes that download an QSR-Apps and are only conventional PKI capable, without any KPAD being included. Tier 5-Devices at each tier will have corresponding warranty/insurance protections and limitations. The supply of devices in all Tiers may be provided by the supplier of QSR-PN Solutions within a QSR-PN Ecosystem. Devices in Tiers 3 and 4 may also be provided or integrated by users wishing to connect their devices into a QSR-PN Ecosystem.

TABLE 2

| Tier | Tier Name | Description |
|---|---|---|
| 1 | QSR-Device w/KPAD | This type of QSR-Device includes: QSR-Books, |
| | only (SCI) | QSR-Tablets, and QSR-Phones which are |
| | | provisioned by QSR-E and are fully managed |
| | | devices. They are pre-provisioned with KPAD's |
| | | and are configured to perform full KPAD |
| | | encryption for both the handshake and the data |
| | | transmission (QSR-PN stream cipher). |
| | | Tier 1 represents the highest security tier and is |
| | | restricted to pure KPAD encryption, making the |
| | | communications between Tier 1 devices QS |
| | | (quantum secure). Tier 1 devices are hardened, |
| | | meaning that the hardware and operating system of |
| | | a Tier 1 device have been modified to reduce its |
| | | surface of vulnerability. Tier 1 devices are imaged |
| | | and deployed through the QSR-E. |
| 2 | QSR-Device w/KPAD | This type of QSR-Device includes: QSR-Books, |
| | and interaction with | QSR-Tablets, and QSR-Phones which are |
| | lower tiers | provisioned by QSR-E and are fully managed |
| | | devices. They are pre-provisioned with KPAD's |
| | | and are configured to communicate with pure |
| | | KPAD encryption for the most sensitive |
| | | communications, but they can also communicate in |
| | | QR (quantum resistant) mode, whereby a |
| | | symmetric key exchange between KPADs replaces |
| | | the key exchange mechanisms provided for with |
| | | PKI, PQC and QKD methodologies. Furthermore, |
| | | Tier 2 devices could, if permitted by the security |
| | | policies that govern their use, communicate with |
| | | Tier 3,4 and 5 devices. Tier 2 devices are hardened, |
| | | meaning that the hardware and operating system of |
| | | a Tier 2 device have been modified to reduce its |
| | | surface of vulnerability. Tier 2 devices are imaged |
| | | and deployed through the QSR-E. |
| 3 | QSR-Adaptor w/KPAD | Tier 3 devices have been upgraded with QSR- |
| | and interactions with | Adaptors. A QSR-Adaptor may also be referred to |
| | tiers 2-5 | as a BITW (bump-in-the-wire). Furthermore, Tier 3 |
| | | devices could, if permitted by the security policies |
| | | that govern their use, communicate with Tier 3, 4 |
| | | and 5 devices. The device that a QSR-Adaptor is |
| | | connected to, such as a SCADA device, has not been |
| | | hardened and may still be vulnerable if an attacker |
| | | can physically access it. QSR-Adaptors, but not the |
| | | devices they're connected to, are imaged and |
| | | deployed through the QSR-E. |
| 4 | BYOD w/PQC | Tier 4 represents an end user device that is upgraded |
| | | with a QSR-Agent and enabled with PQC |
| | | capabilities making the device QR (Quantum- |
| | | Resilient). Tier 4 devices are not imaged or deployed |
| | | through the QSR-E, but they may communicate with |
| | | other QSR-E connected devices subject to the |
| | | security policies that govern these other devices. |
| 5 | BYOD w/PKI | Tier 5 represents an end user device that is upgraded |
| | | with a QSR-Agent so that it can connect to the QSR- |
| | | E and communicate with other QSR-E connected |
| | | devices subject to the security policies that govern |
| | | these other devices, but such a device is not QR as it |
| | | can only communicate with conventional key |
| | | exchange mechanisms, including PKI and TLS. Tier |
| | | 5 devices are not imaged or deployed through the |
| | | QSR-E. |

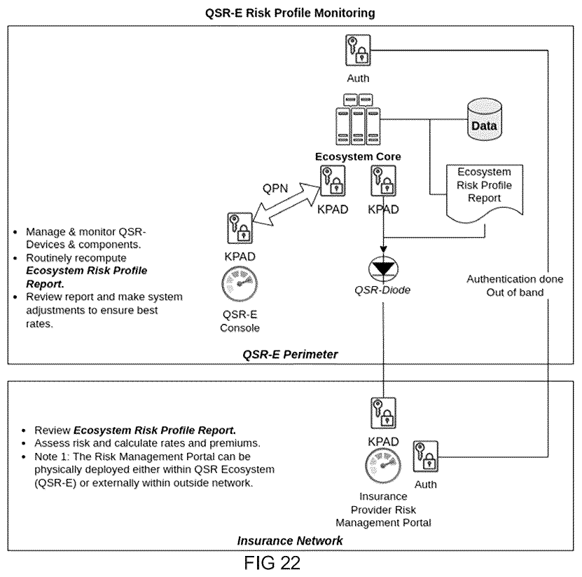

With reference to FIGS. 22 and 23, QSR-PN Solutions implemented leveraging a QSR-PN Ecosystem provide the assurance that the systems, data, and transmission of information is secure and risk averse and accordingly also support the establishment of insurable risks. Process steps for establishing insurable risks and mitigating them are provided in FIG. 23, which illustrates a risk profile monitoring system configuration including a QSR-PN Ecosystem and Insurance Network, as well as related steps carried out with direct and indirect QSR-PN Ecosystem access, respectively.

Features of the QSR-PN Ecosystem that are used to establish insurable risks and comply with insurance policy parameters include a KPAD Exchange and KPAD Directory. The KPAD Exchange and Directory (sub) systems of a QSR-PN Ecosystem are designed to manage and control keys, appliances and devices, how each of these are bound to users, and their associated privileges and access rights to services. These (sub) systems include a number of security capabilities to detect and address anomalies, as well as conventional technologies to report on security events.

An enterprise (organizational) risk profile can be scored and a report generated within a QSR-PN Ecosystem with regard to a number of factors including but not limited to:
a. The number of devices it manages at each and all security levels, for example using a scoring, ranking, or other type of assessment matrix (e.g. using a number between 1 and 5, with 1 representing the lowest risk and 5 representing the highest risk);
b. The classifications and value of the digital assets managed within the QSR-PN Ecosystem that will determine the required coverage; and
c. The number and nature of security events and anomalies.

A number of predictable risk profiles can be generated within a QSR-PN Ecosystem, based uniquely upon the application of KPAD (OTP) processes and be evaluated in real-time to provide an overall risk profile for the QSR-PN Ecosystem that can be used by the organization managing the QSR-PN Ecosystem and a cyber insurance provider. For example, the risk profile of a laptop connected and within a QSR-PN Ecosystem will change the instant that a USB key is inserted into a computer port. This will affect the risk profile for the laptop and as a result, the overall risk profile in a way which is dynamic depending on how devices and the like are being used and how well security policies are being followed and enforced.

The organization managing the risk has direct access to components and systems of the QSR-PN Ecosystem to be able to address risks and make system adjustments to maintain a certain risk profile ranking. The cyber insurance provider has indirect access through a data diode that provides only the ability to receive information relevant to the risk assessment of the QSR-PN Ecosystem, such that variances in the risk profile for a given QSR-PN Ecosystem can support policy design and trigger policy adjustments related to premiums and deductibles in accordance with the terms of a given policy.

### Example III

One embodiment of a secure digital network environment is provided by integrating OTP keys as part of quantum secure/resistant data systems solutions (QSR-PN Solutions), including the use of one-time-pad (OTP) keys to encrypt data, support multi-factor authentication and secure all communications between devices in the secure digital network environment. The OTP keys are “pre-loaded” to end-point (EP) devices to render them quantum secure/resistant (QSR) when connected into the secure digital network environment, or are otherwise provided through removable media to be loaded into user supplied appliances, devices and accessories to render them QSR when connected into the secure digital network environment. The application of QSR-PN Solutions refers to the application of QSR-PN enabled technologies to provide a secure digital network environment includes risk assessment and management solutions for establishing and managing cyber security insurable risks and policies.

One embodiment of a secure digital network environment is a QSR-PN Ecosystem including components, (sub) systems, and processes, that leverage one-time-pad (OTP) keys and libraries, as well as other technologies to secure the digital network environment (QSR-PN Solutions). Communications can be secured between devices (QSR-PN secured devices such as phones, tablets, computers, SCADA devices, and other embedded systems). QSR-PN Solutions help ensure that all communications within a QSR-PN Ecosystem are quantum secure/resistant (QSR) against attack vectors from malicious actors using conventional hacking tools, and from future threats anticipated when quantum computing reaches the power necessary to break public key encryption. The perimeter of protection within a QSR-PN Ecosystem extends to QSR-Devices, wherever they may be, including when they are connected through public networks.

In one embodiment, a secure digital network environment according to the present disclosure (e.g., a QSR-PN Ecosystem) comprises a security operation center including a number of systems and devices, such as media for providing OTP encryption (e.g. KPADs), an encryption key exchange and management system (e.g. KPAD Exchange), and a system to support network management and control (e.g. KPAD Directory). Additional systems that can be integrated into the architecture of a secure digital network environment (e.g. a QSR-PN Ecosystem) include an encryption generation and distribution system (e.g. KPAD Distribution) for generating and distributing contemplated future quantum key distribution (QKD) solutions used for encrypting data at rest as well as data in flight. In the meantime, however, QSR-PN capabilities for prepositioning OTP technology throughout a secure digital network environment avoids the need for QKD enabled delivery of networked OTP technology.

A secure digital network environment according to the present disclosure represents a reliable foundation upon which competitive digital network environments (ecosystems) as well as independent services can coexist. A list of quantum secure/resistant architecture features that can form part of an exemplary secure digital network environment (i.e., a QSR-PN Ecosystem) is provided in FIGS. 21A, 21B and 21C, including foundational quantum secure/resistant services and capabilities (e.g. QSR-PN Solutions) that can be provided from within the secure digital network environment.

In an embodiment, a secure digital network environment comprises one or more OTP key enabled authentication methods. As illustrated in FIG. 20 for a QSR-PN Ecosystem, KPADs are used to facilitate authentication and permissible communications and transmission between different parts of the QSR-PN Ecosystem, for example, between a QSR-PN Core Ecosystem, QSR-Device and QSR-Accessory. There is a unique KPAD pair between each instance of two connections.

In another embodiment, a secure digital network environment according to the present disclosure is configured to carry out “Identity and Access Management” (IAM) processes so that only authorized devices can access the network environment through their respective, unique OTP keys.

In another embodiment, a secure digital network environment according to the present disclosure deploys one or more OTP keys to encrypt all communication and other data transmission lines between devices in the secure digital network environment. OTP encryption keys (e.g. KPADs that essentially consist of random key material formatted for use within a QSR-PN Ecosystem) are pre-loaded onto appliances (e.g. QSR-Appliances), devices (e.g. QSR-Devices) and accessories (e.g. QSR-Accessories) connected into a secure digital network environment, or otherwise provided through removable media to be loaded into customer supplied appliances, devices and accessories. In a related embodiment, OTP encryption and more particularly KPAD encryption is contemplated for use to encrypt and decrypt data in an Information Theoretically Secure (ITS) manner and is understood by one skilled in the art to be provably unbreakable.

In a further embodiment a secure digital network environment according to the present disclosure is configured to provide centralized data storage and prevent data residue on devices (see FIGS. 20 and 22). Every device, unless otherwise specified by security policies, acts simply as an access point to the secure digital network environment.

According to an embodiment, the architecture and application of a QSR-PN Ecosystem and related QSR-PN Solutions with reference to FIG. 19 and FIGS. 21A, 21B and 21C.

A secure digital network environment according to the present disclosure has the capability to secure QSR communications across public and private networks.

In one embodiment, communications between one or more sites (substations) of a secure digital network environment are secured by establishing one or more data centers each using a QSR-PN enabled Router (a point-to-multipoint solution) or QSR-PN enabled Stream Cipher (strictly a point-to-point solution) whereby all traffic from the site's local area network is encrypted leveraging OTP key technologies and integrated into the organization's wide area network.

Securing individual end-point devices, such as computers, laptops, tablets, phones, Internet of Things (IoT) connected devices, SCADA devices (PLC's, PAC's, RTU's) throughout an organization with one or more data centers within a secure digital network environment according to the present disclosure (e.g within a QSR-PN Ecosystem) comprises providing QSR-PN enabled embedded devices and adapters.

In one embodiment OTP key technology is embedded on one or more devices, such as phones, tablets, computers and SCADA devices. In the exemplary QSR-PN Ecosystem illustrated in FIGS. 19 and 20, devices are provisioned within the organization using Q-Initialization Stations to load QSR-Apps with KPADs and are managed and controlled within the QSR-PN Ecosystem. Examples of embedded device use cases include replacing existing computers with QSR-Books or QSR-Tablets that use VDI (Virtual Desktop Infrastructure) images to connect them to the QSR-PN Ecosystem (such as bank teller terminals). Additional uses would include developing new PLC, PAC, or RTU SCADA devices, or customized IoT devices such as security cameras and traffic signals.

Bump-In-The-Wire (BITW) communication devices (adapters) are QSR-PN enabled network devices (using OTP keys) that are physically attached to existing (legacy) systems, and pre-loaded with QSR-PN enabled applications and OTP keys to support encrypted QS communications. QSR-PN enabled adapters encrypt/decrypt data across the logical network link without altering the communication end-points. They can be attached to physical device's network ports such as RJ45, USB attached or other communication ports.

For the device to communicate to the network it will send and receive data through the QSR-PN enabled adapter that will encrypt/decrypt the data utilizing the OTP libraries and OTP key material pre-loaded on the QSR-PN enabled adapter. This adapter will then route the network traffic securely across the network to a paired QSR-PN enabled Router or QSR-PN enabled Stream Cipher that will have the shared OTP key also pre-loaded. The QSR-PN enabled Router or QSR-PN enabled Stream Cipher will then route the data to the paired end-point to which the device was communicating after decrypting the network packets received from the QSR-PN enabled QSR-Adapter

### Example IV

In a secure digital network environment according to the present disclosure, underlying user devices, end-points, systems, and infrastructure components must be built first with security policies and patterns that ultimately provide the assurance that the systems, data, and transmission of information is secure and risk averse.

In one embodiment, quantum secure/resistant data systems (QSR-PN) enabled technologies are used to secure a digital network environment against cyber security threats. OTP keys, “Secure by Design” principles and one or more traditional security implementation concepts are applied to achieve this, as described herein. The resulting secure digital network environment is exemplified herein as a QSR-PN Ecosystem that delivers QSR-PN Solutions.

Security and data privacy risk is the association (and weighted risk assessment probability) of a cyber security threat being successful via an attack vector. QSR-PN Solutions are implemented leveraging a QSR-PN Ecosystem by following “Secure by Design” principles. Traditional security implementation concepts are also implemented as part of QSR-PN design, including “Defense in Depth”, “Zero Trust”, and “Behavior Analytics/Anomaly Detection” approaches. An assumption that “you will be attacked” forms the basis of all decisions made when building out a system to meet Secure by Design criteria.

“Secure By Design” software and hardware products and capabilities are designed to be foundationally secure. Malicious attacks on software should be assumed to occur. Care is taken to minimize impact. Security vulnerabilities are anticipated. Designs that work well do not rely on being secret. Security through obscurity is avoided. Secure by Design tactics and patterns provide solutions for enforcing the necessary authentication, authorization, confidentiality, data integrity, privacy, accountability, availability, safety, and non-repudiation.

“Defense in Depth (DID)” is a multi-layer controls approach for information security and is a methodology was meant to delay; not prevent the advance of an attack. DID, also known as the castle defense, is akin to putting a barrier in front of an adversary that they must penetrate or circumvent. The building of higher walls (more barriers, additional redundancies) can only go so far before another avenue of attack is discovered, or a taller ladder is built. Attack and threat intelligence should be shared, adaptive and behavioral characteristics understood. Building a higher wall or adding a second moat is not the answer, especially if the infiltrator is already inside.

The “Zero Trust” model is a shift from traditional perimeter-based security to a model that is user and device centric. “All users are untrusted”. Identity and Access management (IAM) are at the core of a zero-trust implementation combined with advanced analytics, Artificial Intelligence (AI) and machine learning. Access management is critical, evaluating identity, ensuring that a user is who they say they are, using the devices they should be and accessing the network from authorized locations. All devices, applications, services, components, and systems with the QS Ecosystem follow the NIST Zero Trust security model, and leverage centrally managed policies stored within PO providing an implementation of a NIST Zero Trust PDP-Policy Definition Point. Throughout the QS Ecosystems, devices, applications, and services provide localized policy enforcement within QS Policy Engines implementing NIST PEP—Policy Enforcement Point access control based upon both device and user identity and authorization policies.

“System Behavior Analytics” is primarily focused on the detection of insider threats, advanced persistent threats, targeted attacks, and fraudulent activity. Systems in a steady state operational environment can be foot-printed through patterns of behavior. These patterns are analyzed for anomalies that can indicate a potential threat. Automated threat responses built into the system suspend and/or sandbox the activities until verified and validated by an operator. QSR-Appliances and QSR-Devices run QSR-Agent software which performs automated always on monitoring of QSR-Appliances and QSR-Devices and performs system behavior analytics upon identification of an anomalous activity

“QSR-PN Security Fabric” is a cyber security platform, providing visibility and protection of the organizations attack surface; integrating solutions leveraging threat intelligence while reducing management complexity; and AI and automation tools to provide network self-healing and automated incident and response protocols.

“SOAR”, which stands for “Security Orchestration, Automation and Response” software technology, allows an organization to collect and monitor security events and execute automated workflow and playbook responses to incidents. This may be combined with other AI automation tools and orchestration. All QSR-Devices, applications, and services track and log events and publish them to a centrally managed SIEM system which is accessible by SOAR AI automation tools and orchestration. In the event that there is an anomalous event that requires specific device changes, such as taking a quarantining a device or revoking device access from a specific user, the SOAR systems will perform this action remotely through the QSR-Agent running on the device in question.

“SIEM”, which stands for “Security Information and Event Management” is a set of technology tools that collect logging and event information in real-time across the enterprise to provide a consolidated view of all information security systems. QSR-PN SIEM is integrated with SOAR and a QSOC (Quantum Security Operations Center), and forms part of the overall QSR-PN Security Fabric. As stated above in the SOAR section, all QSR-Devices, applications, and services track and log events and publish them to a centrally managed SIEM system, where AI and automated processes can perform workflows in response to different types of events.

In one embodiment, SIEM and SOAR systems are sourced from Elastic (ELK). SIEM and SOAR applications can also be sourced from companies such as Manage Engine, Fortinet, Rapid7 and LogRhythm, or another provider as would be readily understood.

“Continuous Monitoring & Managed Detection & Response (MDR)”, is part of the QSR-PN Security Fabric and includes the implementation of 24/7 security monitoring combined with MDR capabilities to provide additional threat hunting, correlation, and threat response actions in response to security alerts occurring within the security infrastructure. In one embodiment, MDR services can be provided by Field Effect. MDR services can also be provided by CrowdStrike, Google Mandiant, and PaloAlto, or another provider as would be readily understood.

“Stress Testing with Incident Response Planning and Playbook Development” refers to proactively conduct system stress testing and conduct attack simulations to test out the organizations Incident Response (IR) handling and incident response plans. IR playbooks are developed, and plans updated on a regular basis. Stress testing also includes vulnerability scanning, penetration testing and red team attack simulation and active exploits.

“UEM” (Unified End-point Management) is combined with strong IAM to allow security team visibility into suspicious activity on company devices as well as allowable Bring Your Own Device (BYOD). BYODs not used at stricter levels of security management (e.g. Tier 1 and Tier 2 levels as described in Example 2). The ability to monitor and control inaccessible Internet of Things (IoT) and endpoint devices allows speedy investigation and response to incidents or loss, including device isolation and damage control. Managed QSR-Devices (Tier 1 and Tier 2) run QSR-Agent as a privileged process upon them. For unmanaged BYOD devices, QSR-Agent can be installed as a software application to provide some levels of end-point management, although not as sophisticated to that of managed devices.

“Audit, Security Governance, Policy and Certification” refers to managing security risks using an Information Security Management System (ISMS) that is regularly reviewed and updated. A QSR-E ISMS includes Security Governance, audit requirements, policy development and security controls implementation. In one embodiment, a QSR-PN Solution of this type is based on ISO 27001 for its ISMS framework in addition to the NIST 800 series Cyber Security Frameworks.

“Data Classification, Retention Policy & Encryption” is for addressing data security risks and refers to the proper identification of information assets needed to determine what must be protected. Data assets are inventoried, controlled, and classified according to sensitivity, and encrypted while in motion and at rest. Highly sensitive information is separated from the rest of the business with multisig (multiple signatures) access controls and hardware security.

### Security Threats Addressed by QSR-PN Solutions

Attack vectors (passive and active) are methods of achieving unauthorized access to a network or system to allow a cyber-attack to take place. A cyber-attack may exploit a system vulnerability or weakness to manipulate the system, gain access, extract data, or deliver a malicious payload. They allow cybercriminals to exploit system vulnerabilities to gain access to sensitive data, personally identifiable information (PII), and other valuable information accessible after a data breach.

In one embodiment a solution (e.g., a QSR-PN Solution embodied as part of a QSR-PN Ecosystem) is provided to counter or mitigate “Passive Attack Vector” exploits, which typically relies on the lack of security awareness of users to obtain information and mount an active attack and include social engineering, phishing, and URL hijacking (typo squatting). The QSR-PN Solution embodied in and leveraged from within a QSR-PN Ecosystem that is designed to address a Passive Attack Vector can be implemented through the application of one or more components, systems and/or processes.

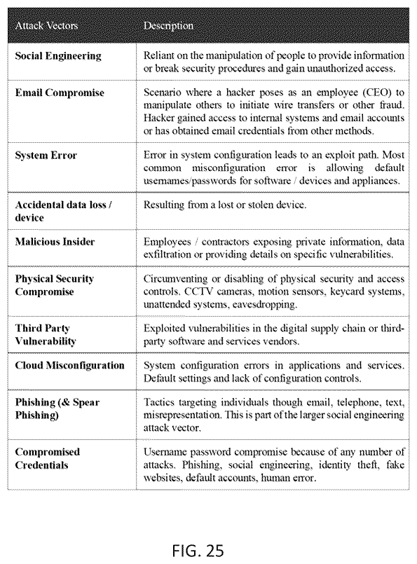

In another embodiment a solution (e.g., a QSR-PN Solution embodied as part of a QSR-PN Ecosystem) is provided to counter or mitigate a cyber security threat implemented through one or more attack vectors set out in FIG. 25. A QSR-PN Solution embodied in and leveraged from within a QSR-PN Ecosystem that is designed to address said attack vectors can be implemented through the application of one or more components, systems and/or processes.

In a further embodiment, a solution (e.g., a QSR-PN Solution embodied as part of a QSR-PN Ecosystem) is provided to counter or mitigate a Digital Harvesting Threat, namely those posed by Nation-state actors that are storing encrypted network and data transmissions (harvesting data), so that they can decrypt and gain access using quantum computers as and when they are available. A QSR-PN Solution embodied in and leveraged from within a QSR-PN Ecosystem that is designed to address such threats can be implemented through the application of one or more components, systems and/or processes.

In yet another embodiment, a solution (e.g., a QSR-PN Solution embodied as part of a QSR-PN Ecosystem) is provided to counter or mitigate an adversarial, or a nation-state threat, often sponsored by a foreign government launching cyber-attacks against another government, or the business, and infrastructure of a given nation. Such state sponsored attacks are carried out by groups conducting espionage. They employ stealth, subterfuge, and weaponized technologies to wage cyberwar against countries and organizations, and will be the first to develop or acquire quantum computing capabilities, as will well-funded criminal and terrorist organizations. Nation-state threats also involve advanced persistent threat (APT) groups, most often under government employ, who focus on long term cyber-attacks where the actors gain access to the network and remain undetected for a prolonged period. All of these threats are difficult to defend against as they are extremely well funded and utilize the most advanced technologies and highly trained personnel. A QSR-PN Solution embodied in and leveraged from within a QSR-PN Ecosystem that is designed to address such adversarial threats can be implemented through the application of one or more of its components, systems and/or processes.

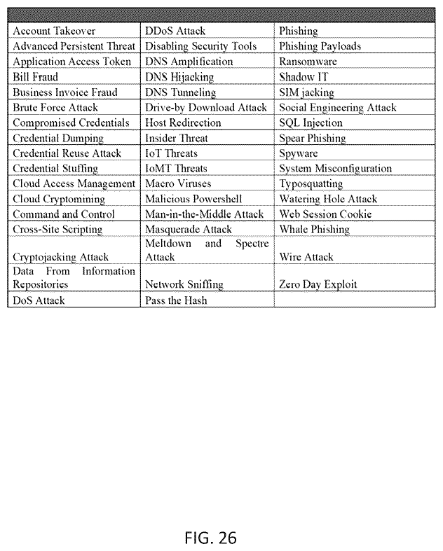

Digital Harvesting and Adversarial Threats are examples of active (cyber security) threats. In an embodiment, a solution (e.g., a QSR-PN Solution embodied as part of a QSR-PN Ecosystem) is used to counter or mitigate one or more active threats as set out in FIG. 26. A QSR-PN Solution embodied in and leveraged from within a QSR-PN Ecosystem to address active threats can be implemented through the application of one or more of its components, systems and/or processes.

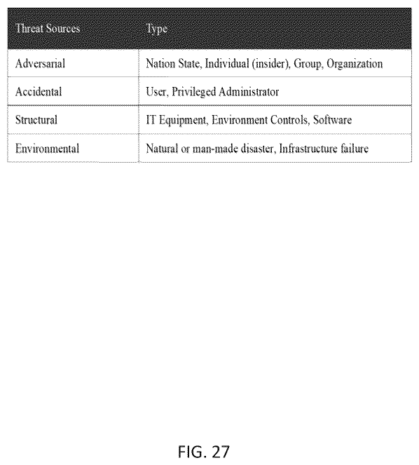

In another embodiment, a solution (e.g., a QSR-PN Solution embodied as part of a QSR-PN Ecosystem) is provided to counter or mitigate one or more active (cyber security) threats originating from a threat source set out in FIG. 27, including adversarial, accidental, structural and environmental threat sources. A QSR-PN Solution embodied in and leveraged from within a QSR-PN Ecosystem to address sources of active threats can be implemented through the application of one or more of its components, systems and/or processes.

In a further embodiment, a solution (e.g., a QSR-PN Solution embodied as part of a QSR-PN Ecosystem) is provided to counter or mitigate one or more malicious software threats such as botnets, Trojans and other similar means of launching malicious software to affect Internet of Things (IoT) systems. A QSR-PN Solution embodied in and leveraged from within a QSR-PN Ecosystem to address malicious software threats can be implemented through the application of one or more components, systems and/or processes.

Botnets, or networked computing robots are a collection (in many cases tens of thousands) of internet connected computers running any number of malicious software payloads. Botnets can remain dormant and undetected for long periods of time until their remote-control operators activate the software via a command-and-control system or server running in a remote data center cloud instance or other location. Botnets are a major threat to web applications, especially e-commerce, IoT devices and mobile devices. Botnets are capable of initiating Denial of Service (DOS) attacks, credential stealing and identity theft, mass SPAM delivery, brute force hacking, crypto mining, and delivery of ransomware. Exemplary botnets are cloud and mobil botnets, and other known botnets such as Emotet, TrickBot, Dridex, Joker, CryCryptor, and EventBot. A design feature of a secure digital network environment according to the present disclosure is the capability to detect botnet activity and attack by identifying abnormal activity and patterns in traffic (see FIG. 23).

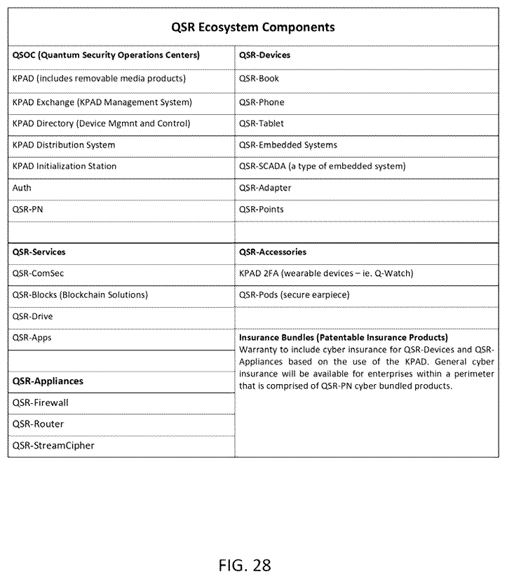

FIG. 28 is a table listing one embodiment of QSR-E components, according to embodiments.

The disclosures of all patents, patent applications, publications and database entries referenced in this specification are hereby specifically incorporated by reference in their entirety to the same extent as if each such individual patent, patent application, publication and database entry were specifically and individually indicated to be incorporated by reference.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any modifications, variations, combinations, or equivalents that fall within the scope of the present invention.

1. A system configured to create a quantum secure/resistant secure communication channel (QSR-SCC) for communication between two or more end-points, the system comprising:
an originating end-point and a destination end-point, both the originating end-point and the destination end-point configured for communication therebetween;
an encryption engine to provide an encrypted communication between the originating end-point and the destination end-point;
a plurality of KPADs, wherein each KPAD includes multiple sets of true random number generator (TRNG) bytes of key data configured with a QSR-E key structure, each of the plurality of KPADs configured to be used by the encryption engine, wherein each of the plurality of KPADs is created and centrally managed by a quantum key management system (QKMS); and
a true random number generator (TRNG), the TRNG configured to generate quantum secure random numbers for use in the plurality of KPADs;
wherein the encryption engine and plurality of KPADs are used to establish a secure communication tunnel for the secure transmission of data.

2. The system of claim 1, wherein the two or more end-points are located at or within one or more of devices, applications, services, application programming interfaces (APIs) and secure communication protocols.

3. The system of claim 1 or claim 2, wherein the QSR-SCC is operatively associated with means to provide authentication and authorization functionalities with respect to the originating and destination end-points and associated users to establish the secure communication tunnel and securely transmit data via the QSR-SCC.

4. The system according to any one of claims 1 to 3, wherein the system further comprises an identity and access management service (IAM) configured to manage user and end-point identity, access, and authorization services, wherein the originating end-point and the destination end-point are operatively connected to the IAM.

5. The system according to any one of claims 1 to 4, wherein the system further comprises one or more universal end-point managers (UEM), wherein each UEM is operatively associated with the means to provide authorization and authentication functionalities and is configured to manage at least the originating and destination end-points.

6. The system according to any one of claims 1 to 5, further comprising user and end-point authorization services (Auth), wherein the Auth is configured to interface with the IAM to remotely manage the originating end-point and the destination end-point of the QSR-SCC.

7. The system according to any of one of claims 1 to 6, further comprising one or more firewalls, wherein each firewall is configured to provide one or more zero trust access, ingress and/or egress, and communication traffic inspection capabilities.

8. The system according to any one of claims 1 to 7, further comprising one or more quantum secure/resistant end-point management services (QSR-Agent), wherein each of the originating and destination end-points is operatively connected with a QSR-Agent and wherein each QSR-Agent is operative to interact with the system to allow, deny, manage, monitor and/or control the establishment of the secure communication tunnel and the transmission of data via the QSR-SCC.

9. The system according to any one of claims 1 to 8, further comprising a quantum secure/resistant enterprise asset manager (QSR-EAM) configured for centralized management of hardware and digital assets and operatively associated with the QSR-SCC.

10. The system according to any one of claims 1 to 9, further comprising one or more policy orchestrators (PO), wherein each PO is configured to manage and deliver zero trust policy services within the QSR-SCC and wherein each PO is configured to orchestrate one or more of user, group, or other security policies for providing access and control to the originating and destination end-points of the QSR-SCC.

11. The system according to any one of claims 1 to 10, further comprising one or more risk managers (RM), wherein the RM is configured to assess and report on risk regarding the operability of the QSR-SCC and compliance with pre-determined risk management standards set for or to be evaluated for the system.

12. The system according to any one of claims 1 to 11, further comprising a quantum secure/resistant enterprise manager (QSR-EM) configured to provide a unified view of the two or more end-points and entirety of the system.

13. The system according to any one of claims 1 to 12, wherein the QSR-SCC is used to create a quantum secure/resistant private network (QSR-PN) between the two or more end-points.

14. The system according to claim 13, wherein the QSR-PN comprises a quantum secure/resistant gateway (QSR-Gateway).

15. The system according to claim 13 or claim 14, wherein the QSR-PN comprises a quantum secure/resistant router (QSR-Router).

16. The system according to any one of claims 1 to 15 wherein the QSR-SCC is timed-out and rekeyed on a random periodic basis.

17. The system of any one of claims 1 to 16, wherein the multiple sets of true random number generator (TRNG) bytes of key data are sequenced in a sequentially ordered fashion.

18. A quantum secure/resistant ecosystem (QSR-E) for secure communication between a plurality of quantum secure/resistant end-points, the QSR-E comprising:
one or more systems according to claim 1;
a QSR-Router deployed at a location remote from one of the one or more systems, wherein the QSR-Router is configured to secure a remote communication tunnel with one or more end-points of said system; and
one or more quantum secure/resistant user and end-point devices (QSR-UEDs), each QSR-UED including a plurality of KPADS, each KPAD configured with a QSR-E key structure created and managed by a quantum key management system (QKMS) within the QSR-E.

19. A quantum secure/resistant device (QSR-Device) for use within a QSR-E created by one or more systems according to claim 1, the QSR-device comprising:
a processor;
a memory having stored thereon one or more KPADs; the memory further storing machine executable instructions, the instructions when executed by the processor cause the QSR-device to be configured to:
communicate with an Auth, the Auth configured to conduct multi-factor authentication (MFA) with an access management service (IAM) within the system; and
communicate with one or more other devices associated with the QSR-E using a KPAD for encrypting communications.

20. A method for creating a quantum secure/resistant private network (QSR-PN) for communication between two or more devices, the method comprising:
generating, by the originating device, an encrypted handshake using a cipher key retrieved from an originating KPAD, the originating KPAD including multiple sets of true random number generator (TRNG) bytes of cipher key data configured with a QSR-Ecosystem key structure, the encrypted handshake including information indicative of the originating device;
transmitting, by the originating device, the encrypted handshake to a destination device together with an indication of the cipher key;
receiving, by the destination device, the encrypted handshake and the indication of the cipher key;
retrieving, by the destination device, the cipher key from a destination KPAD, the destination KPAD associated with the originating KPAD, the retrieving based at least in part on the indication of the cipher key;
decrypting the encrypted handshake using the cipher key to obtain the handshake and the information indicative of the originating device for the destination device to thereby authenticate the originating device;
upon authentication of the originating device by the destination device, generating, by the destination device, a second encrypted handshake using an ephemeral key created, derived or generated from the destination KPAD, the second encrypted handshake including information indicative of the destination device;
transmitting, by the destination device, the second encrypted handshake to the originating device together with an indication of the ephemeral key;
receiving, by the originating device, the second encrypted handshake and the indication of the ephemeral key;
retrieving, by the originating device, the ephemeral key from the originating KPAD, the retrieving based at least in part on the indication of the ephemeral key;
decrypting the second encrypted handshake using the ephemeral key to obtain the handshake and the information indicative of the destination device for the originating device to thereby authenticate the destination device;
upon authentication of the destination device by the originating device, establishing an encrypted communication session between the originating device and the destination device based at least in part on the ephemeral key.

21. A system configured to create a quantum secure/resistant private network (QSR-PN) for communication of data between two or more devices, the system comprising:
an originating device including:
an originating KPAD loaded in memory on the originating device, the KPAD including multiple sets of true random number generator (TRNG) bytes of cipher key data configured with a QSR-Ecosystem key structure;
an originating cipher module configured to use a cipher key received from an encryption engine, the cipher key used by the cipher module to transform the data into encrypted data;
an originating encryption engine configured to perform logic of providing the cipher module with the cipher key obtained from the KPAD; and
an originating communication module for transmitting the encrypted data and an indication of the cipher key to a destination device; and
the destination device including:
a destination communication module for receiving the encrypted data and the indication of the cipher key from the originating device; and
a destination KPAD loaded in memory on the destination device, the destination KPAD associated with the originating KPAD;
a destination encryption engine configured to perform logic of providing a destination cipher module with a decryption cipher key obtained from the destination KPAD based at least in part on the indication of the cipher key received from the originating device;
the destination cipher module configured to use the decryption cipher key received from the destination encryption engine, the decryption cipher key used by the destination cipher module to transform the encrypted data into the data.

22. A method for creating a quantum secure/resistant private network (QSR-PN) for communication of data between two or more devices, the method comprising:
storing an originating KPAD on an originating device, the KPAD including multiple sets of true random number generator (TRNG) bytes of cipher key data configured with a QSR-Ecosystem key structure;
obtaining a cipher key from the originating KPAD and transferring the cipher key to an encryption engine;
transforming the data to encrypted data using the cipher key; and
transmitting the encrypted data and an indication of the cipher key to a destination device.

23. An apparatus for creating a quantum secure/resistant private network (QSR-PN) for communication of data between two or more devices, the apparatus comprising:
a processor; and
a memory having stored thereon computer executable instructions, the instructions when executed by the processor configure the apparatus to:
store an originating KPAD on an originating device, the KPAD including multiple sets of true random number generator (TRNG) bytes of cipher key data sequenced in a sequentially ordered fashion and configured with a QSR-ecosystem key structure;
obtain a cipher key from the originating KPAD and transferring the cipher key to an encryption engine;
transform the data to encrypted data using the cipher key; and
transmit the encrypted data and an indication of the cipher key to a destination device.

24. A method for creating a quantum secure/resistant private network (QSR-PN) for communication of data between two devices, the method comprising:
storing a destination KPAD on a destination device;
receiving encrypted data and an indication of a cipher key from an originating device;
retrieving the cipher key from the destination KPAD, the retrieving based at least in part on the indication of the cipher key; and
transforming the encrypted data into the data based on the cipher key.

25. An apparatus for creating a quantum secure/resistant private network (QSR-PN) for communication of data between two or more devices, the apparatus comprising:
a processor; and
a memory having stored thereon computer executable instructions, the instructions when executed by the processor configure the apparatus to:
store a destination KPAD on a destination device;
receive encrypted data and an indication of a cipher key from an originating device;
retrieve the cipher key from the destination KPAD, the retrieving based at least in part on the indication of the cipher key; and
transform the encrypted data into the data based on the cipher key.
